(19) United States
(12) Patent Application Publication
(10) Pub. No.: US 2026/0202718 A1
(43) Pub. Date: Jul. 16, 2026

(54) LENS DRIVING DEVICE, CAMERA DEVICE, AND OPTICS

(71) Applicant: LG INNOTEK CO., LTD., Seoul (KR)

(72) Inventor: Sung Guk LEE, Seoul (KR)

(21) Appl. No.: 19/136,142

(22) PCT Filed: Nov. 7, 2023
(86) PCT No.: PCT/KR2023/017726

§ 371 Date: Jun. 5, 2025

(30) Foreign Application Priority Data
Dec. 5, 2022 (KR) 10-2022-0168179
Jan. 9, 2023 (KR) 10-2023-0003153

(51) Int. Cl. G03B 13/36; G03B 5/02; G03B 5/04; G03B 30/00; H04N 23/54; H04N 23/57

(52) U.S. Cl. CPC G03B 13/36; G03B 5/02; G03B 5/04; G03B 30/00; H04N 23/54; H04N 23/57; G03B 2205/0015; G03B 2205/0069

(57) ABSTRACT

A first embodiment of the present invention relates to a lens driving device comprising: a fixed part; a first moving part disposed within the fixed part; a second moving part disposed between the fixed part and the first moving part; a first coil and a first magnet which move the first moving part in an optical axis direction; and a second coil and a second magnet which move the second moving part in a first direction perpendicular to the optical axis direction, wherein the first coil overlaps the second coil in the first direction.

### TECHNICAL FIELD

The present embodiment relates to a lens driving device, a camera device, and an optics.

### BACKGROUND ART

A camera device is a device that photographs a picture or video of a subject, and is installed in optics such as smartphones, drones, and vehicles.

An auto-focus function that automatically adjusts the focus according to the distance of the subject is applied to the camera device. In addition, a shake correction function is applied to prevent a phenomenon in which the focus is shaking by the user's shaking hands.

However, in order to dispose the magnets and coils, and the like for performing the auto focus function and handshake correction function, a size larger than the thickness of a smartphone in an optical axis direction is required, which causes the camera device mounted on the smartphone to be protruded more than other portions of the smartphone.
(Patent Literature 1) KR 10-2015-0118005 A

### DETAILED DESCRIPTION OF THE INVENTION

### Technical Subject

The present embodiment is intended to provide a camera device having an autofocus function and a handshake correction function, while having a minimized size in an optical axis direction.

### Technical Solution

A lens driving device according to the present embodiment comprises: a fixed part; a first moving part being disposed inside the fixed part; a second moving part being disposed between the fixed part and the first moving part; a first coil and a first magnet which move the first moving part in an optical axis direction; and a second coil and a second magnet which move the second moving part in a first direction perpendicular to the optical axis direction, wherein the first coil may be overlapped with the second coil in the first direction.

The second coil comprises a first unit coil and a second unit coil, wherein in the first direction, the first coil can be disposed between the first unit coil and the second unit coil.

In the first direction, the first magnet can be overlapped with the second magnet.

The lens driving device may comprise: a third moving part being disposed between the fixed part and the second moving part; and a third coil and a third magnet that move the third moving part in a second direction perpendicular to the optical axis direction and the first direction.

When a current is applied to the second coil, the first moving part can move together with the second moving part, and when a current is applied to the third coil, the first moving part and the second moving part can move together with the third moving part.

The lens driving device comprises a first yoke on which an attractive force with the first magnet acts, wherein the first magnet is disposed in the first moving part, and wherein the first yoke may be disposed in the second moving part.

The lens driving device comprises a second yoke on which an attractive force with the second magnet acts, wherein the second magnet is disposed in the second moving part, and wherein the second yoke may be disposed in the third moving part.

The lens driving device comprises a third yoke on which an attractive force with the third magnet acts, wherein the third magnet is disposed in the third moving part, and wherein the third yoke may be disposed in the fixed part.

The lens driving device comprises a first ball being disposed between the first moving part and the second moving part, wherein the first moving part and the second moving part comprise a first groove being extended in the optical axis direction, and wherein the first ball may be disposed between the first groove of the first moving part and the first groove of the second moving part.

The lens driving device comprises a second ball being disposed between the second moving part and the third moving part, wherein the second moving part and the third moving part comprise a second groove being extended in the first direction, and wherein the second ball may be disposed between the second groove of the second moving part and the second groove of the third moving part.

The lens driving device comprises a third ball being disposed between the third moving part and the fixed part, wherein the third moving part and the fixed part comprise a third groove being extended in the second direction, and wherein the third ball may be disposed between the third groove of the third moving part and the third groove of the fixed part.

In the second direction, the second magnet may be overlapped with the third magnet.

In the first direction and the second direction, the first magnet may not be overlapped with the third magnet.

A lens driving device according to a first embodiment of the present invention comprises: a fixed part; a first moving part being disposed inside the fixed part; a second moving part being disposed between the fixed part and the first moving part; a first coil and a first magnet moving the first moving part in an optical axis direction; and a second coil and a second magnet moving the second moving part in a first direction perpendicular to the optical axis direction, wherein the second moving part may comprise: a first surface on which a first guide part is formed to guide the first moving part to move in a first direction; and a second surface on which a third guide part is formed to guide the movement of the first moving part in the optical axis direction.

A lens driving device according to a first embodiment of the present invention comprises: a fixed part comprising a bottom plate and a side plate; a first moving part being disposed inside the fixed part; a second moving part being disposed between the fixed part and the first moving part; and a third moving part being disposed between the fixed part and the first moving part, wherein the side plate of the fixed part comprises a first side plate and a second side plate which are adjacent to each other, wherein the third moving part comprises a first guide part which guides the first moving part to move in a first direction and a second guide part which guides the first moving part to move in a second direction, wherein the second moving part is disposed between the first side plate of the fixed part and the first moving part, wherein the first guide part is disposed between a lower surface of the second moving part and the bottom plate of the fixed part, and wherein the second guide part may be disposed between a side surface of the first moving part and the second side plate of the fixed part.

A lens driving device according to a first embodiment of the present invention may comprise: a fixed part comprising a bottom plate and a side plate; a first moving part moving with respect to the fixed part; a second moving part guiding the first moving part to move in an optical direction; a third moving part guiding the first moving part to move in a first direction and a second direction perpendicular to the optical direction; a first ball part being disposed between the first moving part and the second moving part; a second ball part being disposed between a lower surface of the second moving part and an upper surface of the third moving part; and a third ball part being disposed between the third moving part and the side plate of the fixed part.

The lens driving device may comprise: a first coil and a first magnet that move the first moving part in the optical axis direction; a second coil and a second magnet that move the second moving part in a first direction perpendicular to the optical axis direction; and a third coil and a third magnet that move the third moving part in a second direction perpendicular to the optical axis direction and the first direction.

A camera device according to a first embodiment of the present invention may comprise: a printed circuit board; an image sensor being disposed in the printed circuit board; the lens driving device being disposed on the printed circuit board; and a lens being coupled to the lens driving device.

The optical apparatus according to a first embodiment of the present invention may comprise: a main body; the camera device being disposed in the main body; and a display being disposed in the main body and outputting at least one or more of an image and a video photographed by the camera device.

A lens driving device according to a second embodiment of the present invention comprises: a fixed part; a first moving part being disposed inside the fixed part; a second moving part being disposed between the fixed part and the first moving part; a first coil and a first magnet that move the first moving part; a second coil and a second magnet that move the second moving part; and a shaft being disposed between the first moving part and the second moving part, wherein an attractive force can be applied between the shaft and the second magnet.

The first moving part can be pressurized toward the second moving part by an attractive force between the shaft and the second magnet.

The shaft is fixed to one of the first moving part and the second moving part so that the shaft can be pressurized against the other one of the first moving part and the second moving part by an attractive force between the shaft and the second magnet.

The shaft may be fixed to the first moving part.

By the attractive force between the shaft and the second magnet, the shaft and the first moving part can be pressurized toward the second magnet.

The central axis of the shaft may be disposed parallel to an optical axis.

The shaft can guide the first moving part to move in an optical axis direction with respect to the second moving part.

The second magnet can be fixed to the second moving part.

The second magnet comprises: a first magnet portion comprising an N pole and a S pole; a second magnet portion comprising a S pole and an N pole; and a neutral portion between the first magnet portion and the second magnet portion, wherein the second magnet comprises an inner surface facing the shaft, and wherein at least a portion of the shaft may be overlapped with the neutral portion of the second magnet in a direction perpendicular to the inner surface of the second magnet.

The shaft comprises a first shaft and a second shaft being spaced apart from each other, wherein in a direction in which the first shaft faces the second shaft, the first magnet may not be overlapped with the first shaft and the second shaft.

The first moving part comprises a first side surface facing the first coil, wherein the first side surface of the first moving part comprises a first region, a second region recessed more inwardly than the first region, and a third region recessed more inwardly than the second region, and wherein the first magnet may be disposed in a groove formed in the first region, and the shaft can be disposed in a groove formed in the third region.

The second moving part comprises a groove being extended in an optical axis direction, wherein the shaft may be disposed in the groove of the second moving part.

In the optical axis direction, the length of the groove of the second moving part may be longer than the length of the shaft.

The first coil and the first magnet move the first moving part in an optical axis direction, the second coil and the second magnet move the second moving part in a first direction perpendicular to the optical axis direction, and in the first direction, the first magnet may be overlapped with the second magnet.

In the first direction, the first coil may be overlapped with the second coil.

The lens driving device may comprise: a third moving part being disposed between the fixed part and the second moving part; and a third coil and a third magnet for moving the third moving part in a second direction perpendicular to the optical axis direction and the first direction.

When current is applied to the second coil, the first moving part moves together with the second moving part, and when current is applied to the third coil, the first moving part and the second moving part may move together with the third moving part.

A lens driving device according to a second embodiment of the present invention comprises: a fixed part; a first moving part being disposed inside the fixed part; a second moving part being disposed between the fixed part and the first moving part; a first coil and a first magnet that move the first moving part in an optical axis direction; a second coil and a second magnet that move the second moving part in a first direction perpendicular to the optical axis direction; and a shaft being disposed between the first moving part and the second moving part, wherein the second moving part may comprise: a first surface on which a first guide portion guiding the first moving part to move in the first direction is formed; and a second surface on which a groove in which the shaft is disposed is formed.

A lens driving device according to a second embodiment of the present invention may comprise: a fixed part comprising a bottom plate and a side plate; a first moving part moving with respect to the fixed part; a second moving part guiding the first moving part to move in an optical axis direction; a third moving part guiding the first moving part to move in a first direction and a second direction perpendicular to the optical axis direction; a shaft being disposed between the first moving part and the second moving part; a first ball part being disposed between a lower surface of the second moving part and an upper surface of the third moving part; and a second ball part being disposed between the third moving part and the side plate of the fixed part.

A camera device according to a second embodiment of the present invention may comprise: a printed circuit board; an image sensor being disposed in the printed circuit board; the lens driving device being disposed in the printed circuit board; and a lens being coupled to the lens driving device.

The optical apparatus according to a second embodiment of the present invention may comprise: a main body; the camera device being disposed in the main body; and a display being disposed in the main body and outputting at least any one or more of an image and a video photographed by the camera device.

### Advantageous Effects

Through the present embodiment, the autofocus function and the handshake correction function can be performed in a camera device with a size minimized in an optical axis direction.

According to a first embodiment of the present invention, a camera device even not being protruded from a smartphone can perform both an auto focus function and a handshake correction function.

Furthermore, through a first embodiment of the present invention, a camera device having a minimized size in a horizontal and vertical directions perpendicular to an optical axis can be provided.

The camera device according to a second embodiment of the present invention may not be protruded from the smartphone. Alternatively, the camera device according to a second embodiment of the present invention may be protruded minimally from the smartphone.

According to a second embodiment of the present invention, a camera device even not being protruded or protruded minimally from a smartphone can perform both an auto focus function and a handshake correction function.

Furthermore, through a second embodiment of the present invention, a camera device having a minimized size in a horizontal direction and a vertical direction perpendicular to an optical axis can be provided.

In addition, a second embodiment of the present invention has an advantage in that there is no need to dispose a separate attractive force member for pressurizing an AF guide member as an attractive force acts between a metal shaft and a driving magnet.

In other words, a second embodiment of the present invention has an advantage in that there is no need to dispose a separate attractive force member for pressurizing an AF guide member by arranging a magnetic shaft to guide the AF driving.

### BRIEF DESCRIPTION OF DRAWINGS

FIG. 1 is a perspective view of a lens driving device according to a first embodiment of the present invention.

FIG. 2 (a) is a plan view of a lens driving device according to a first embodiment of the present invention, and (b) is a side view.

FIG. 3 is a cross-sectional view taken along line a-a of FIG. 1.

FIG. 4 is a cross-sectional view taken along line b-b of FIG. 1.

FIG. 5 is a cross-sectional view taken along line c-c of FIG. 1.

FIG. 6 is a cross-sectional view taken along line d-d of FIG. 1.

FIG. 7 is a cross-sectional view taken along line e-e of FIG. 1.

FIG. 8 is a cross-sectional view taken along line f-f of FIG. 1.

FIG. 9 is a cross-sectional perspective view illustrating a cross-section of a lens driving device according to a first embodiment of the present invention cut in a direction perpendicular to an optical axis.

FIG. 10 is an exploded perspective view of a lens driving device according to a first embodiment of the present invention.

FIG. 11 is a plan view of a lens driving device according to a first embodiment of the present invention with the cover removed.

FIG. 12 is a perspective view of a lens driving device according to a first embodiment of the present invention with the cover removed.

FIG. 13 is a partial enlarged view of FIG. 12.

FIG. 14 is a perspective view illustrating an AF attractive force yoke and related components of a lens driving device according to a first embodiment of the present invention.

FIG. 15a is a perspective view of a lens driving device according to a first embodiment of the present invention with a cover and an AF carrier removed.

FIG. 15b is a bottom perspective view of an OIS-y carrier of a lens driving device according to a first embodiment of the present invention.

FIG. 16 is a partial enlarged view of FIG. 15a with an OIS-y carrier removed.

FIG. 17 is an enlarged view illustrating an enlarged view of an OIS-y guide ball and related components of FIG. 16.

FIG. 18 is a perspective view of a lens driving device according to a first embodiment of the present invention with a cover, an AF carrier, an OIS-y carrier, and a substrate removed.

FIG. 19 is a perspective view of FIG. 18 with a base removed.

FIG. 20 is a drawing illustrating a process of forming an AF carrier assembly by coupling an AF magnet to an AF carrier.

FIG. 21 is a drawing illustrating a process in which an OIS-y magnet and an AF attractive force yoke are coupled to an OIS-y carrier to form an OIS-y carrier assembly.

FIG. 22 is a drawing illustrating a process in which an OIS-x magnet and an OIS-y attractive force yoke are coupled to an OIS-x carrier to form an OIS-x carrier assembly.

FIG. 23 is a drawing illustrating a process in which an OIS-x attractive force yoke and a substrate assembly are coupled to a base. At this time, the substrate assembly may comprise a substrate, and a coil and a sensor coupled to the substrate.

FIG. 24 is a drawing illustrating a process in which an OIS-x guide ball and an OIS-x carrier assembly are coupled in a final state of FIG. 23.

FIG. 25 is a drawing illustrating a process in which an OIS-y guide ball and an OIS-y carrier assembly and an AF guide ball are coupled in a final state of FIG. 24.

FIG. 26 is a drawing illustrating the process of assembling an AF carrier assembly and a cover into a lens driving device by coupling them in the final state of FIG. 25.

FIGS. 27 to 29 are drawings for explaining the auto focus driving of a lens driving device according to a first embodiment of the present invention. FIG. 27 is a cross-sectional view illustrating the appearance of an AF moving part in an initial state in which no current is applied to the AF coil. FIG. 28 is a cross-sectional view illustrating the appearance of an AF moving part moving upward in an optical axis direction when a forward current is applied to an AF coil. FIG. 29 is a cross-sectional view illustrating the appearance of the AF moving part moving downward in an optical axis direction when a reverse current is applied to an AF coil.

FIGS. 30 to 32 are drawings for explaining the handshake correction driving of a lens driving device according to a first embodiment of the present invention. FIG. 30 is a cross-sectional view illustrating the appearance of a moving part in an initial state in which no current is applied to an OIS-y coil and an OIS-x coil. FIG. 31 is a cross-sectional view illustrating a state in which an OIS-x moving part, an OIS-y moving part, and an AF moving part move in an x-axis direction perpendicular to the optical axis when current is applied to an OIS-x coil. FIG. 32 is a cross-sectional view illustrating a state in which an OIS-y moving part and an AF moving part move in a y-axis direction perpendicular to the optical axis when current is applied to the OIS-y coil.

FIG. 33 is an exploded perspective view of a camera device according to a first embodiment of the present invention.

FIG. 34 is a perspective view of optics according to a first embodiment of the present invention.

FIG. 35 is a perspective view of optics according to a modified embodiment.

FIG. 36 is a perspective view of a lens driving device according to a second embodiment of the present invention.

FIG. 37 (a) is a plan view of a lens driving device according to a second embodiment of the present invention, and (b) is a side view.

FIG. 38 is a cross-sectional view taken along line a-a of FIG. 36.

FIG. 39 is a cross-sectional view taken along line b-b of FIG. 36.

FIG. 40 is a cross-sectional view taken along line c-c of FIG. 36.

FIG. 41 is a cross-sectional view taken along line d-d of FIG. 36.

FIG. 42 is a cross-sectional view taken along line e-e of FIG. 36.

FIG. 43 is a cross-sectional view illustrating a cross-section of a lens driving device according to a second embodiment of the present invention cut in a direction perpendicular to an optical axis.

FIG. 44 is an exploded perspective view of a lens driving device according to a second embodiment of the present invention.

FIG. 45 is a plan view and a partially enlarged view of a lens driving device according to a second embodiment of the present invention with a cover removed.

FIG. 46 is a perspective view of a lens driving device according to a second embodiment of the present invention with a cover removed.

FIG. 47 is a partially enlarged see-through view of a portion of FIG. 46.

FIG. 48 is a perspective view of a lens driving device according to a second embodiment of the present invention with a cover and an AF carrier removed.

FIG. 49 is a bottom perspective view of an OIS-y carrier of a lens driving device according to a second embodiment of the present invention.

FIG. 50 is a partially enlarged view of FIG. 48 with an OIS-y carrier removed.

FIG. 51 is an enlarged view of an AF guide shaft and an OIS-y guide ball and related configuration of FIG. 50.

FIG. 52 is a perspective view of a lens driving device according to a second embodiment of the present invention with a cover, an AF carrier, an OIS-y carrier, and a substrate removed.

FIG. 53 is a perspective view of FIG. 52 with a base removed.

FIG. 54 is a perspective view illustrating an OIS-x carrier, a driving part, a guide member, and an attractive force member.

FIG. 55 is a drawing illustrating a process in which an AF magnet and a shaft are coupled to an AF carrier to form an AF carrier assembly.

FIG. 56 is a drawing illustrating a process in which an OIS-y magnet is coupled to an OIS-y carrier to form an OIS-y carrier assembly.

FIG. 57 is a drawing illustrating a process in which an OIS-x magnet and an OIS-y attractive force yoke are coupled to an OIS-x carrier to form an OIS-x carrier assembly.

FIG. 58 is a drawing illustrating a process in which an OIS-x attractive force yoke and a substrate assembly are coupled to a base. At this time, the substrate assembly may comprise a substrate, and a coil and a sensor coupled to the substrate.

FIG. 59 is a drawing illustrating a process in which an OIS-x guide ball and an OIS-x carrier assembly are coupled in a final state of FIG. 58.

FIG. 60 is a drawing illustrating a process in which an OIS-y guide ball and an OIS-y carrier assembly are coupled in a final state of FIG. 59.

FIG. 61 is a drawing illustrating the process of assembling an AF carrier assembly and a cover into a lens driving device by coupling them in a final state of FIG. 60.

FIGS. 62 to 64 are drawings for explaining an auto focus driving of a lens driving device according to a second embodiment of the present invention. FIG. 62 is a cross-sectional view illustrating the appearance of an AF moving part in an initial state in which no current is applied to an AF coil. FIG. 63 is a cross-sectional view illustrating the appearance of an AF moving part moving upward in an optical axis direction when a forward current is applied to an AF coil. FIG. 64 is a cross-sectional view illustrating the appearance of an AF moving part moving downward in an optical axis direction when a reverse current is applied to an AF coil.

FIGS. 65 to 67 are drawings for explaining the handshake correction driving of a lens driving device according to a second embodiment of the present invention. FIG. 65 is a cross-sectional view illustrating the appearance of a moving part in an initial state in which no current is applied to an OIS-y coil and an OIS-x coil. FIG. 66 is a cross-sectional view illustrating an OIS-x moving part, an OIS-y moving part, and an AF moving part moving in an x-axis direction perpendicular to the optical axis when current is applied to an OIS-x coil. FIG. 67 is a cross-sectional view illustrating an OIS-y moving part and an AF moving part moving in a y-axis direction perpendicular to the optical axis when current is applied to an OIS-y coil.

FIG. 68 is an exploded perspective view of a camera device according to a second embodiment of the present invention.

FIG. 69 is a perspective view of optics according to a second embodiment of the present invention.

FIG. 70 is a perspective view of optics according to a modified embodiment.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (comprising technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may comprise the plural form unless specifically stated in the phrase, and when described as “at least one (or more than one) of A and B and C”, it may comprise one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also comprise cases of being ‘connected’, ‘coupled’, or ‘interconnected’ due that another component between that other components.

In addition, when described as being formed or disposed in “on (above)” or “below (under)” of each component, “on (above)” or “below (under)” means that it comprises not only the case where the two components are directly in contact with, but also the case where one or more other components are formed or disposed between the two components. In addition, when expressed as “on (above)” or “below (under)”, the meaning of not only an upward direction but also a downward direction with respect to one component may be comprised.

The ‘optical axis (see OA of FIG. 27) direction’ used hereinafter is defined as an optical axis direction of a lens and/or image sensor being coupled to a lens driving device.

The ‘vertical direction’ used hereinafter may be a direction parallel to or the same as an optical axis direction. The vertical direction may correspond to a ‘z-axis direction’. The ‘horizontal direction’ used hereinafter may be a direction perpendicular to a vertical direction. That is, a horizontal direction may be a direction perpendicular to the optical axis. Therefore, a horizontal direction may comprise an ‘x-axis direction’ and a ‘y-axis direction’.

The ‘auto focus (AF) function’ used hereinafter is defined as a function that automatically focuses on a subject by adjusting the distance from an image sensor by moving the lens in an optical axis direction according to the distance of the subject so that a clear image of the subject can be obtained on an image sensor. In addition, ‘closed-loop auto focus (CLAF) control’ is defined as detecting the distance between an image sensor and a lens and controlling the position of the lens through feedback in real time in order to improve the accuracy of focus adjustment.

The ‘optical image stabilization (OIS) function’ used hereinafter is defined as a function that moves or tilts a lens in a direction perpendicular to the optical axis to offset shaking hand in order to prevent an image or video from handshaking due to the user's shaking hand. In addition, ‘closed-loop auto focus (CLAF) control’ is defined as detecting the position of a lens with respect to an image sensor and controlling the feedback of the lens position in real time in order to improve the accuracy of shaking hand correction.

Hereinafter, one among an “OIS-x moving part 200”, “OIS-y moving part 300” and “AF moving part 400” may be referred to as a “first moving part”, the other may be referred to as a “second moving part”, and yet the other may be referred to as a “third moving part”. In addition, a “moving part” may be referred to as a “moving body” or a “mover”.

Hereinafter, one among an “AF carrier 210”, an “OIS-x carrier 310”, and an “OIS-y carrier 410” is referred to as a “first carrier”, the other is referred to as a “second carrier”, and yet the other may be referred to as a “third carrier”. In addition, a “carrier” may be referred to as a “holder”, a “frame”, or a “spacer”.

Hereinafter, one among an “AF drive unit 500”, an “OIS-x driving part 600”, and an “OIS-y driving part 700” is referred to as a “first driving part”, the other is referred to as a “second drive part”, and yet the other may be referred to as a “third driving part”.

Hereinafter, one among an “AF magnet 510”, an “OIS-x magnet 610”, and an “OIS-y magnet 710” is referred to as a “first magnet”, the other is referred to as a “second magnet”, and yet the other may be referred to as a “third magnet”. Meanwhile, a “magnet” may be referred to as a “magnet”, or a “permanent magnet”.

Hereinafter, one among an “AF coil 520”, an “OIS-x coil 620”, and an “OIS-y coil 720” may be referred to as a “first coil”, the other is referred to as a “second coil”, and yet the other may be referred to as a “third coil”.

Hereinafter, one among an “AF sensor 530”, an “OIS-x sensor 630”, and an “OIS-y sensor 730” may be referred to as a “first sensor”, the other may be referred to as a “second sensor”, and yet the other may be referred to as a “third sensor”.

Hereinafter, one among an “AF guide ball 810”, an “OIS-x guide ball 820”, and an “OIS-y guide ball 830” is referred to as a “first guide ball”, the other is referred to as a “second guide ball”, and yet the other may be referred to as a “third guide ball”. In addition, the “guide ball” may be referred to as a “ball”. Alternatively, the “guide ball” may be referred to as a “ball part”.

Hereinafter, one among an “AF attractive force yoke 910”, an “OIS-x attractive force yoke 920”, and an “OIS-y attractive force yoke 930” is referred to as a “first yoke”, the other is referred to as a “second yoke”, and yet the other may be referred to as a “third yoke”.

Hereinafter, among a “groove 111”, a “groove 211”, a “groove 311”, a “groove 312”, a “groove 211” and a “groove”, at least any one or more is referred to as a “first groove”, at least one other is referred to as a “second groove”, at least one another is referred to as a “third groove”, at least one another is referred to as a “fourth groove”, at least one another is referred to as a “fifth groove” and at least one another may be referred to as a “sixth groove”. For example, the “first groove” may collectively refer to as a “groove 211” where the AF guide ball 810 is disposed and a “groove 211”, the “second groove” is collectively refer to as a “groove 311” where the OIS-y guide ball 830 is disposed and a “groove”, and the “third groove” may collectively refer to as a “groove 111” where the OIS-x guide ball 820 is disposed and a “groove 312”.

Hereinafter, one of an “x-axis direction” and a “y-axis direction” is referred to as a “first direction” and the other may be referred to as a “second direction”.

Hereinafter, one among an “AF moving part 1200”, an “OIS-x moving part 1300”, and an “OIS-y moving part 1400” may be referred to as a “first moving part”, the other is referred to as a “second moving part”, and yet the other may be referred to as a “third moving part”. In addition, a “moving part” may be referred to as a “moving body” or a “mover”.

Hereinafter, one among an “AF carrier 1210”, an “OIS-x carrier 1310”, and an “OIS-y carrier 1410” is referred to as a “first carrier”, the other is referred to as a “second carrier”, and yet the other may be referred to as a “third carrier”. In addition, a “carrier” may be referred to as a “holder”, a “frame”, or a “spacer”.

Hereinafter, one among an “AF driving part 1500”, an “OIS-x driving part 1600”, and an “OIS-y driving part 1700” may be referred to as a “first driving part”, the other is referred to as a “second driving part”, and yet the other may be referred to as a “third driving part”.

Hereinafter, one among an “AF magnet 1510”, an “OIS-x magnet 1610”, and an “OIS-y magnet 1710” is referred to as a “first magnet”, the other is referred to as a “second magnet”, and yet the other may be referred to as a “third magnet”. Meanwhile, a “magnet” may be referred to as a “magnet” or a “permanent magnet”.

Hereinafter, one among an “AF coil 1520”, an “OIS-x coil 1620”, and an “OIS-y coil 1720” is referred to as a “first coil”, the other is referred to as a “second coil”, and yet the other may be referred to as a “third coil”.

Hereinafter, one among an “AF sensor 1530”, an “OIS-x sensor 1630”, and an “OIS-y sensor 1730” is referred to as a “first sensor”, the other is referred to as a “second sensor”, and yet the other may be referred to as a “third sensor”.

Hereinafter, one of an “OIS-x guide ball 1820” and an “OIS-y guide ball 1830” is referred to as a “first guide ball” and the other may be referred to as a “second guide ball”.

Hereinafter, one of an “OIS-x attractive force yoke 1920” and an “OIS-y attractive force yoke 1930” is referred to as a “first yoke” and the other may be referred to as a “second yoke”.

Hereinafter, among a “groove111”, a “groove1211”, a “groove1311”, a “groove1312”, a “groove1411” and a “groove 1412”, at least any one or more is referred to as a “first groove”, at least one other is referred to as a “second groove”, at least one another is referred to as a “third groove”, at least one another is referred to as a “fourth groove”, at least one another is referred to as a “fifth groove” and at least one another may be referred to as a “sixth groove”. For example, the “first groove” may collectively refer to as a “groove 1211” where the AF guide ball 1810 is disposed and a “groove 1411”, the “second groove” is collectively refer to as a “groove 1311” where the OIS-y guide ball 1830 is disposed and a “groove 1412”, and the “third groove” may collectively refer to as a “groove 1111” where the OIS-x guide ball 1820 is disposed and a “groove 1312”.

Hereinafter, one among an “x-axis”, a “y-axis”, and a “z-axis” is referred to as a “first axis”, the other is referred to as a “second axis”, and yet the other may be referred to as a “third axis”.

Hereinafter, a configuration of a lens driving device according to a first embodiment of the present invention will be described with reference to the drawings.

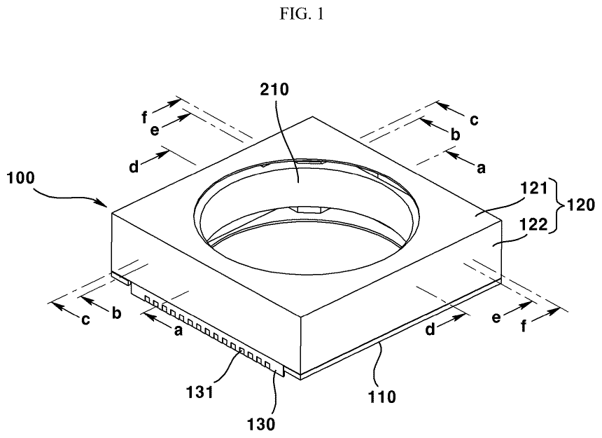

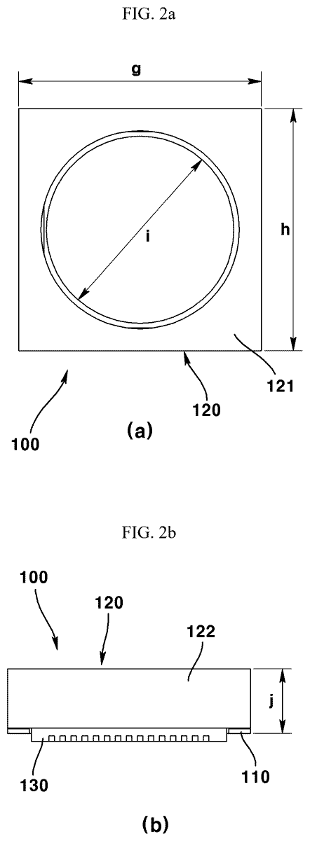

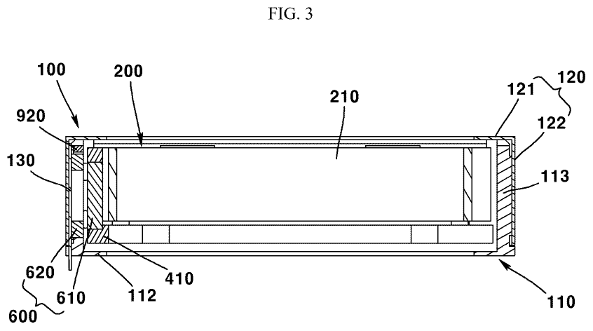

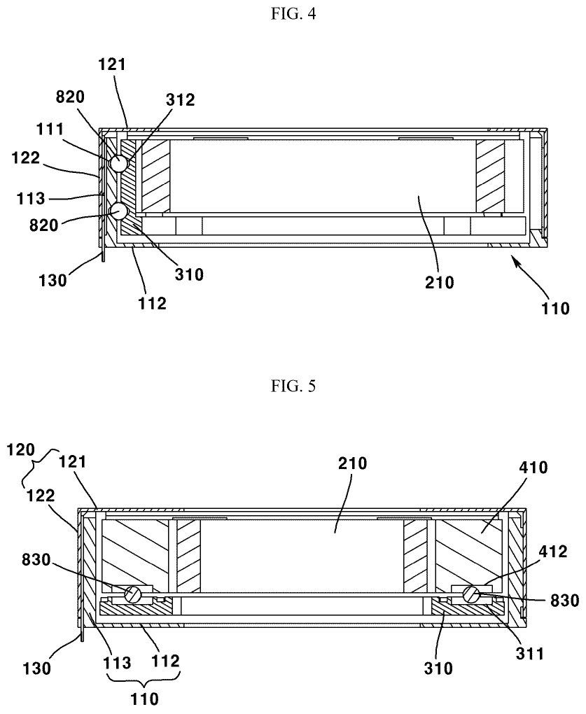

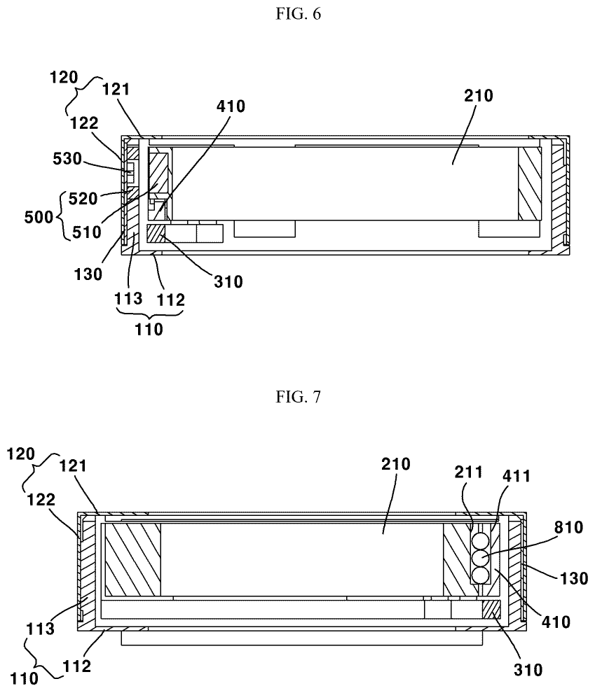

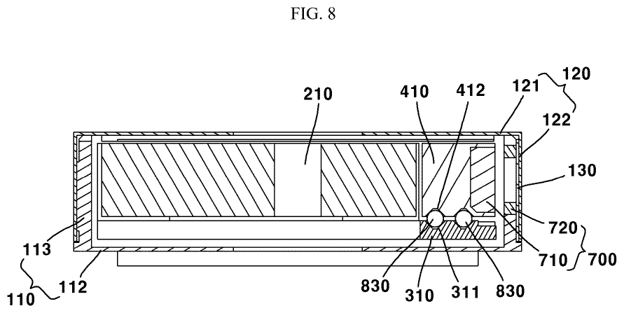

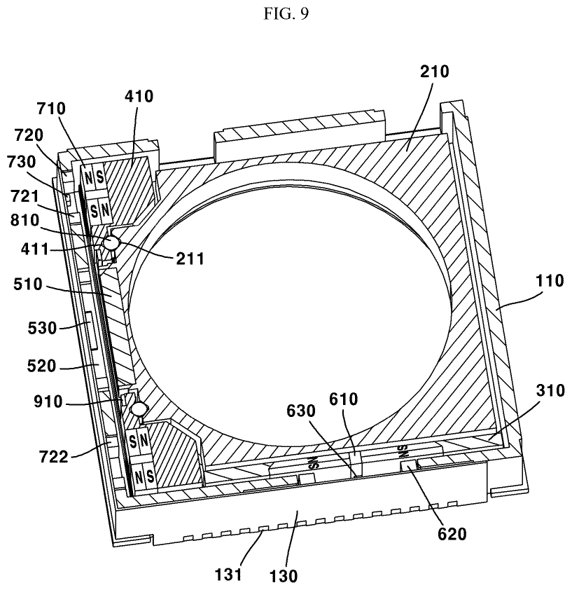

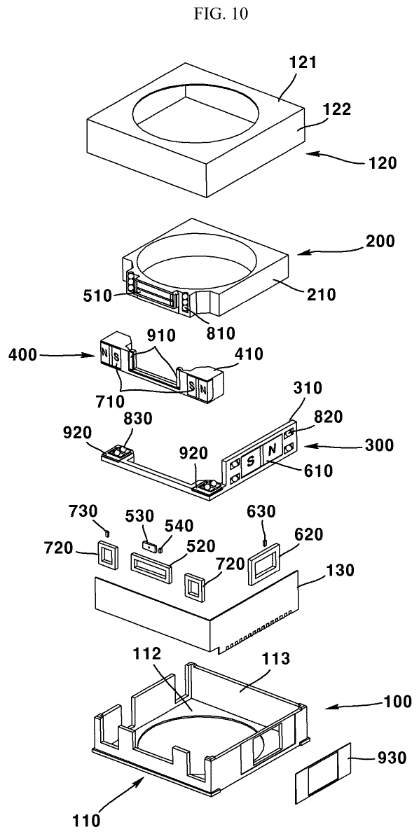

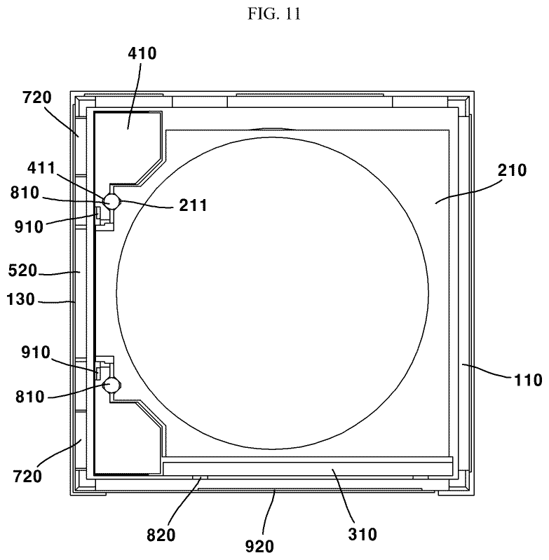

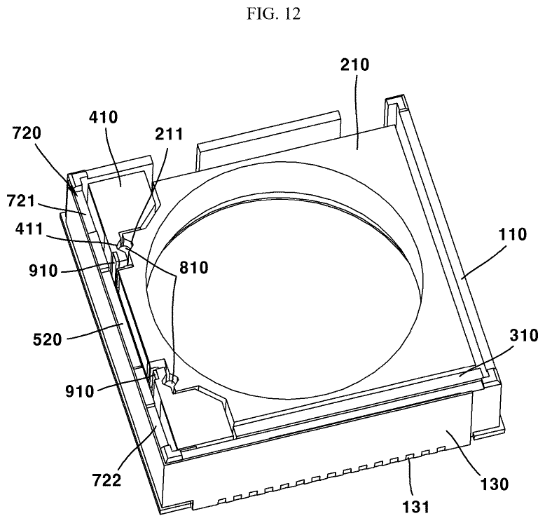

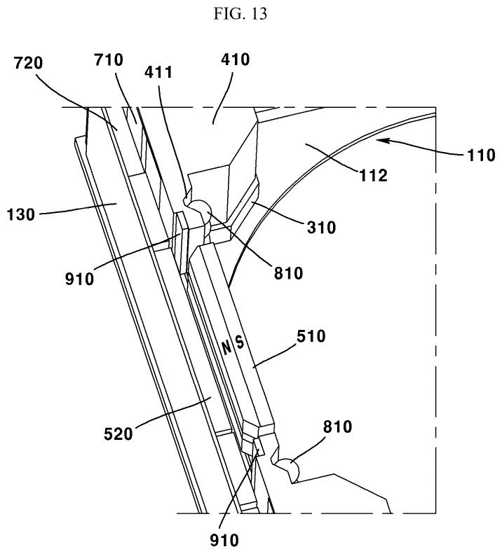

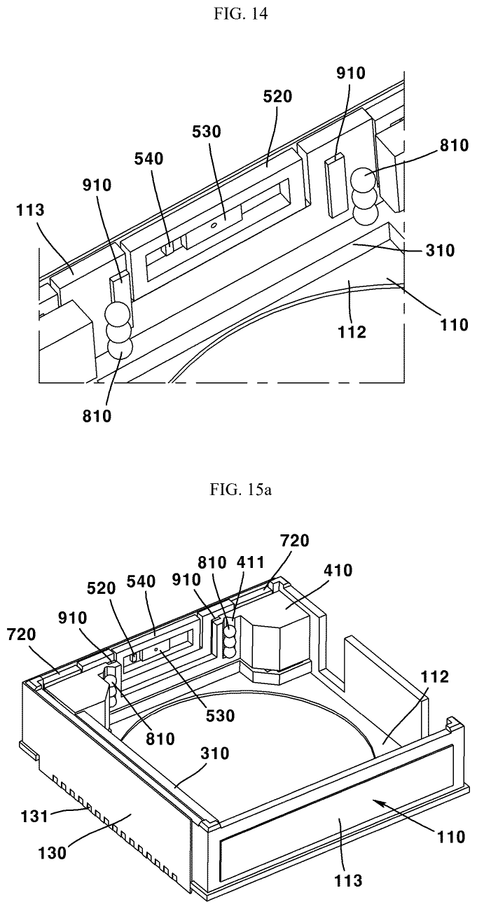

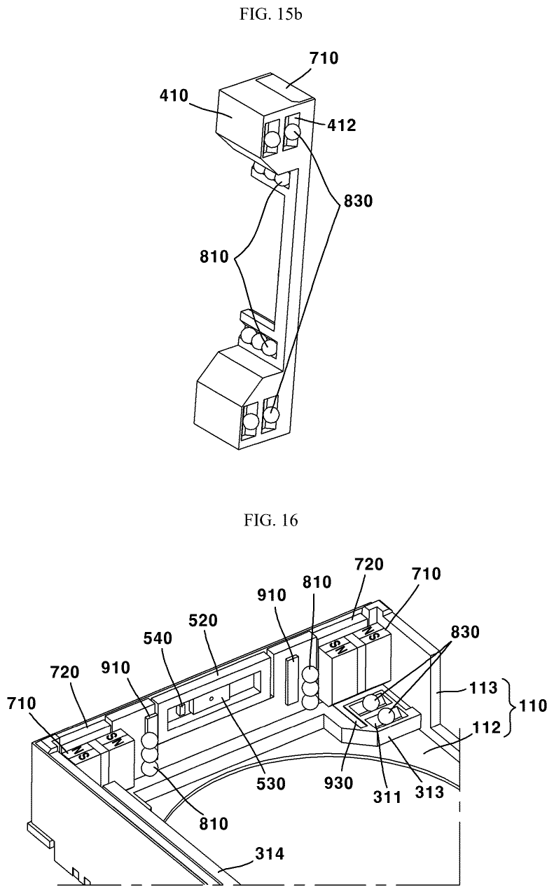

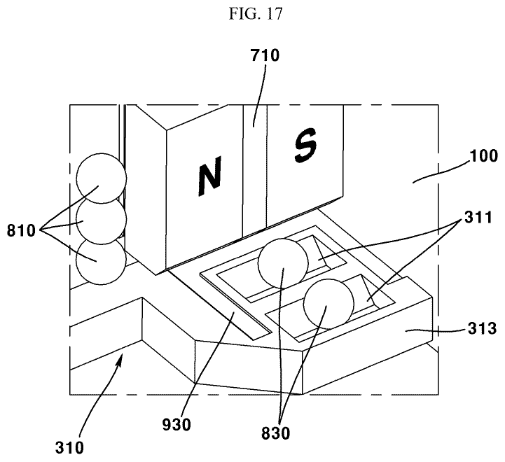

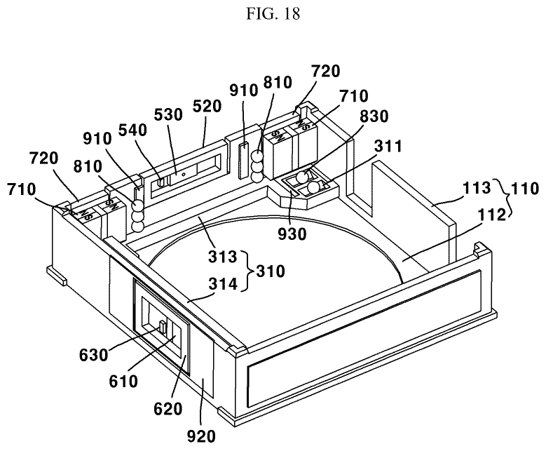

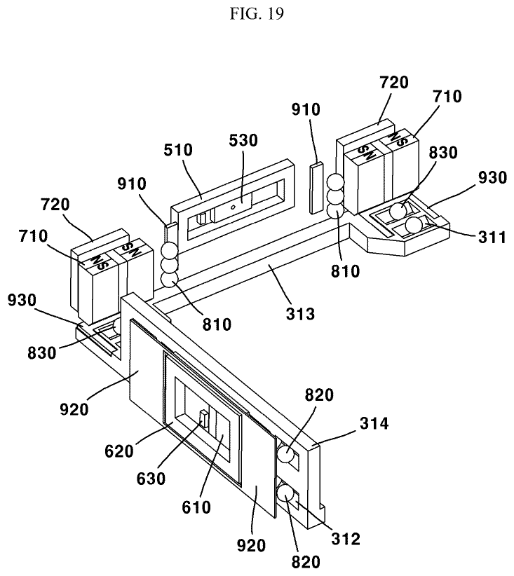

FIG. 1 is a perspective view of a lens driving device according to a first embodiment of the present invention; FIG. 2 a is a plan view of a lens driving device according to a first embodiment of the present invention, and b is a side view; FIG. 3 is a cross-sectional view taken along line a-a of FIG. 1; FIG. 4 is a cross-sectional view taken along line b-b of FIG. 1; FIG. 5 is a cross-sectional view taken along line c-c of FIG. 1; FIG. 6 is a cross-sectional view taken along line d-d of FIG. 1; FIG. 7 is a cross-sectional view taken along line e-e of FIG. 1; FIG. 8 is a cross-sectional view taken along line f-f of FIG. 1; FIG. 9 is a cross-sectional perspective view illustrating a cross-section of a lens driving device according to a first embodiment of the present invention cut in a direction perpendicular to an optical axis; FIG. 10 is an exploded perspective view of a lens driving device according to a first embodiment of the present invention; FIG. 11 is a plan view of a lens driving device according to a first embodiment of the present invention with the cover removed; FIG. 12 is a perspective view of a lens driving device according to a first embodiment of the present invention with the cover removed; FIG. 13 is a partial enlarged view of FIG. 12; FIG. 14 is a perspective view illustrating an AF attractive force yoke and related components of a lens driving device according to a first embodiment of the present invention; FIG. 15a is a perspective view of a lens driving device according to a first embodiment of the present invention with a cover and an AF carrier removed; FIG. 15b is a bottom perspective view of an OIS-y carrier of a lens driving device according to a first embodiment of the present invention; FIG. 16 is a partial enlarged view of FIG. 15a with an OIS-y carrier removed; FIG. 17 is an enlarged view illustrating an enlarged view of an OIS-y guide ball and related components of FIG. 16; FIG. 18 is a perspective view of a lens driving device according to a first embodiment of the present invention with a cover, an AF carrier, an OIS-y carrier, and a substrate removed; and FIG. 19 is a perspective view of FIG. 18 with a base removed.

The lens driving device 10 may be a voice coil motor (VCM). The lens driving device 10 may be a lens driving motor. The lens driving device 10 may be a lens driving actuator. The lens driving device 10 may comprise an AF module. The lens driving device 10 may comprise an OIS module.

The lens driving device 10 may comprise a fixed part 100. The fixed part 100 may be a part that is relatively fixed when the moving part moves. The moving part may move against the fixed part 100. The fixed part 100 may be disposed outside the moving part. The fixed part 100 may accommodate the moving part inside therein.

The lens driving device 10 may comprise a base 110. The fixed part 100 may comprise the base 110. The base 110 may be disposed below the AF carrier 210. The base 110 may be disposed below the OIS-x carrier 310. The base 110 may be disposed below the OIS-y carrier 410. The base 110 may be coupled with the cover 120. The AF carrier 210, the OIS-x carrier 310, and the OIS-y carrier 410 may be disposed on the base 110. The AF carrier 210, the OIS-x carrier 310, and the OIS-y carrier 410 may be disposed on the lower plate 112 of the base 110. The AF carrier 210, the OIS-x carrier 310, and the OIS-y carrier 410 may be disposed inside the base 110. The AF carrier 210, the OIS-x carrier 310, and the OIS-y carrier 410 may be disposed inside the side plate 113 of the base 110.

The base 110 may comprise a groove 111. The groove 111 may be an ‘OIS-x guide ball accommodating groove’. The groove 111 may be concavely formed in the base 110. The groove 111 may be formed by recessing one surface of the base 110. The groove 111 may be formed in a side plate 113 of the base 110. The groove 111 may be formed on an inner surface of the side plate 113 of the base 110. An OIS-x guide ball 820 may be disposed in the groove 111. The groove 111 may be in direct contact with the OIS-x guide ball 820. The groove 111 may be disposed in a y-axis direction perpendicular to the optical axis. The groove 111 may comprise a plurality of grooves. The groove 111 may comprise four grooves. The four grooves may be disposed parallel to one another. The groove 111 may comprise a first groove being in contact with the OIS-x guide ball 820 at two points, and a second groove being in contact with the OIS-x guide ball 820 at one point. In a variation, both the first groove and the second groove may be in contact with the OIS-x guide ball 820 at two points.

The base 110 may comprise a lower plate 112. The lower plate 112 may be a ‘bottom plate’. The base 110 may comprise a side plate 113. The side plate 113 of the base 110 may be a ‘side portion’. The side plate 113 of the base 110 may be extended from an upper surface of the lower plate 112. The side plate 113 of the base 110 may comprise a plurality of side plates. The side plate 113 of the base 110 may comprise four side plates. The base 110 may comprise a first side portion and a second side portion being disposed opposite to each other, and a third side portion and a fourth side portion being disposed opposite to each other. The AF coil 520 and the OIS-y coil 720 may be disposed in the first side portion of the base 110. The OIS-x coil 620 can be disposed in the third side portion of the base 110.

The base 110 may comprise a groove 114. The groove 114 may be a ‘yoke accommodating groove’. The groove 114 may be formed in a side plate 113 of the base 110. The groove 114 may be formed on an outer side surface of the side plate 113 of the base 110. An OIS-x attractive force yoke 920 may be disposed in the groove 114. The groove 114 may comprise a shape corresponding to at least a portion of the OIS-x attractive force yoke 920.

The lens driving device 10 may comprise a cover 120. The fixed part 100 may comprise a cover 120. The cover 120 may be disposed in the base 110. The cover 120 may be disposed on the base 110. The cover 120 may be coupled to the base 110. The cover 120 may be fixed to the base 110. The cover 120 may be attached to the base 110 with an adhesive. The cover 120 may accommodate an AF carrier 210 therein. The cover 120 may accommodate an OIS-x carrier 310 therein. The cover 120 may accommodate an OIS-y carrier 410 therein. The cover 120 may be a shield member. The cover 120 may be a shield can.

The cover 120 may comprise an upper plate 121. The upper plate 121 may be disposed on a moving part. The upward movement of the moving part may be limited by the moving part being in contact with the upper plate 121. The upper plate 121 may comprise a hole through which light passes.

The cover 120 may comprise a side plate 122. The side plate 122 may be extended from the upper plate 121. The side plate 122 may be disposed in the base 110. The side plate 122 may be disposed on a step portion being protruded from a lower portion of an outer side surface of the base 110. The side plate 122 may comprise a plurality of side plates. The side plate 122 may comprise four side plates. The side plate 122 may comprise a first side plate and a second side plate being disposed opposite to each other, and a third side plate and a fourth side plate being disposed opposite to each other.

In a first embodiment of the present invention, the AF coil 520 and the OIS-y coil 720 may be disposed between the moving part and the first side plate of the cover 120. The AF coil 520 and the OIS-y coil 720 may be disposed between the AF carrier 210 and the first side plate of the cover 120. The AF coil 520 and the OIS-y coil 720 may be disposed between the OIS-y carrier 410 and the first side plate of the cover 120. The AF coil 520 and the OIS-y coil 720 may be disposed in the first side plate of the cover 120. The AF coil 520 and the OIS-y coil 720 may be disposed at a position corresponding to the first side plate of the cover 120.

The lens driving device 10 may comprise a substrate 130. The fixed part 100 may comprise a substrate 130. The substrate 130 may be disposed in the base 110. The substrate 130 may be disposed in the side plate 113 of the base 110. The substrate 130 may be disposed on an outer side surface of the side plate 122 of the cover 120. The substrate 130 may be disposed parallel to an optical axis. The substrate 130 may be a circuit board. The substrate 130 may be a printed circuit board. The substrate 130 may comprise a flexible printed circuit board FPCB. The substrate 130 may be flexible. The substrate 130 may be bent.

The substrate 130 may comprise a first portion and a third portion being disposed at an opposite side to each other, and a second portion which connects the first portion and the third portion. At this time, the OIS-y coil 720 may be disposed on a first portion of the substrate 130. The OIS-x coil 620 may be disposed in a second portion of the substrate 130. The AF coil 520 may be disposed in a third portion of the substrate 130.

The substrate 130 may comprise a body portion. Coils 510, 610, and 710 may be disposed in the body portion. The substrate 130 may comprise a terminal 131. The terminal 131 may be disposed in a terminal portion being extended downward from the body portion. The terminal 131 may be formed at a lower portion of the substrate 130. The terminal 131 may be protruded downward from the base 110.

The terminal 131 may comprise a plurality of terminals. The terminal 131 of the substrate 130 may be electrically connected to the coils 510, 610, and 710. The terminal 131 of the substrate 130 may be electrically connected to the AF coil 520. The terminal 131 of the substrate 130 may be electrically connected to the OIS-x coil 620. The terminal 131 of the substrate 130 may be electrically connected to the OIS-y coil 720. The terminal 131 of the substrate 130 may be electrically connected to the sensors 530, 630, and 730. The terminal 131 of the substrate 130 may be electrically connected to the AF sensor 530. The terminal 131 of the substrate 130 can be electrically connected to the OIS-x sensor 630. The terminal 131 of the substrate 130 can be electrically connected to the OIS-y sensor 730. The terminal 131 can be coupled to the printed circuit board 50. The terminal 131 can be coupled to the printed circuit board 50 via solder. The terminal 131 can be coupled to the printed circuit board 50 via a conductive member.

The lens driving device 10 may comprise a moving part. The moving part may be disposed in the fixed part 100. The moving part may be disposed inside the fixed part 100. The moving part may be disposed on the fixed part 100. The moving part may be movably disposed in the fixed part 100. The moving part may be moved with respect to the fixed part 100 by a driving part. The moving part may be moved during AF driving. The moving part may be moved during OIS driving. A lens may be coupled to the moving part.

The lens driving device 10 may comprise an AF moving part 200. The AF moving part 200 may be disposed in the fixed part 100. The AF moving part 200 may be disposed inside the fixed part 100. The AF moving part 200 may be disposed on the fixed part 100. The AF moving part 200 may be disposed inside the OIS-x moving part 300. The AF moving part 200 may be disposed on the OIS-x moving part 300. The AF moving part 200 may be disposed inside the OIS-y moving part 400. The AF moving part 200 may be disposed on the OIS-y moving part 400. The AF moving part 200 may be movably disposed. The AF moving part 200 can move in an optical axis direction against the fixed part 100, the OIS-x moving part 300, and the OIS-y moving part 400 by the AF driving unit 500. The AF moving part 200 can move during AF driving.

When a current is applied to the OIS-y coil 720, the AF moving part 200 can move together with the OIS-y moving part 400. When a current is applied to the OIS-x coil 620, the AF moving part 200 and the OIS-y moving part 400 can move together with the OIS-x moving part 300.

The lens driving device 10 may comprise an AF carrier 210. The AF moving part 200 may comprise an AF carrier 210. The AF carrier 210 may be a ‘bobbin’. The AF carrier 210 may be an ‘AF holder’. The AF carrier 210 may be disposed inside the base 110. The AF carrier 210 may be disposed on the base 110. The AF carrier 210 may be disposed inside the OIS-x carrier 310. The AF carrier 210 may be disposed on the OIS-x carrier 310. The AF carrier 210 may be disposed inside the OIS-y carrier 410. The AF carrier 210 may be disposed on the OIS-y carrier 410. The AF carrier 210 can be disposed inside the cover 120. The AF carrier 210 can be movably disposed in an optical axis direction.

The AF carrier 210 may comprise a groove 211. The groove 211 may be an ‘AF guide ball accommodating groove’. An AF guide ball 810 may be disposed in the groove 211. The groove 211 may be in direct contact with the AF guide ball 810. The groove 211 may be disposed in an optical axis direction. The groove 211 may comprise a plurality of grooves. The groove 211 may comprise two grooves. The groove 211 may comprise a first groove being in contact with the AF guide ball 810 at two points, and a second groove being in contact with the AF guide ball 810 at one point. In a modified embodiment, both the first groove and the second groove may contact the AF guide ball 810 at two points.

The AF carrier 210 may comprise a groove 212. The groove 212 may be an ‘AF magnet accommodating groove’. The groove 212 may be formed on an outer side surface of the AF carrier 210. An AF magnet 510 may be disposed in the groove 212. The groove 212 may be formed in a shape corresponding to the AF magnet 510.

The lens driving device 10 may comprise an OIS-x moving part 300. The OIS-x moving part 300 may be disposed in the fixed part 100. The OIS-x moving part 300 may be disposed inside the fixed part 100. The OIS-x moving part 300 may be disposed on the fixed part 100. The OIS-x moving part 300 may be disposed below the OIS-y moving part 400. The OIS-x moving part 300 may be disposed between the fixed part 100 and the AF moving part 200. The OIS-x moving part 300 may be disposed between the fixed part 100 and the OIS-y moving part 400. The OIS-x moving part 300 may be movably disposed. The OIS-x moving part 300 can move in an x-axis direction against the fixed part 100 by the OIS-x driving unit 600. The OIS-x moving part 300 can move during OIS driving. When the OIS-x moving part 300 moves in an x-axis direction, the OIS-y moving part 400 and the AF moving part 200 can also move together.

The lens driving device 10 may comprise an OIS-x carrier 310. The OIS-x moving part 300 may comprise an OIS-x carrier 310. The OIS-x carrier 310 may be an ‘OIS-x holder’. The OIS-x carrier 310 may be disposed inside the base 110. The OIS-x carrier 310 may be disposed on the base 110. The OIS-x carrier 310 may be disposed below the OIS-y carrier 410. The OIS-x carrier 310 may be disposed inside the cover 120. The OIS-x carrier 310 may be disposed between the base 110 and the AF carrier 210. The OIS-x carrier 310 can be disposed between the base 110 and the OIS-y carrier 410. The OIS-x carrier 310 can be movably disposed in an x-axis direction.

The OIS-x carrier 310 may comprise a groove 311. The groove 311 may be an ‘OIS-y guide ball accommodating groove’. The groove 311 may be formed in a lower plate 313 of the OIS-x carrier 310. The groove 311 may be formed on an upper surface of the lower plate 313 of the OIS-x carrier 310. An OIS-y guide ball 830 may be disposed in the groove 311. The groove 311 may be in direct contact with the OIS-y guide ball 830. The groove 311 may be disposed in a y-axis direction. The groove 311 may comprise a plurality of grooves. The groove 311 may comprise four grooves. The groove 311 may comprise a first groove being in contact with the OIS-y guide ball 830 at two points, and a second groove being in contact with the OIS-y guide ball 830 at one point. In a modified embodiment, both the first groove and the second groove may contact the AF guide ball 810 at two points.

The OIS-x carrier 310 may comprise a groove 312. The groove 312 may be an ‘OIS-x guide ball accommodating groove’. The groove 312 may be formed in a side plate 314 of the OIS-x carrier 310. The groove 312 may be formed on an outer surface of the side plate 314 of the OIS-x carrier 310. An OIS-x guide ball 820 may be disposed in the groove 312. The groove 312 may be in direct contact with the OIS-x guide ball 820. The groove 312 may be disposed in an x-axis direction. The groove 312 may comprise a plurality of grooves. The groove 312 may comprise four grooves. The groove 312 may comprise a first groove being in contact with the OIS-x guide ball 820 at two points, and a second groove being in contact with the OIS-x guide ball 820 at one point. In a modified embodiment, both the first groove and the second groove may contact the OIS-x guide ball 820 at two points.

The OIS-x carrier 310 may comprise a lower plate 313. The lower plate 313 of the OIS-x carrier 310 may be disposed between the base 110 and the OIS-y carrier 410 in an optical axis direction. The lower plate 313 may be disposed perpendicular to the optical axis.

The OIS-x carrier 310 may comprise a side plate 314. The side plate 314 of the OIS-x carrier 310 may be disposed between the base 110 and the AF carrier 210 in a y-axis direction. The side plate 314 may be connected to the lower plate 313. The side plate 314 may be disposed parallel to an optical axis.

The OIS-x carrier 310 may comprise a hole 315. The hole 315 may be an ‘OIS-x magnet accommodating hole’. The hole 315 may be formed in a side plate 314 of the OIS-x carrier 310. The hole 315 may penetrate the OIS-x carrier 310 in a y-axis direction. An OIS-x magnet 610 may be disposed in the hole 315. The hole 315 may comprise a shape corresponding to the OIS-x magnet 610.

The lens driving device 10 may comprise an OIS-y moving part 400. The OIS-y moving part 400 may be disposed in the fixed part 100. The OIS-y moving part 400 may be disposed inside the fixed part 100. The OIS-y moving part 400 may be disposed on the fixed part 100. The OIS-y moving part 400 may be disposed on the OIS-x moving part 300. The OIS-y moving part 400 may be disposed on the OIS-x moving part 300. The OIS-y moving part 400 may be disposed between the fixed part 100 and the AF moving part 200. The OIS-y moving part 400 may be disposed between the fixed part 100 and the AF moving part 200 in a direction perpendicular to the optical axis. The OIS-y moving part 400 can be disposed between the fixed part 100 and the AF moving part 200 in an x-axis direction. The OIS-y moving part 400 can be movably disposed in the fixed part 100. The OIS-y moving part 400 can move in a y-axis direction against the fixed part 100 by the OIS-y driving unit 700. The OIS-y moving part 400 can move during OIS driving. When the OIS-y moving part 400 moves, the AF moving part 200 can also move together.

The lens driving device 10 may comprise an OIS-y carrier 410. The OIS-y moving part 400 may comprise an OIS-y carrier 410. The OIS-y carrier 410 may be an ‘OIS-y holder’. The OIS-y carrier 410 may be disposed in the base 110. The OIS-y carrier 410 may be disposed inside the base 110. The OIS-y carrier 410 may be disposed on the base 110. The OIS-y carrier 410 may be disposed inside the cover 120. The OIS-y carrier 410 may be disposed on the OIS-x carrier 310. The OIS-y carrier 410 may be disposed on the OIS-x carrier 310. The OIS-y carrier 410 can be disposed between the base 110 and the AF carrier 210. The OIS-y carrier 410 can be disposed between the base 110 and the AF carrier 210 in a direction perpendicular to the optical axis. The OIS-y carrier 410 can be disposed between the side plate 113 of the base 110 and the AF carrier 210 in an x-axis direction. The OIS-y carrier 410 can be movably disposed in a y-axis direction.

The OIS-y carrier 410 may comprise a groove 411. The groove 411 may be an ‘AF guide ball accommodating groove’. The groove 411 may be concavely formed in the OIS-y carrier 410. The groove 411 may be formed on an inner surface of the OIS-y carrier 410. An AF guide ball 810 may be disposed in the groove 411. The groove 411 may be in direct contact with the AF guide ball 810. The groove 411 may be disposed in an optical axis direction. The groove 411 may comprise a plurality of grooves. The groove 411 may comprise two grooves. The groove 411 may comprise a first groove being in contact with the AF guide ball 810 at two points, and a second groove being in contact with the AF guide ball 810 at one point. In a modified embodiment, both the first groove and the second groove can come into contact with the AF guide ball 810 at two points.

The OIS-y carrier 410 may comprise a groove 412. The groove may be an ‘OIS-y guide ball accommodating groove’. The groove 412 may be concavely formed in the OIS-y carrier 410. The groove 412 may be formed on a lower surface of the OIS-y carrier 410. An OIS-y guide ball 830 may be disposed in the groove 412. The groove 412 may be in direct contact with the OIS-y guide ball 830. The groove 412 may be disposed in a y-axis direction. The groove 412 may comprise a plurality of grooves. The groove 412 may comprise four grooves. The four grooves may be disposed parallel to each other. The groove 412 may comprise a first groove being in contact with the OIS-y guide ball 830 at two points, and a second groove being in contact with the OIS-y guide ball 830 at one point. In a modified embodiment, both the first groove and the second groove may contact the OIS-y guide ball 830 at two points.

The OIS-y carrier 410 may comprise a groove 413. The groove 413 may be an ‘OIS-y magnet accommodating groove’. The groove 413 may be formed on an outer side surface of the OIS-y carrier 410. An OIS-y magnet 710 may be disposed in the groove 413. The groove 413 may comprise a shape corresponding to the OIS-y magnet 710.

The OIS-y carrier 410 may comprise a groove 414. The groove 414 may be an ‘AF attractive force yoke accommodating groove’. The groove 414 may be formed on an outer surface of the OIS-y carrier 410. An AF attractive force yoke 910 may be disposed in the groove 414. The groove 414 may comprise a shape corresponding to the AF attractive force yoke 910. The groove 414 may comprise a plurality of grooves. The groove 414 may comprise two grooves.

The lens driving device 10 may comprise a driving part. The driving part may move the moving part against the fixed part. The driving part may comprise an AF driving part 500. The driving part may comprise an OIS driving parts 600 and 700. The driving part may comprise a coil and a magnet.

The lens driving device 10 may comprise an AF driving part 500. The AF driving part 500 may move the AF moving part 200 in an optical axis direction. The AF driving part 500 may move the AF carrier 210 in an optical axis direction. The AF driving part 500 may move the AF carrier 210 in an optical axis direction through electromagnetic force. The AF driving part 500 may comprise a coil and a magnet. The AF driving part 500 may comprise a coil and a magnet that interact with each other. The AF coil 520 and the AF magnet 510 may move the AF moving part 200 in an optical axis direction.

When the OIS-x moving part 300, the OIS-y moving part 400, and the AF moving part 200 are moved by the OIS-x driving part 600, the distance between the facing surfaces of the AF coil 520 and the AF magnet 510 may change. When the OIS-y moving part 400 and the AF moving part 200 are moved by the OIS-y driving part 700, the distance between the facing surfaces of the AF coil 520 and the AF magnet 510 does not change, and the AF magnet 510 may be eccentric against the AF coil 520.

The lens driving device 10 may comprise an AF magnet 510. The AF driving part 500 may comprise an AF magnet 510. The AF magnet 510 may be disposed in the AF moving part 200. The AF magnet 510 may be disposed in the AF carrier 210. The AF magnet 510 may be disposed in the groove 212 of the AF carrier 210. The AF magnet 510 may be disposed on an outer side surface of the AF carrier 210. The AF magnet 510 may be fixed to the AF carrier 210. The AF magnet 510 may be coupled to the AF carrier 210. The AF magnet 510 may be attached to the AF carrier 210 with an adhesive. The AF magnet 510 may be disposed inside the cover 120. The AF magnet 510 may interact with the AF coil 520. The AF magnet 510 may electromagnetically interact with the AF coil 520. The AF magnet 510 may be disposed at a position corresponding to the AF coil 520. The AF magnet 510 may face the AF coil 520. The AF magnet 510 may face the AF coil 520. The AF magnet 510 may be overlapped with the AF coil 520 in a direction perpendicular to the optical axis. The AF magnet 510 may be overlapped with the AF coil 520 in an x-axis direction. In a y-axis direction and an x-axis direction, the AF magnet 510 may not be overlapped with the OIS-x magnet 610.

The AF magnet 510 may be a four-pole magnet. The AF magnet 510 may comprise a four-pole magnetizing magnet. The AF magnet 510 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be disposed spaced apart from each other in a vertical direction, and a neutral portion may be disposed between the first magnet portion and the second magnet portion.

In a y-axis direction, the AF magnet 510 may be overlapped with the OIS-y magnet 710. The OIS-y magnet 710 may comprise a first unit magnet and a second unit magnet being spaced apart from each other. The AF magnet 510 may be disposed between the first unit magnet and the second unit magnet of the OIS-y magnet 710. In a y-axis direction, the AF magnet 510 may be disposed between the first unit magnet and the second unit magnet. The AF magnet 510 and the OIS-y magnet 710 may be disposed on the same side. At this time, in a y-axis direction, the AF magnet 510 may be overlapped with the OIS-y magnet 710. Alternatively, in a y-axis direction, the AF magnet 510 may not be overlapped with the OIS-y magnet 710.

The lens driving device 10 may comprise an AF coil 520. The AF driving part 500 may comprise an AF coil 520. The AF coil 520 may interact with an AF magnet 510. The AF coil 520 may move the AF magnet 510 in an optical axis direction. The AF coil 520 may move the AF magnet 510 in the optical axis direction through interaction with the AF magnet 510. The AF coil 520 may face the AF magnet 510. The AF coil 520 may face the AF magnet 510. The AF coil 520 may be disposed at a position corresponding to the AF magnet 510. The AF coil 520 may be overlapped with the AF magnet 510 in an x-axis direction. The AF coil 520 may be disposed in the substrate 130. The AF coil 520 may be disposed at a position corresponding to the AF magnet 510 in the substrate 130. The AF coil 520 may be disposed in the base 110. The AF coil 520 may be disposed in the side plate 122 of the cover 120. The AF coil 520 may be disposed between the AF magnet 510 and the cover 120. The AF coil 520 may be disposed in the fixed part 100.

The AF coil 520 may be disposed in the first side plate of the cover 120. The AF coil 520 may be disposed in the first side plate of the base 110. The AF coil 520 may be disposed in a first portion of the substrate 130. The OIS-y coil 720 may be disposed in the first side plate of the cover 120. The OIS-y coil 720 may be disposed in the first side plate of the base 110. The OIS-y coil 720 may be disposed in the first part of the substrate 130.

In a y-axis direction, the AF coil 520 may be overlapped with the OIS-y coil 720. The AF coil 520 may be disposed between the first unit coil 721 and the second unit coil 722 of the OIS-y coil 720. In a y-axis direction, the AF coil 520 may be disposed between the first unit coil 721 and the second unit coil 722. The AF coil 520 and the OIS-y coil 720 may be disposed on the same side. At this time, the AF coil 520 may be overlapped with the OIS-y coil 720 in a y-axis direction. Alternatively, the AF coil 520 may not be overlapped with the OIS-y coil 720 in a y-axis direction. The first embodiment of the present invention may be a large-diameter lens driving device 10 having a horizontal width (see g of FIG. 2) of 22 mm, a vertical width (see h of FIG. 2) of 22 mm, and a hollow diameter see i of FIG. 2 of 17 mm when viewed from above, as illustrated in (a) of FIG. 2. At this time, the horizontal width may be 20 to 24 mm, and the vertical width may be 20 to 24 mm. The hollow diameter may be 16 to 18 mm. The first embodiment of the present invention may secure a space in which two coils having different functions can be disposed on one side of the large-diameter lens driving device 10. In the first embodiment of the present invention, an AF coil 520 and an OIS-y coil 720 may be disposed on one side of the moving part. As illustrated in (b) of FIG. 2, the height of the lens driving device 10 (see j of FIG. 2) may be 5.7 mm. At this time, the height of the lens driving device 10 may be 5.2 to 6.2 mm.

The lens driving device 10 may comprise an AF sensor 530. The AF driving part 500 may comprise an AF sensor 530. The AF sensor 530 may be disposed on a substrate 130. The AF sensor 530 may comprise a Hall element (Hall IC). The AF sensor 530 may comprise a Hall sensor. The AF sensor 530 may detect an AF magnet 510. The AF sensor 530 may detect a magnetic force of the AF magnet 510. The AF sensor 530 may detect movement of the AF magnet 510. The movement amount or position of the AF magnet 510 detected by the AF sensor 530 may be used for feedback of auto focus (AF).

The AF sensor 530 may be disposed inside the AF coil 520. The AF sensor 530 may be overlapped with the AF coil 520 in an optical axis direction. The AF sensor 530 may be overlapped with the neutral portion of the AF magnet 510 in an x-axis direction. In a modified embodiment, the AF sensor 530 may be disposed outside the AF coil 520. The AF sensor 530 may face the AF magnet 510. The AF sensor 530 may be disposed at a position corresponding to the AF magnet 510.

The AF sensor 530 may comprise a drive IC. In this case, the drive IC may be electrically connected to the AF coil 520. The drive IC may apply current to the AF coil 520.

The lens driving device 10 may comprise a capacitor 540. The capacitor 540 may be disposed in the substrate 130. The capacitor 540 may be disposed next to the AF sensor 530. The capacitor 540 may be disposed inside the AF coil 520. The capacitor 540 may remove noise related to data and current being transmitted and received from the AF sensor 530.

The lens driving device 10 may comprise an OIS-x driving part 600. The OIS-x driving part 600 can move the OIS-x moving part 300 in an x-axis direction perpendicular to the optical axis direction and the y-axis direction. The OIS-x driving part 600 can move the OIS-x carrier 310 in an x-axis direction. The OIS-x driving part 600 can move the OIS-x carrier 310 in an x-axis direction through electromagnetic force. The OIS-x driving part 600 may comprise a coil and a magnet. The OIS-x coil 620 and the OIS-x magnet 610 can move the OIS-x moving part 300 in an x-axis direction perpendicular to the optical axis direction and the y-axis direction.

When the OIS-x moving part 300 is moved by the OIS-x driving part 600, the AF moving part 200 and the OIS-y moving part 400 can move together with the OIS-x moving part 300. The AF moving part 200 and the OIS-y moving part 400 can move together with the OIS-x moving part 300 in an x-axis direction.

The lens driving device 10 may comprise an OIS-x magnet 610. The OIS-x driving part 600 may comprise an OIS-x magnet 610. The OIS-x magnet 610 may be disposed in the OIS-x moving part 300. The OIS-x magnet 610 may be disposed in the OIS-x carrier 310. The OIS-x magnet 610 may be disposed in the hole 315 of the OIS-x carrier 310. The OIS-x magnet 610 may be fixed to the OIS-x carrier 310. The OIS-x magnet 610 may be coupled to the OIS-x carrier 310. The OIS-x magnet 610 may be attached to the OIS-x carrier 310 with an adhesive. The OIS-x magnet 610 can be disposed inside the cover 120. The OIS-x magnet 610 can interact with the OIS-x coil 620. The OIS-x magnet 610 can electromagnetically interact with the OIS-x coil 620. The OIS-x magnet 610 can be disposed at a position corresponding to the OIS-x coil 620. The OIS-x magnet 610 can face the OIS-x coil 620. The OIS-x magnet 610 can face the OIS-x coil 620. The OIS-x magnet 610 may be overlapped with the OIS-x coil 620 in a direction perpendicular to the optical axis. The OIS-x magnet 610 may be overlapped with the OIS-x coil 620 in a y-axis direction.

The OIS-x magnet 610 may be a four-pole magnet. The OIS-x magnet 610 may comprise a four-pole magnetizing magnet. The OIS-x magnet 610 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be spaced apart from each other in a horizontal direction, and a neutral portion may be disposed between the first magnet portion and the second magnet portion.

In a first embodiment of the present invention, even when the OIS-x magnet 610 moves due to the interaction between the OIS-x coil 620 and the OIS-x magnet 610, the distance between the OIS-x coil 620 and the OIS-x magnet 610 can be maintained constant.

The lens driving device 10 may comprise an OIS-x coil 620. The OIS-x driving part 600 may comprise the OIS-x coil 620. The OIS-x coil 620 may interact with the OIS-x magnet 610. The OIS-x coil 620 may move the OIS-x magnet 610 in an x-axis direction. The OIS-x coil 620 may move the OIS-x magnet 610 in an x-axis direction through interaction with the OIS-x magnet 610. The OIS-x coil 620 may face the OIS-x magnet 610. The OIS-x coil 620 may face the OIS-x magnet 610. The OIS-x coil 620 may be disposed at a position corresponding to the OIS-x magnet 610. The OIS-x coil 620 may be overlapped with the OIS-x magnet 610 in a y-axis direction. The OIS-x coil 620 may be disposed in the substrate 130. The OIS-x coil 620 may be disposed in the substrate 130 at a position corresponding to the OIS-x magnet 610. The OIS-x coil 620 may be disposed in the base 110. The OIS-x coil 620 may be disposed in the side plate 122 of the cover 120. The OIS-x coil 620 may be disposed between the OIS-x magnet 610 and the cover 120. The OIS-x coil 620 can be disposed in the fixed part 100.

The lens driving device 10 may comprise an OIS-x sensor 630. The OIS-x driving part 600 may comprise an OIS-x sensor 630. The OIS-x sensor 630 may be disposed in a substrate 130. The OIS-x sensor 630 may comprise a Hall element (Hall IC). The OIS-x sensor 630 may comprise a Hall sensor. The OIS-x sensor 630 may detect an OIS-x magnet 610. The OIS-x sensor 630 may detect a magnetic force of the OIS-x magnet 610. The OIS-x sensor 630 may detect movement of the OIS-x magnet 610. The movement or position of the OIS-x magnet 610 detected by the OIS-x sensor 630 can be used for feedback of the handshake correction driving (OIS) in an x-axis direction.

The OIS-x sensor 630 can be disposed inside the OIS-x coil 620. The OIS-x sensor 630 may be overlapped with the OIS-x coil 620 in an optical axis direction. The OIS-x sensor 630 may be overlapped with the neutral portion of the OIS-x magnet 610 in a y-axis direction. In a modified embodiment, the OIS-x sensor 630 can be disposed outside the OIS-x coil 620. The OIS-x sensor 630 can face the OIS-x magnet 610. The OIS-x sensor 630 can be disposed at a position corresponding to the OIS-x magnet 610.

The lens driving device 10 may comprise an OIS-y driving part 700. The OIS-y driving part 700 may move the OIS-y moving part 400 in a y-axis direction perpendicular to the optical axis direction. The OIS-y driving part 700 may move the OIS-y carrier 410 in a y-axis direction. The OIS-y driving part 700 may move the OIS-y carrier 410 in a y-axis direction through electromagnetic force. The OIS-y driving part 700 may comprise a coil and a magnet. The OIS-y coil 720 and the OIS-y magnet 710 may move the OIS-y moving part 400 in a y-axis direction perpendicular to the optical axis direction.

When the OIS-y moving part 400 is moved by the OIS-y driving part 700, the AF moving part 200 can move together with the OIS-y moving part 400. The AF moving part 200 can move together with the OIS-y moving part 400 in a y-axis direction.

The lens driving device 10 may comprise an OIS-y magnet 710. The OIS-y driving part 700 may comprise an OIS-y magnet 710. The OIS-y magnet 710 may be disposed in the OIS-y moving part 400. The OIS-y magnet 710 may be disposed in the OIS-y carrier 410. The OIS-y magnet 710 may be disposed in a groove 413 of the OIS-y carrier 410. The OIS-y magnet 710 may be disposed on an outer side surface of the OIS-y carrier 410. The OIS-y magnet 710 may be fixed to the OIS-y carrier 410. The OIS-y magnet 710 can be coupled to the OIS-y carrier 410. The OIS-y magnet 710 can be attached to the OIS-y carrier 410 with an adhesive. The OIS-y magnet 710 can be disposed inside the cover 120. The OIS-y magnet 710 can interact with the OIS-y coil 720. The OIS-y magnet 710 can electromagnetically interact with the OIS-y coil 720. The OIS-y magnet 710 can be disposed at a position corresponding to the OIS-y coil 720. The OIS-y magnet 710 can face the OIS-y coil 720. The OIS-y magnet 710 can face the OIS-y coil 720. The OIS-y magnet 710 may be overlapped with the OIS-y coil 720 in a direction perpendicular to the optical axis. In an x-axis direction, the OIS-y magnet 710 may be overlapped with the OIS-x magnet 610.

The OIS-y magnet 710 may be a four-pole magnet. The OIS-y magnet 710 may comprise a four-pole magnetizing magnet. The OIS-y magnet 710 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be disposed spaced apart from each other in a horizontal direction, and a neutral portion may be disposed between the first magnet portion and the second magnet portion.

The OIS-y magnet 710 may comprise a plurality of magnets. The OIS-y magnet 710 may comprise two magnets. The OIS-y magnet 710 may comprise a first unit magnet and a second unit magnet. The first unit magnet and the second unit magnet may be formed with the same size and shape. The first unit magnet and the second unit magnet may be disposed on both sides of the AF magnet 510. In a modified embodiment, one of the first unit magnet and the second unit magnet may be omitted. That is, the OIS-y magnet 710 may be formed with only the first unit magnet. Alternatively, the OIS-y magnet 710 may be formed with only the second unit magnet.

The first unit magnet and the second unit magnet can be disposed so that the surfaces facing the AF magnet 510 have the same polarity. That is, the first unit magnet comprises a first surface facing the AF magnet 510, and the outer side of the first surface has an S pole and the inner side can have an N pole. The second unit magnet comprises a second surface facing the AF magnet 510, and the outer side of the second surface has an S pole and the inner side can have an N pole.

In a first embodiment of the present invention, even when the OIS-y magnet 710 moves due to the interaction between the OIS-y coil 720 and the OIS-y magnet 710, the distance between the OIS-y coil 720 and the OIS-y magnet 710 can be maintained constant.

The lens driving device 10 may comprise an OIS-y coil 720. The OIS-y driving part 700 may comprise an OIS-y coil 720. The OIS-y coil 720 may interact with an OIS-y magnet 710. The OIS-y coil 720 may move the OIS-y magnet 710 in a y-axis direction. The OIS-y coil 720 may move the OIS-y magnet 710 in a y-axis direction through interaction with the OIS-y magnet 710. The OIS-y coil 720 may face the OIS-y magnet 710. The OIS-y coil 720 may face the OIS-y magnet 710. The OIS-y coil 720 may be disposed at a position corresponding to the OIS-y magnet 710. The OIS-y coil 720 may be overlapped with the OIS-y magnet 710 in an x-axis direction. The OIS-y coil 720 may be disposed in the substrate 130. The OIS-y coil 720 may be disposed in the substrate 130 at a position corresponding to the OIS-y magnet 710. The OIS-y coil 720 may be disposed in the base 110. The OIS-y coil 720 may be disposed in the side plate 122 of the cover 120. The OIS-y coil 720 may be disposed between the OIS-y magnet 710 and the cover 120. The OIS-y coil 720 can be disposed on the fixed part 100.

The OIS-y coil 720 may comprise a plurality of coils. The OIS-y coil 720 may comprise two coils. The OIS-y coil 720 may comprise a first unit coil 721 and a second unit coil 722. The first unit coil 721 and the second unit coil 722 may be formed with the same size and shape. The first unit coil 721 and the second unit coil 722 may be disposed on both sides of the AF coil 520. In a modified embodiment, either the first unit coil 721 or the second unit coil 722 may be omitted. That is, the OIS-y coil 720 may be formed with only the first unit coil 721. Alternatively, the OIS-y coil 720 may be formed with only the second unit coil 722.

The lens driving device 10 may comprise an OIS-y sensor 730. The OIS-y driving part 700 may comprise an OIS-y sensor 730. The OIS-y sensor 730 may be disposed in a substrate 130. The OIS-y sensor 730 may comprise a Hall element (Hall IC). The OIS-y sensor 730 may comprise a Hall sensor. The OIS-y sensor 730 may detect an OIS-y magnet 710. The OIS-y sensor 730 may detect a magnetic force of the OIS-y magnet 710. The OIS-y sensor 730 may detect movement of the OIS-y magnet 710. The movement amount or position of the OIS-y magnet 710 detected by the OIS-y sensor 730 can be used for feedback of the handshake correction driving (OIS) in a y-axis direction.

The OIS-y sensor 730 may be disposed inside the OIS-y coil 720. The OIS-y sensor 730 may be overlapped with the OIS-y coil 720 in an optical axis direction. The OIS-y sensor 730 may be overlapped with the neutral portion of the OIS-y magnet 710 in an x-axis direction. In a modified embodiment, the OIS-y sensor 730 may be disposed outside the OIS-y coil 720. The OIS-y sensor 730 may face the OIS-y magnet 710. The OIS-y sensor 730 may be disposed at a position corresponding to the OIS-y magnet 710.

The lens driving device 10 may comprise a guide member. The guide member may comprise a ball. The guide member may comprise a pin. The guide member may comprise a cylindrical member. The guide member may guide the movement of the moving part against the fixed part 100 in a specific direction.

The lens driving device 10 may comprise an AF guide ball 810. The AF guide ball 810 may guide the movement of the AF carrier 210 against the OIS-y carrier 410 in an optical axis direction. The AF guide ball 810 may be disposed between the AF moving part 200 and the OIS-y moving part 400. The AF moving part 200 and the OIS-y moving part 400 may comprise grooves 211 and 411 being extended in an optical axis direction. The AF guide ball 810 may be disposed between the groove 211 of the AF moving part 200 and the groove 411 of the OIS-y moving part 400. The AF guide ball 810 may be disposed between the OIS-y carrier 410 and the AF carrier 210. The AF guide ball 810 may be disposed between the OIS-y carrier 410 and the AF carrier 210 in an x-axis direction. The AF guide ball 810 may be disposed between an inner side surface of the OIS-y carrier 410 and an outer side surface of the AF carrier 210. When viewed from the outside of the AF carrier 210, the AF guide ball 810 may be overlapped with the AF magnet 510 in a horizontal direction. When viewed from above, at least a portion of the AF guide ball 810 may be overlapped with the AF magnet 510 in a y-axis direction. At least a portion of the AF guide ball 810 may be overlapped with the AF magnet 510 in a y-axis direction.

The AF guide ball 810 may be disposed between the groove 411 of the OIS-y moving part 400 and the groove 211 of the AF moving part 200. At least one of the groove 411 of the OIS-y moving part 400 and the groove 211 of the AF moving part 200 may be extended longer than the diameter of the AF guide ball 810 in an optical axis direction.

The AF guide ball 810 may be disposed in the groove 411 of the OIS-y carrier 410. The AF guide ball 810 may be disposed in the groove 211 of the AF carrier 210. The AF guide ball 810 may comprise a first-first ball being in contact with the OIS-y carrier 410 and the AF carrier 210 at four points, and a first-second ball being in contact with the OIS-y carrier 410 and the AF carrier 210 at three points. The AF guide ball 810 may be spherical. The AF guide ball 810 may be formed of metal. Grease may be applied to the surface of the AF guide ball 810.

The AF guide ball 810 may comprise a plurality of balls. The AF guide ball 810 may comprise six balls. Three AF guide balls 810 may be disposed on one side of the AF magnet 510 and the remaining three AF guide balls 810 may be disposed on the other side of the AF magnet 510.

The distance between the center of the uppermost ball and the center of the lowermost ball among the AF guide balls 810 may be 40 to 60% of the total height of the lens driving device 10. At this time, the total height of the lens driving device 10 may be the distance from the lower surface of the base 110 to the upper surface of the cover 120.

The lens driving device 10 may comprise an OIS-x guide ball 820. The OIS-x guide ball 820 may guide the movement of the OIS-x carrier 310 against the base 110 in an x-axis direction. The OIS-x guide ball 820 may be disposed between the OIS-x moving part 300 and the fixed part 100. The OIS-x moving part 300 and the fixed part 100 may comprise grooves 111 and 312 being extended in an x-axis direction. The OIS-x guide ball 820 may be disposed between the groove 312 of the OIS-x moving part 300 and the groove 111 of the fixed part 100. The OIS-x guide ball 820 may be disposed between the base 110 and the OIS-x carrier 310. The OIS-x guide ball 820 can be disposed between the base 110 and the OIS-x carrier 310 in a y-axis direction. The entire region from the lower end to the upper end of the OIS-x guide ball 820 may be overlapped with both the base 110 and the OIS-x carrier 310 in a y-axis direction. The entire region of the OIS-x guide ball 820 may be overlapped with the base 110 and the OIS-x carrier 310 in a y-axis direction. The OIS-x guide ball 820 can be disposed between the side plate 113 of the base 110 and the side plate 314 of the OIS-x carrier 310. The OIS-x guide ball 820 can be disposed between the inner surface of the side plate 113 of the base 110 and the outer surface of the side plate 314 of the OIS-x carrier 310. When viewed from the outside of the OIS-x carrier 310, the OIS-x guide ball 820 may be overlapped with the OIS-x magnet 610 in a horizontal direction. At least a portion of the OIS-x guide ball 820 may be overlapped with the OIS-x magnet 610 in an x-axis direction.

The OIS-x guide ball 820 can be disposed between the groove 111 of the base 110 and the groove 312 of the OIS-x moving part 300. At least one of the groove 111 of the base 110 and the groove 312 of the OIS-x moving part 300 can be extended longer than the diameter of the OIS-x guide ball 820 in an x-axis direction.

The OIS-x guide ball 820 may be disposed in the groove 111 of the base 110. The OIS-x guide ball 820 may be disposed in the groove 312 of the OIS-x carrier 310. The OIS-x guide ball 820 may comprise a first-first ball being in contact with the base 110 and the OIS-x carrier 310 at four points, and a first-second ball being in contact with the base 110 and the OIS-x carrier 310 at three points. The OIS-x guide ball 820 may be spherical. The OIS-x guide ball 820 may be formed of metal. Grease may be applied to the surface of the OIS-x guide ball 820.

The OIS-x guide ball 820 may comprise multiple balls. The OIS-x guide ball 820 may comprise four balls. Two OIS-x guide balls 820 may be disposed on one side of the OIS-x magnet 610, and the remaining two OIS-x guide balls 820 may be disposed on the other side of the OIS-x magnet 610.

The lens driving device 10 may comprise an OIS-y guide ball 830. The OIS-y guide ball 830 may guide the movement of the OIS-y carrier 410 against the OIS-x carrier 310 in a y-axis direction. The OIS-y guide ball 830 may be disposed between the OIS-y moving part 400 and the OIS-x carrier 310. The OIS-y guide ball 830 may be disposed between the OIS-y moving part 400 and the OIS-x carrier 310 in an optical axis direction. The OIS-y moving part 400 and the OIS-x moving part 300 may comprise grooves 311 and 412 being extended in a y-axis direction. The OIS-y guide ball 830 may be disposed between the groove 412 of the OIS-y moving part 400 and the groove 311 of the OIS-x moving part 300. The OIS-y guide ball 830 may be disposed between the OIS-x carrier 310 and the OIS-y carrier 410. The OIS-y guide ball 830 may be disposed between the base 110 and the OIS-y carrier 410 in an optical axis direction. The OIS-y guide ball 830 may be disposed in the groove 311 of the OIS-x carrier 310. The OIS-y guide ball 830 may be disposed between the lower plate 313 of the OIS-x carrier 310 and the OIS-y carrier 410. The OIS-y guide ball 830 can be disposed between an upper surface of the lower plate 313 of the OIS-x carrier 310 and a lower surface of the OIS-y carrier 410.

The OIS-y guide ball 830 can be disposed between the groove 311 of the OIS-x moving part 300 and the groove 412 of the OIS-y moving part 400. At least one of the groove 311 of the OIS-x moving part 300 and the groove 412 of the OIS-y moving part 400 can be extended in a y-axis direction longer than the diameter of the OIS-y guide ball 830.

The OIS-y guide ball 830 may be disposed in the groove 311 of the OIS-x carrier 310. The OIS-y guide ball 830 may be disposed in the groove 412 of the OIS-y carrier 410. The OIS-y guide ball 830 may comprise a first-first ball being in contact with the OIS-x carrier 310 and the OIS-y carrier 410 at four points, and a first-second ball being in contact with the OIS-x carrier 310 and the OIS-y carrier 410 at three points. The OIS-y guide ball 830 may be spherical. The OIS-y guide ball 830 may be formed of metal. Grease may be applied to a surface of the OIS-y guide ball 830.

The OIS-y guide ball 830 may comprise a plurality of balls. The OIS-y guide ball 830 may comprise four balls. Two OIS-y guide balls 830 may be disposed on one side of the AF magnet 510, and the remaining two OIS-y guide balls 830 may be disposed on the other side of the AF magnet 510.

The lens driving device 10 may comprise a ball pressurizing member. The ball pressurizing member may comprise a yoke. The yoke may be an ‘attractive force yoke’. The yoke may be an ‘attractive force member’. The yoke may be formed of metal. An attractive force may be generated between the yoke and the magnets 510, 610, and 710. The balls 810, 820, and 830 may be pressurized by an attractive force between the yoke and the magnets 510, 610, and 710. The yoke may comprise a plurality of yokes. The yoke may comprise three yokes. The yoke may comprise an AF attractive force yoke 910, an OIS-x attractive force yoke 920, and an OIS-y attractive force yoke 930. The AF attractive force yoke 910, the OIS-x attractive force yoke 920, and the OIS-y attractive force yoke 930 may be spaced from one another.

The lens driving device 10 may comprise an AF attractive force yoke 910. The AF attractive force yoke 910 may be disposed in the OIS-y moving part 400. The AF attractive force yoke 910 may be disposed in the OIS-y carrier 410. The AF attractive force yoke 910 may be coupled to the OIS-y carrier 410. The AF attractive force yoke 910 may be fixed to the OIS-y carrier 410. The AF attractive force yoke 910 may be attached to the OIS-y carrier 410 with an adhesive. The AF attractive force yoke 910 may be disposed on the outer side surface of the OIS-y carrier 410. The AF attractive force yoke 910 may be disposed at a position corresponding to the AF magnet 510. An attractive force can exert on the AF attractive force yoke 910 with the AF magnet 510. An attractive force can be generated between the AF attractive force yoke 910 and the AF magnet 510. The AF guide ball 810 can be pressurized by the attractive force between the AF attractive force yoke 910 and the AF magnet 510. The guide ball 810 can be pressurized between the AF carrier 210 and the OIS-y carrier 410 by the attractive force between the AF attractive force yoke 910 and the AF magnet 510.

The AF attractive force yoke 910 may comprise a plurality of yokes. The plurality of yokes may comprise a first yoke and a second yoke being spaced apart from each other. The first yoke and the second yoke may be disposed on both sides of the AF magnet 510, respectively. The first yoke may be disposed on one side of the AF magnet 510 and the second yoke may be disposed on the other side of the AF magnet 510. The first yoke and the second yoke may be disposed to be extended in an optical axis direction. In a modified embodiment, the AF attractive force yoke 910 may comprise a third yoke that connects a lower end of the first yoke and a lower end of the second yoke.

In a first embodiment of the present invention, since the AF attractive force yoke 910 is disposed in the OIS-y carrier 410, the OIS-x operation may not be affected. If, as a comparative example, the AF attractive force yoke 910 is disposed in the substrate 130, that is, the fixed part 100, the OIS-x operation may be disturbed by the attractive force between the AF attractive force yoke 910 and the AF magnet 510.

The lens driving device 10 may comprise an OIS-x attractive force yoke 920. The OIS-x attractive force yoke 920 may be disposed in the fixed part 100. The OIS-x attractive force yoke 920 may be disposed in the base 110. The OIS-x attractive force yoke 920 may be coupled to the base 110. The OIS-x attractive force yoke 920 may be fixed to the base 110. The OIS-x attractive force yoke 920 may be attached to the base 110 with an adhesive. The OIS-x attractive force yoke 920 may be disposed in the substrate 130. The OIS-x attractive force yoke 920 may be coupled to the substrate 130. The OIS-x attractive force yoke 920 may be fixed to the substrate 130. The OIS-x attractive force yoke 920 may be attached to the substrate 130 with an adhesive. The OIS-x attractive force yoke 920 can be disposed between the base 110 and the substrate 130. The OIS-x attractive force yoke 920 can be disposed in the groove 114 of the base 110.

The OIS-x attractive force yoke 920 can be disposed at a position corresponding to the OIS-x magnet 610. The OIS-x attractive force yoke 920 can exert an attractive force on the OIS-x magnet 610. An attractive force can be generated between the OIS-x attractive force yoke 920 and the OIS-x magnet 610. The OIS-x guide ball 820 can be pressurized by the attractive force between the OIS-x attractive force yoke 920 and the OIS-x magnet 610. The OIS-x guide ball 820 can be pressurized between the OIS-x carrier 310 and the base 110 by the attractive force between the OIS-x attractive force yoke 920 and the OIS-x magnet 610.

The OIS-x attractive force yoke 920 may comprise a hole. An OIS-x coil 620 may be disposed in the hole of the OIS-x attractive force yoke 920.

The lens driving device 10 may comprise an OIS-y attractive force yoke 930. The OIS-y attractive force yoke 930 may be disposed in the OIS-x moving part 300. The OIS-y attractive force yoke 930 may be disposed in the OIS-x carrier 310. The OIS-y attractive force yoke 930 may be coupled to the OIS-x carrier 310. The OIS-y attractive force yoke 930 may be fixed to the OIS-x carrier 310. The OIS-y attractive force yoke 930 may be attached to the OIS-x carrier 310 with an adhesive. The OIS-y attractive force yoke 930 may be disposed in the lower plate 313 of the OIS-x carrier 310. The OIS-y attractive force yoke 930 may be disposed on an upper surface of the lower plate 313 of the OIS-x carrier 310. The OIS-y attractive force yoke 930 may be disposed at a position corresponding to the OIS-y magnet 710. An attractive force can exert on the OIS-y attractive force yoke 930 with the OIS-y magnet 710. An attractive force may be generated between the OIS-y attractive force yoke 930 and the OIS-y magnet 710. The OIS-y guide ball 830 may be pressurized by the attractive force between the OIS-y attractive force yoke 930 and the OIS-y magnet 710. The OIS-y guide ball 830 can be pressurized between the OIS-y carrier 410 and the OIS-x carrier 310 by the attractive force between the OIS-y attractive force yoke 930 and the OIS-y magnet 710.

The OIS-y attractive force yoke 930 may be formed in a ‘⊂’ shape. The OIS-y attractive force yoke 930 may be formed in a ‘U’ shape. The OIS-y attractive force yoke 930 may comprise a first yoke portion and a second yoke portion which are disposed parallel to each other, and a third yoke portion which connects the first yoke portion and the second yoke portion. The OIS-y attractive force yoke 930 may be formed in a shape that is bent twice.

The first embodiment of the present invention may comprise a structure in which an OIS carrier is disposed on a side surface portion of a base 110. An AF carrier 210 may be accommodated in the OIS carrier. One of the OIS carriers may be supported on a side wall of the base 110. The other may be supported on another OIS carrier other than the side wall of the base 110. One OIS guide ball may be disposed on a side wall portion of the base 110, while the other may be disposed on a bottom portion of the base 110. The ball may be disposed only in a direction of the bottom portion of the base 110, and actual support may be provided in a direction of the bottom portion of the OIS carrier. At least one OIS driving coil and an AF driving coil may be disposed on the same surface. At this time, the OIS driving coil disposed on the same surface may be divided into two, but may also be configured as one. An AF attractive force yoke 910 for supporting the AF carrier 200 may be located in the OIS carrier. The AF magnet 510 may have a structure for sending magnetic force in a direction of the AF attractive force yoke 910, such as a C-cut, for a greater attractive force than the AF attractive force yoke 910. The OIS-y attractive force yoke 930 may be present in a bottom direction of the OIS-x carrier 310. The OIS-y guide ball 830 may be disposed in the bottom direction with respect to the base 110. The OIS-y magnet 710 may have a structure for sending magnetic force in a direction of the OIS-y attractive force yoke 930, such as a C-cut, for a greater attractive force than the OIS-y attractive force yoke 930. The OIS-x attractive force yoke 920 may be present in the side wall portion of the base 110. The OIS-x attractive force yoke 920 has a hole shape of a certain size, and an OIS-x coil 620 can be disposed between the holes. However, in a modified embodiment, the hole shape of the OIS-x attractive force yoke 920 may be omitted. If a hole is applied, the size of the OIS-x attractive force yoke 920 can be slimmed down as much as the thickness thereof.

The OIS-y moving part 400 may comprise a first surface on which a first guide part is formed to guide the AF moving part 200 to move in a y-axis direction, and a second surface on which a third guide part is formed to guide the movement of the AF moving part 400 in an optical axis direction. In this case, the first guide part may be an OIS-y guide ball 830, and the third guide part may be an AF guide ball 810.

The side plate 113 of the fixed part 100 may comprise a first side plate and a second side plate being adjacent to each other. The OIS-x moving part 300 may comprise a first guide part that guides the AF moving part 200 to move in an x-axis direction, and a second guide part that guides the AF moving part 200 to move in a y-axis direction. The OIS-y moving part 400 may be disposed between the first side plate of the fixed part 100 and the AF moving part 200. The first guide part may be disposed between a lower surface of the OIS-y moving part 400 and a bottom plate of the fixed part 100. The second guide part may be disposed between a side surface of the AF moving part 200 and a second side plate of the fixed part 100. At this time, the first guide part may be an OIS-y guide ball 830, and the second guide part may be an OIS-x guide ball 820.

The AF moving part 200 can move with respect to the fixed part 100. The OIS-y moving part 400 can guide the AF moving part 200 to move in an optical axis direction. The OIS-x moving part 300 can guide the AF moving part 200 to move in first and second directions perpendicular to the optical axis direction. The AF guide ball 810 can be disposed between the AF moving part 200 and the OIS-y moving part 400. The OIS-y guide ball 830 can be disposed between a lower surface of the OIS-y moving part 400 and an upper surface of the OIS-x moving part 300. The OIS-x guide ball 820 can be disposed between the OIS-x moving part 300 and the side plate of the fixed part 100

Hereinafter, the assembly process of the lens driving device according to a first embodiment of the present invention is described with reference to the drawings.

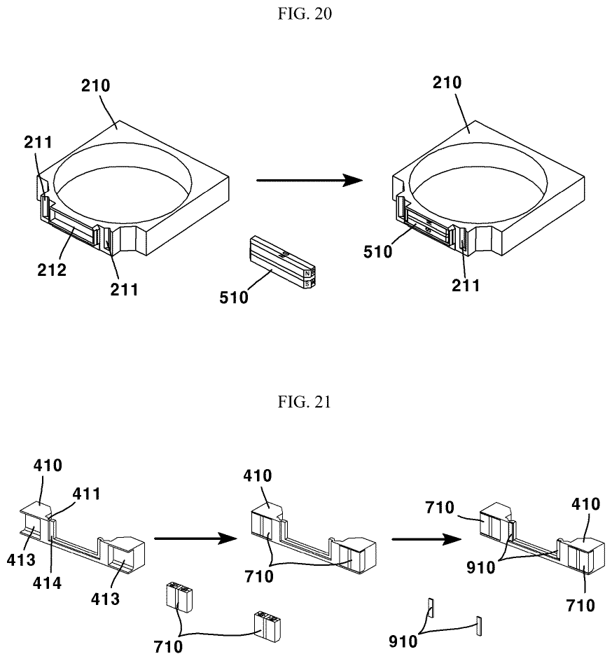

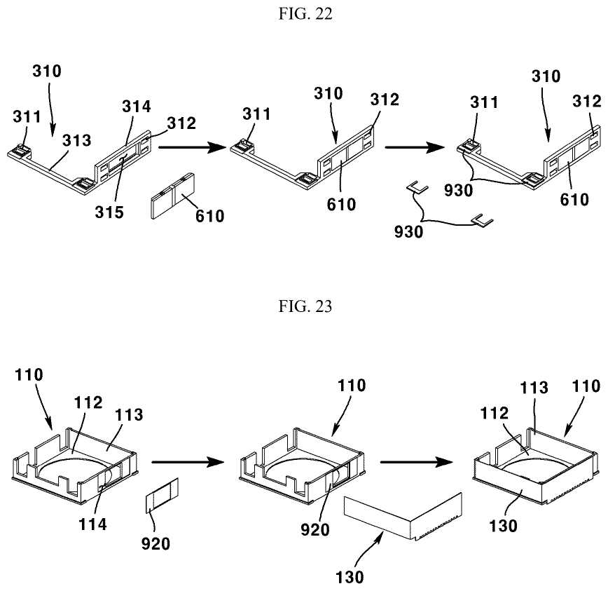

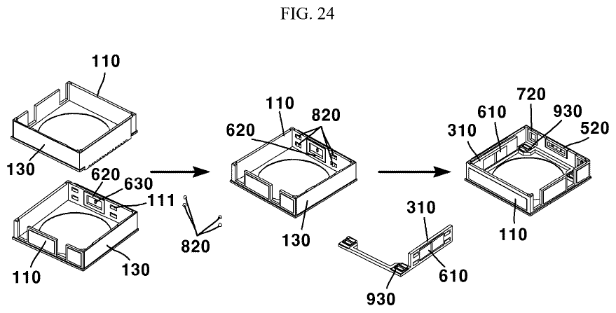

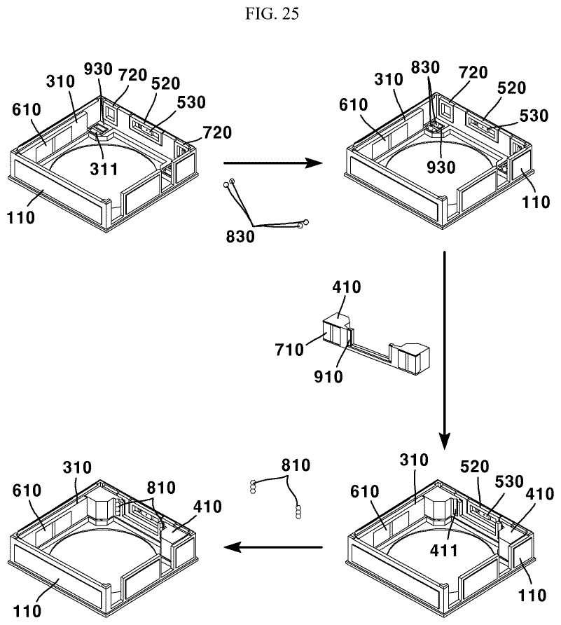

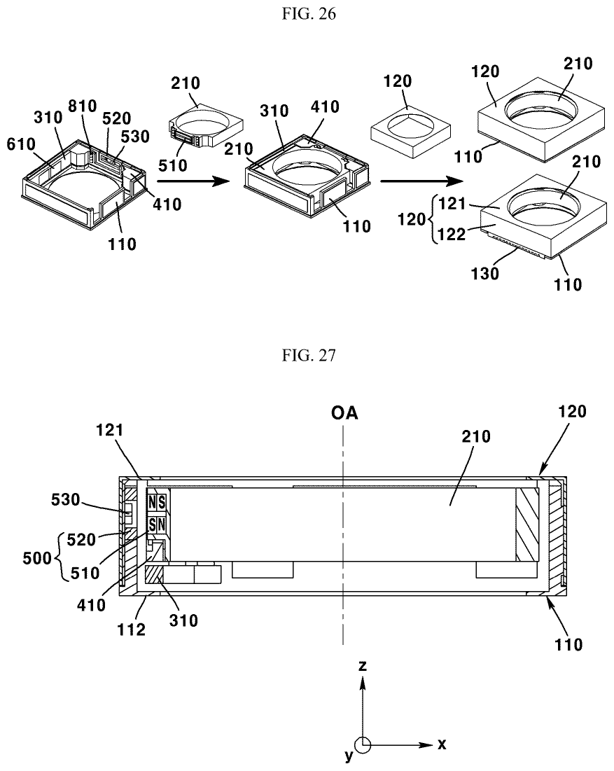

FIG. 20 is a drawing illustrating a process of forming an AF carrier assembly by coupling an AF magnet to an AF carrier; FIG. 21 is a drawing illustrating a process in which an OIS-y magnet and an AF attractive force yoke are coupled to an OIS-y carrier to form an OIS-y carrier assembly; FIG. 22 is a drawing illustrating a process in which an OIS-x magnet and an OIS-y attractive force yoke are coupled to an OIS-x carrier to form an OIS-x carrier assembly; FIG. 23 is a drawing illustrating a process in which an OIS-x attractive force yoke and a substrate assembly are coupled to a base. At this time, the substrate assembly may comprise a substrate, and a coil and a sensor coupled to the substrate; FIG. 24 is a drawing illustrating a process in which an OIS-x guide ball and an OIS-x carrier assembly are coupled in a final state of FIG. 23; FIG. 25 is a drawing illustrating a process in which an OIS-y guide ball and an OIS-y carrier assembly and an AF guide ball are coupled in a final state of FIG. 24; and FIG. 26 is a drawing illustrating the process of assembling an AF carrier assembly and a cover into a lens driving device by coupling them in the final state of FIG. 25.

As illustrated in FIG. 20, an AF magnet 510 may be disposed in the groove 212 of an AF carrier 210 to form an AF carrier assembly. As illustrated in FIG. 21, an OIS-y magnet 710 may be disposed in the groove 413 of an OIS-y carrier 410 and an AF attractive force yoke 910 may be disposed in the groove 414 of the OIS-y carrier 410 to form an OIS-y carrier assembly. As illustrated in FIG. 22, an OIS-x magnet 610 may be disposed in the hole 315 of an OIS-x carrier 310 and an OIS-y attractive force yoke 930 may be disposed in the lower plate 313 of the OIS-x carrier 310 to form an OIS-x carrier assembly. As illustrated in FIG. 23, an OIS-x attractive force yoke 920 and a substrate assembly may be disposed in a base 110. At this time, the substrate assembly may comprise a substrate 130, coils 520, 620, and 720 coupled to the substrate, and sensors 530, 630, and 730. Thereafter, as illustrated in FIG. 24, an OIS-x guide ball 820 and an OIS-x carrier assembly may be disposed in the final state of FIG. 23. Thereafter, as illustrated in FIG. 25, an OIS-y guide ball 830 and an OIS-y carrier assembly are disposed in the final state of FIG. 24, and an AF guide ball 810 may be disposed. Thereafter, as illustrated in FIG. 26, an AF carrier assembly is disposed in the final state of FIG. 25, and a cover 120 may be coupled.

Hereinafter, the auto focus (AF) driving of the lens driving device according to a first embodiment of the present invention will be described with reference to the drawings.

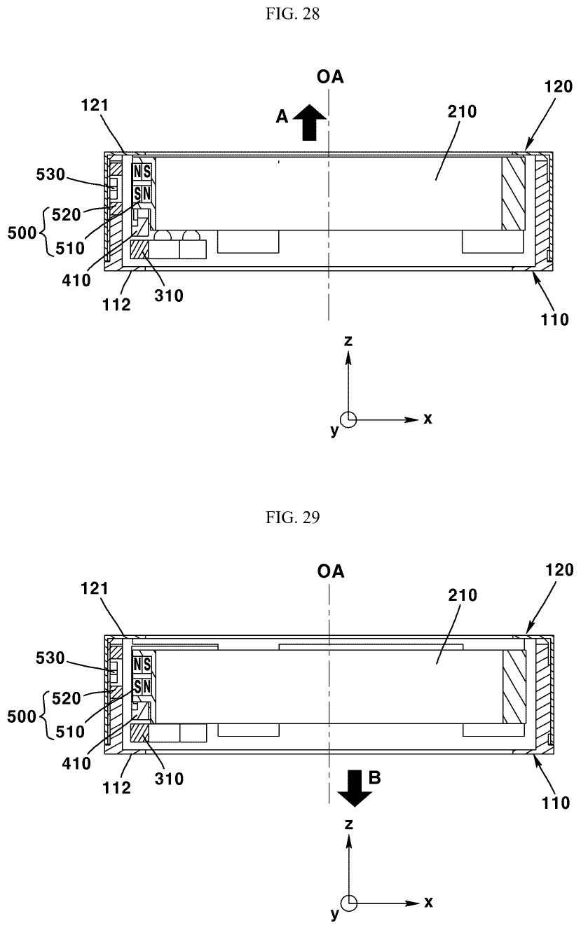

FIGS. 27 to 29 are drawings for explaining the auto focus driving of a lens driving device according to a first embodiment of the present invention. FIG. 27 is a cross-sectional view illustrating the appearance of an AF moving part in an initial state in which no current is applied to the AF coil. FIG. 28 is a cross-sectional view illustrating the appearance of an AF moving part moving upward in an optical axis direction when a forward current is applied to an AF coil. FIG. 29 is a cross-sectional view illustrating the appearance of the AF moving part moving downward in an optical axis direction when a reverse current is applied to an AF coil.

The moving part may be disposed at a position spaced apart from both the upper plate 121 of the cover 120 and the base 110 in the initial position where no current is applied to the AF coil 520. At this time, the moving part may be an AF moving part 200.

When a positive current is applied to the AF coil 520, the AF magnet 510 can move upward in an optical axis direction due to the electromagnetic interaction between the AF coil 520 and the AF magnet 510 (see A of FIG. 28). At this time, the AF carrier 210 can move upward in an optical axis direction together with the AF magnet 510. Furthermore, the lens can move upward in an optical axis direction together with the AF carrier 210. Accordingly, the distance between the lens and the image sensor can be changed, and the focus of the image being formed on the image sensor through the lens can be adjusted.

When a reverse current is applied to the AF coil 520, the AF magnet 510 can move downward in an optical axis direction due to the electromagnetic interaction between the AF coil 520 and the AF magnet 510 (see B of FIG. 29). At this time, the AF carrier 210 can move downward in an optical axis direction together with the AF magnet 510. Furthermore, the lens can move downward in an optical axis direction together with the AF carrier 210. Accordingly, the distance between the lens and the image sensor can be changed, and the focus of the image being formed on the image sensor through the lens can be adjusted.

Meanwhile, during the movement process of the AF magnet 510, the AF sensor 530 can detect the strength of the magnetic field of the AF magnet 510 to detect the amount of movement or position of the AF magnet 510. The amount of movement or position of the AF magnet 510 detected by the AF sensor 530 can be used for auto focus feedback control.

Hereinafter, the handshake correction (OIS, optical image stabilization) operation of the lens driving device according to a first embodiment of the present invention will be described with reference to the drawings.

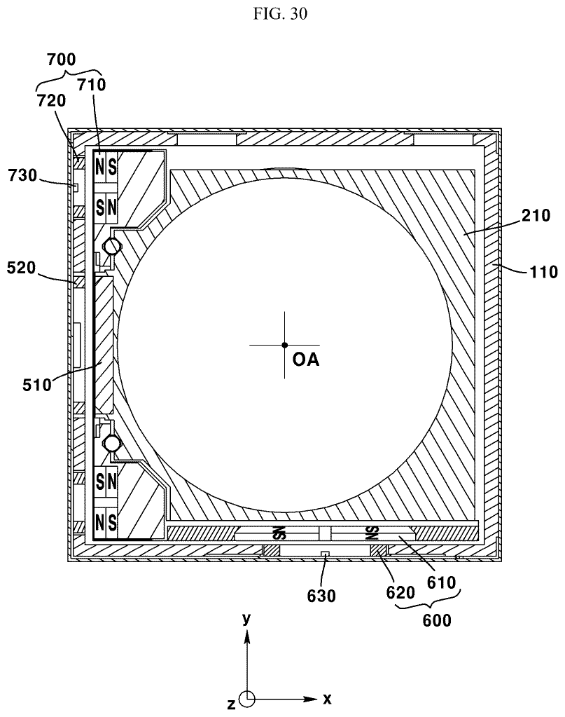

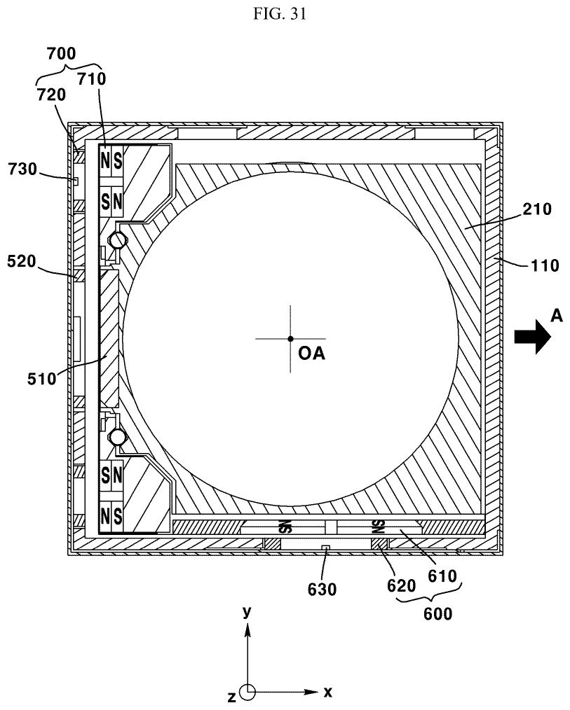

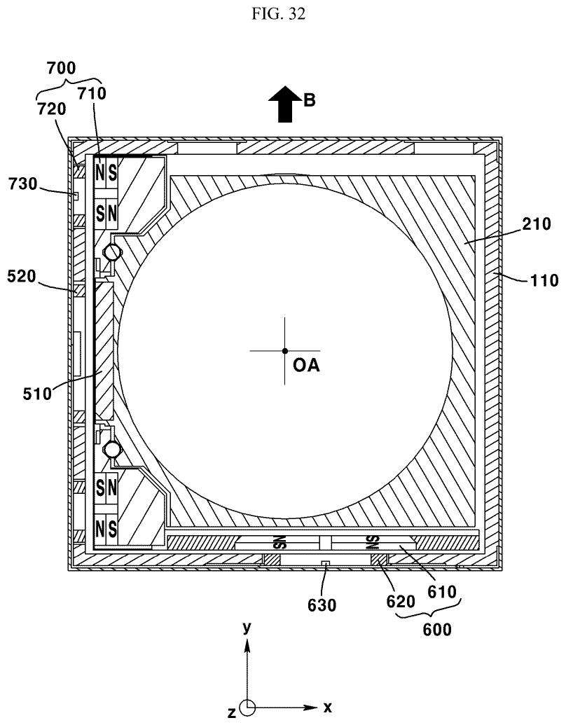

FIGS. 30 to 32 are drawings for explaining the handshake correction driving of a lens driving device according to a first embodiment of the present invention. FIG. 30 is a cross-sectional view illustrating the appearance of a moving part in an initial state in which no current is applied to an OIS-y coil and an OIS-x coil. FIG. 31 is a cross-sectional view illustrating a state in which an OIS-x moving part, an OIS-y moving part, and an AF moving part move in an x-axis direction perpendicular to the optical axis when current is applied to an OIS-x coil. FIG. 32 is a cross-sectional view illustrating a state in which an OIS-y moving part and an AF moving part move in a y-axis direction perpendicular to the optical axis when current is applied to the OIS-y coil.

As illustrated in FIG. 30, the moving part may be disposed at an initial position where no current is applied to the OIS-x coil 620 and the OIS-y coil 720. At this time, the moving part may be the OIS-x moving part 300 and the OIS-y moving part 400. In addition, the moving part may comprise the AF moving part 200, the OIS-x moving part 300, and the OIS-y moving part 400.

When current is applied to the OIS-x coil 620, the OIS-x magnet 610 can move in an x-axis direction perpendicular to the optical axis due to the electromagnetic interaction between the OIS-x coil 620 and the OIS-x magnet 610 (see A of FIG. 31). At this time, the OIS-x carrier 310 can move in an x-axis direction together with the OIS-x magnet 610. Furthermore, the OIS-y carrier 410, the AF carrier 210, and the lens can move in an x-axis direction together with the OIS-x carrier 310. In more detail, when a positive current is applied to the OIS-x coil 620, the OIS-x magnet 610, the OIS-x carrier 310, the OIS-y carrier 410, the AF carrier 210, and the lens can move in one direction on an x-axis. In addition, when a reverse current is applied to the OIS-x coil 620, the OIS-x magnet 610, the OIS-x carrier 310, the OIS-y carrier 410, the AF carrier 210, and the lens can move in the other direction along the x-axis.

When a current is applied to the OIS-y coil 720, the OIS-y magnet 710 can move in a y-axis direction perpendicular to the optical axis due to the electromagnetic interaction between the OIS-y coil 720 and the OIS-y magnet 710 (see B of FIG. 32). At this time, the OIS-y carrier 410 can move in a y-axis direction together with the OIS-y magnet 710. Furthermore, the AF carrier 210 and the lens can move in a y-axis direction together with the OIS-y carrier 410. In more detail, when a positive current is applied to the OIS-y coil 720, the OIS-y magnet 710, the OIS-y carrier 410, the AF carrier 210, and the lens can move in one direction on a y-axis. In addition, when a reverse current is applied to the OIS-y coil 720, the OIS-y magnet 710, the OIS-y carrier 410, the AF carrier 210, and the lens can move in the other direction along the y-axis.

Meanwhile, the OIS-x sensor 630 can detect the amount of movement or position of the OIS-x magnet 610 by detecting the strength of the magnetic field of the OIS-x magnet 610. The amount of movement or position of the OIS-x magnet 610 detected by the OIS-x sensor 630 can be used for x-axis direction handshake correction feedback control. The OIS-y sensor 730 can detect the amount of movement or position of the OIS-y magnet 710 by detecting the strength of the magnetic field of the OIS-y magnet 710. The amount of movement or position of the OIS-y magnet 710 detected by the OIS-y sensor 730 can be used for y-axis direction handshake correction feedback control.

Hereinafter, a camera device according to a first embodiment of the present invention will be described with reference to the drawings.

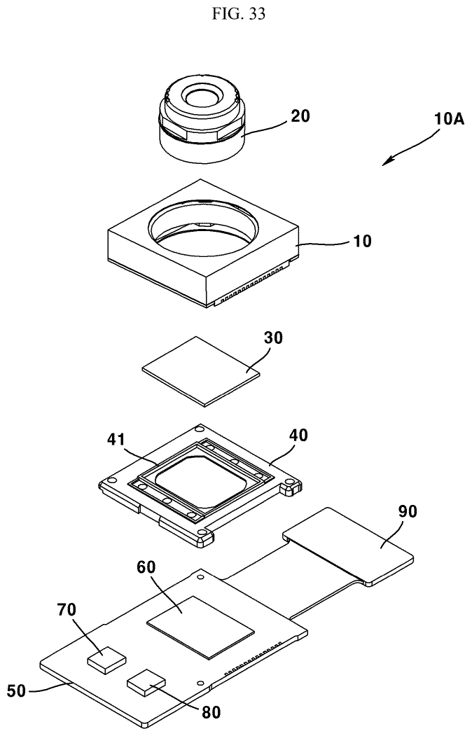

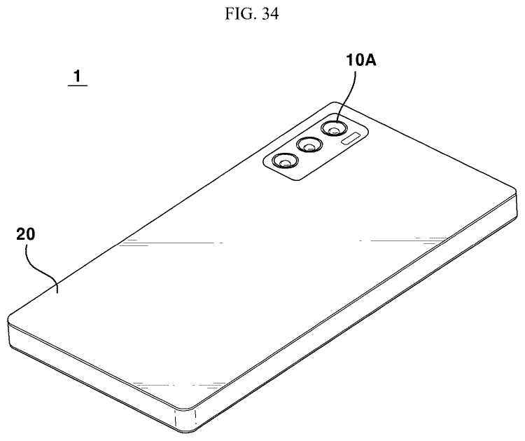

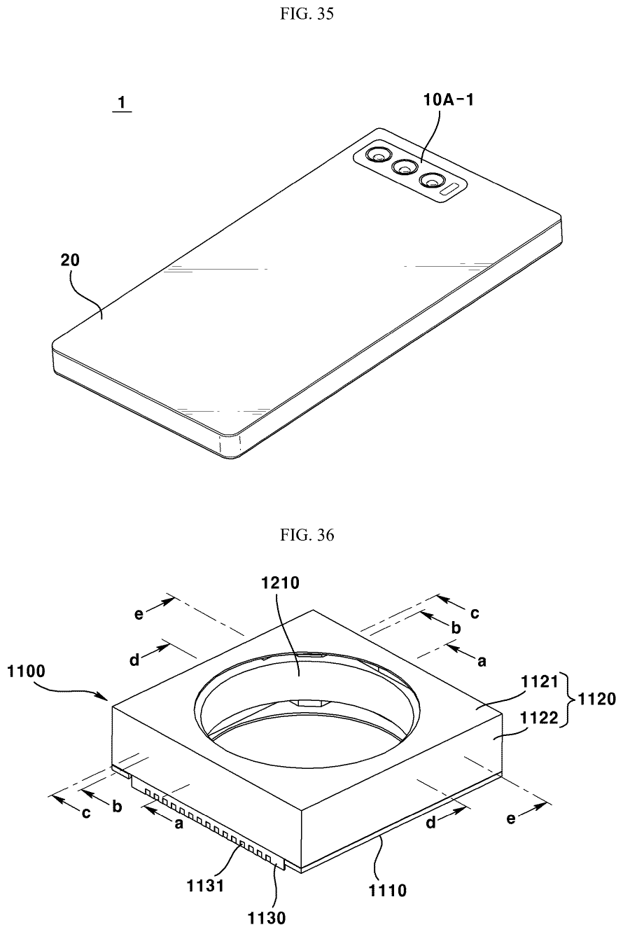

FIG. 33 is an exploded perspective view of a camera device according to a first embodiment of the present invention.

The camera device 10A may comprise a camera module.

The camera device 10A may comprise a lens module 20. The lens module 20 may comprise at least one lens. The lens may be disposed at a position corresponding to the image sensor 60. The lens module 20 may comprise a lens and a barrel. The lens module 20 may be coupled to an AF carrier 210 of a lens driving device 10. The lens module 20 may be coupled to the AF carrier 210 by screw coupling and/or adhesive. The lens module 20 may move integrally with the AF carrier 210.

The camera device 10A may comprise a filter 30. The filter 30 may block light of a specific frequency band from passing through the lens module 20 from being incident on the image sensor 60. The filter 30 may be disposed parallel to an x-y plane. The filter 30 may be disposed between the lens module 20 and the image sensor 60. The filter 30 may be disposed in the sensor base 40. In a modified embodiment, the filter 30 may be disposed in the base 110. The filter 30 may comprise an infrared filter. The infrared filter may block light of an infrared region from being incident on the image sensor 60.

The camera device 10A may comprise a sensor base 40. The sensor base 40 may be disposed between the lens driving device 10 and the printed circuit board 50. The sensor base 40 may comprise a protruded portion 41 on which a filter 30 is disposed. An opening may be formed in a portion of the sensor base 40 on which the filter 30 is disposed so that light passing through the filter 30 may be incident on the image sensor 60. The adhesive member may couple or attach the base 110 of the lens driving device 10 to the sensor base 40. The adhesive member may additionally serve to prevent foreign substances from entering the interior of the lens driving device 10. The adhesive member may comprise at least one of an epoxy, a thermosetting adhesive, and an ultraviolet-curable adhesive.

The camera device 10A may comprise a printed circuit board (PCB) 50. The printed circuit board 50 may be a substrate or a circuit board. A lens driving device 10 may be disposed in the printed circuit board 50. A sensor base 40 may be disposed between the printed circuit board 50 and the lens driving device 10. The printed circuit board 50 may be electrically connected to the lens driving device 10. An image sensor 60 may be disposed in the printed circuit board 50. Various circuits, elements, control units, and the like may be provided in the printed circuit board 50 to convert an image formed on the image sensor 60 into an electrical signal and transmit it to an external device.

The camera device 10A may comprise an image sensor 60. The image sensor 60 may be configured such that light passing through a lens and a filter 30 is incident to form an image. The image sensor 60 may be mounted on a printed circuit board 50. The image sensor 60 may be electrically connected to the printed circuit board 50. For example, the image sensor 60 may be coupled to the printed circuit board 50 by surface mounting technology (SMT). As another example, the image sensor 60 may be coupled to the printed circuit board 50 by flip chip technology. The image sensor 60 may be disposed such that its optical axis is aligned with that of the lens. That is, the optical axis of the image sensor 60 and the optical axis of the lens may be aligned. The image sensor 60 can convert light being irradiated to the effective image area of the image sensor 60 into an electrical signal. The image sensor 60 can be any one among a charge coupled device (CCD), a metal oxide semi-conductor (MOS), a CPD, and a CID.

The camera device 10A may comprise a motion sensor 70. The motion sensor 70 may be mounted on a printed circuit board 50. The motion sensor 70 may be electrically connected to a control unit 80 through a circuit pattern provided in the printed circuit board 50. The motion sensor 70 may output rotational velocity information due to the movement of the camera device 10A. The motion sensor 70 may comprise a two-axis or three-axis gyro sensor or an angular velocity sensor.

The camera device 10A may comprise a control unit 80. The control unit 80 may be disposed in a printed circuit board 50. The control unit 80 may be electrically connected to a coil 330 of a lens driving device 10. The control unit 80 may individually control the direction, intensity, and amplitude of current supplied to the coil 330. The control unit 80 may control the lens driving device 10 to perform an auto-focus function and/or a handshake correction function. Furthermore, the control unit 80 may perform auto-focus feedback control and/or handshake correction feedback control for the lens driving device 10.

The camera device 10A may comprise a connector 90. The connector 90 may be electrically connected to a printed circuit board 50. The connector 90 may comprise a port for being electrically connected to an external device.

Hereinafter, optics according to the present embodiment is described with reference to drawings.

FIG. 34 is a perspective view of optics according to the present embodiment; and FIG. 35 is a perspective view of optics according to a modified embodiment.

The optics 1 may comprise any one or more among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optics 1 may comprise any device for photographing images or pictures.

The optics 1 may comprise a main body 20. The optics 1 may comprise a camera device 10A. The camera device 10A may be disposed in the main body 20. The camera device 10A may photograph a subject. The optics 1 may comprise a display. The display may be disposed in the main body 20. The display may output one or more of an image and a video photographed by the camera device 10A. The display may be disposed on a first surface of the main body 20. The camera device 10A may be disposed on one or more of the first surface of the main body 20 and the second surface opposite to the first surface. As illustrated in FIG. 34, the camera device 10A may have a triple camera disposed in a vertical direction. As illustrated in FIG. 35, the camera device 10A-1 may have a triple camera disposed in a horizontal direction.

Hereinafter, the configuration of a lens driving device according to a second embodiment of the present invention is described with reference to the drawings.

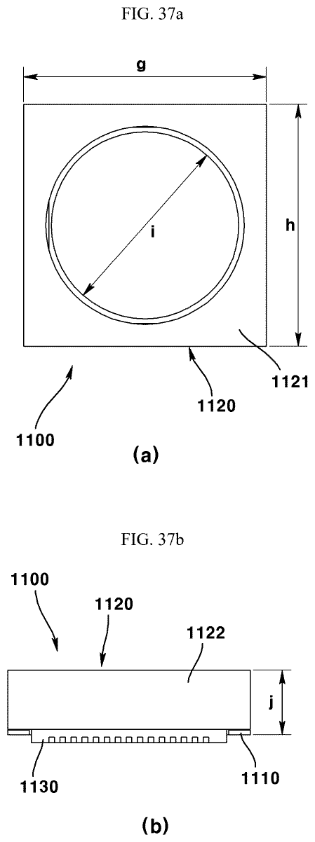

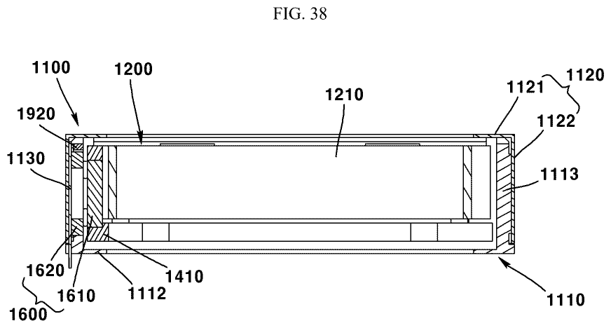

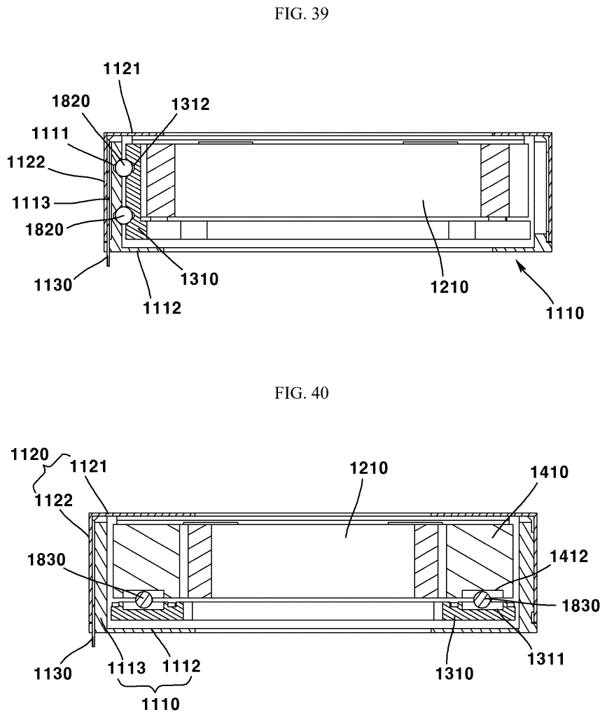

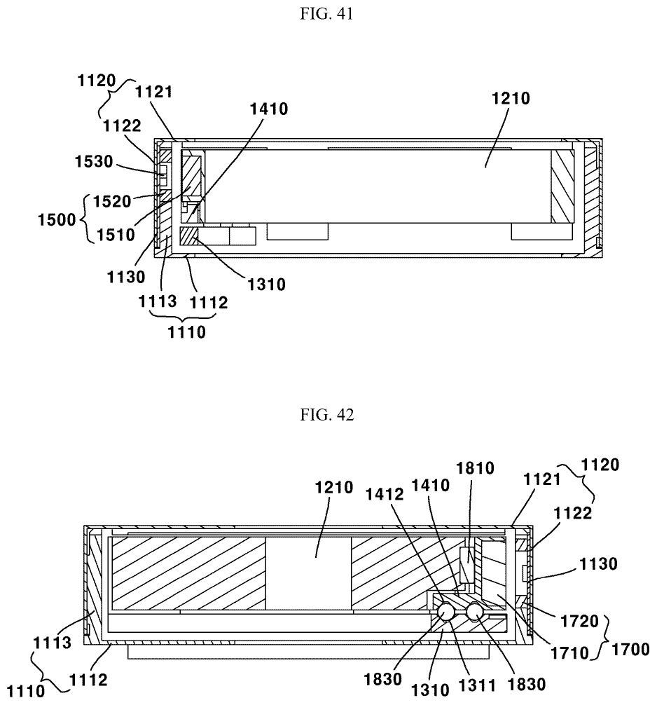

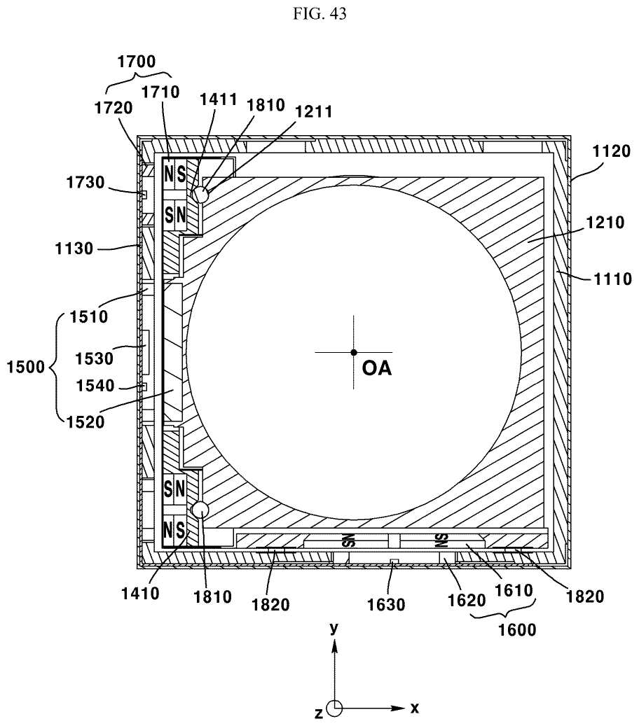

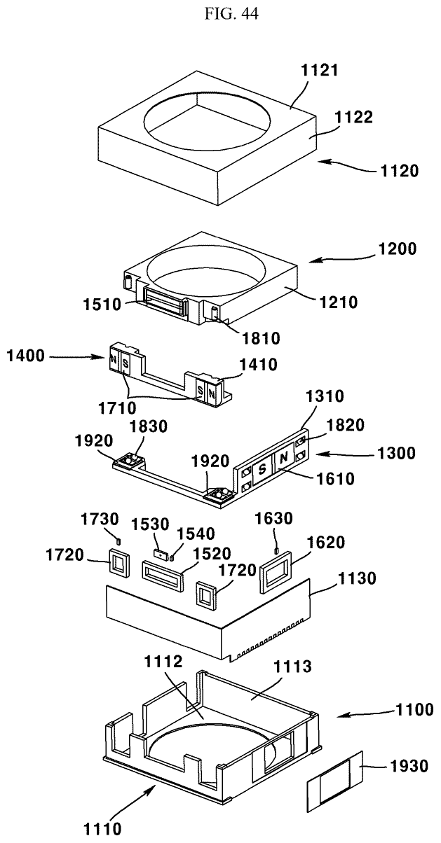

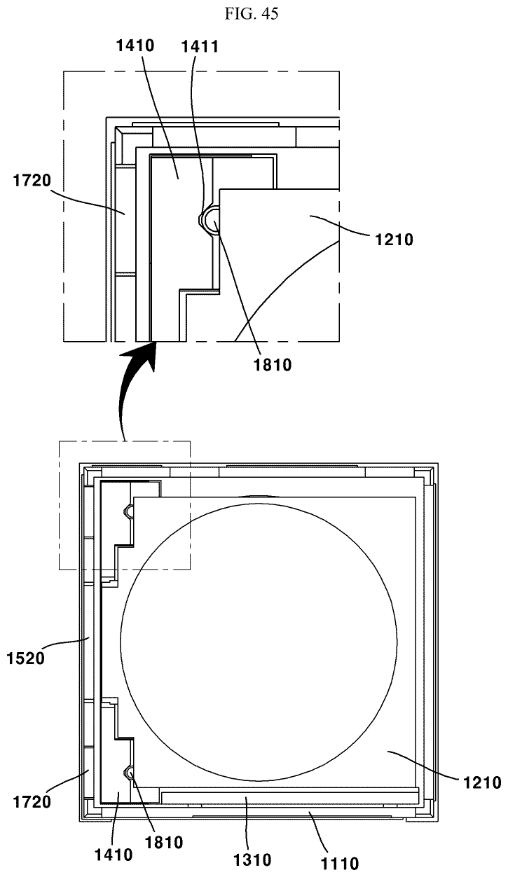

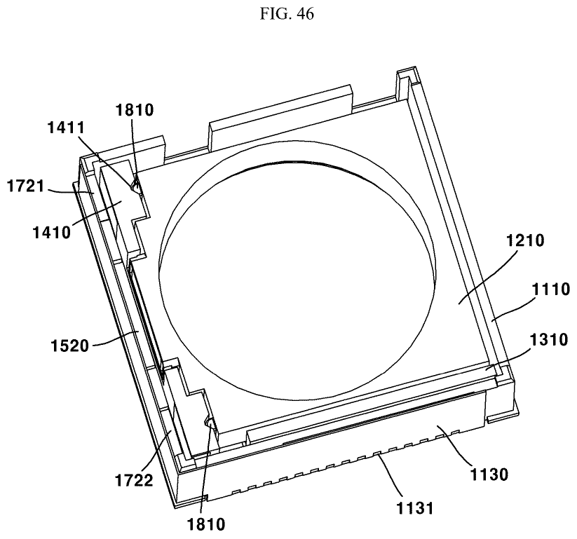

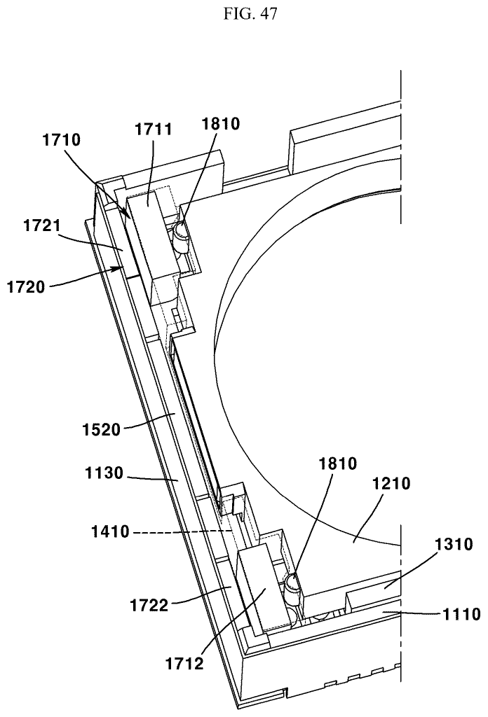

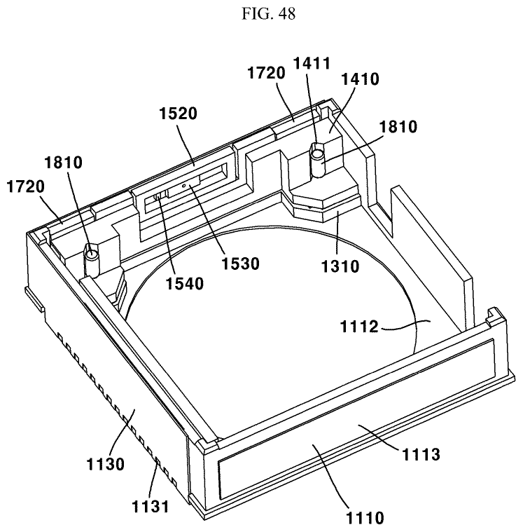

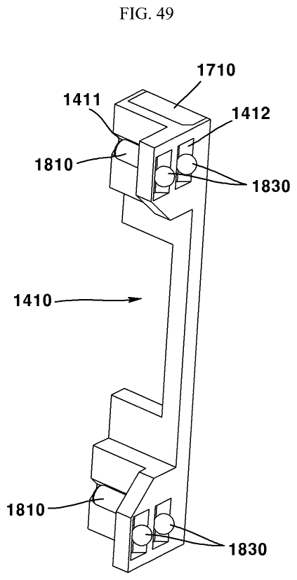

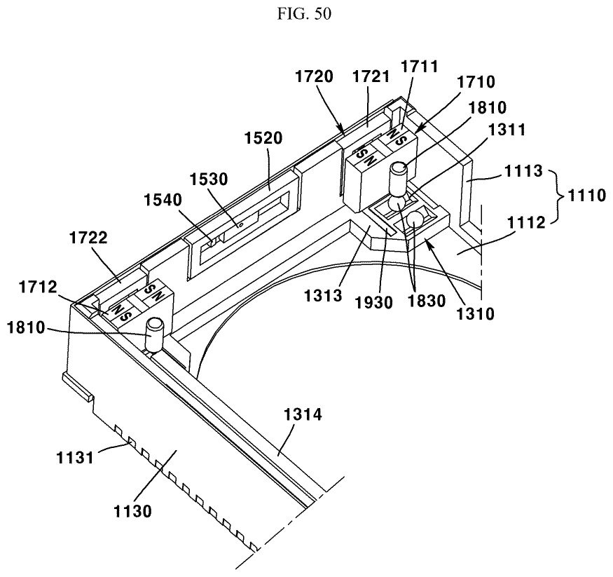

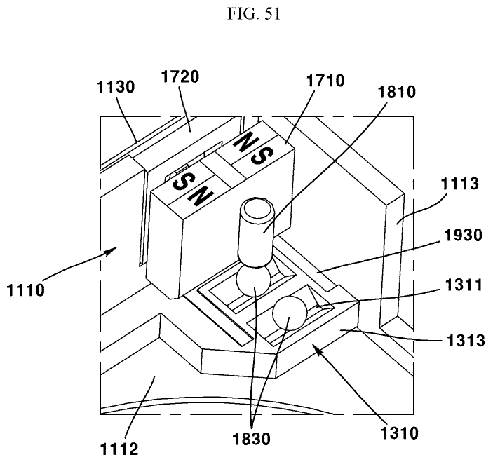

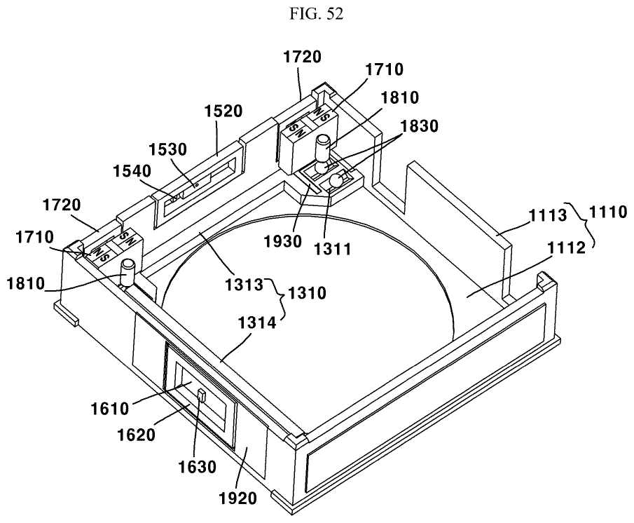

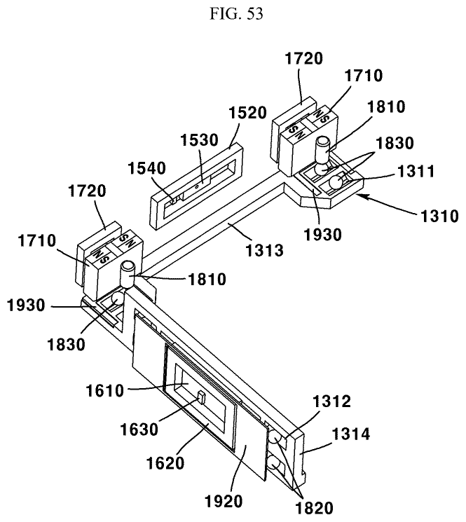

FIG. 36 is a perspective view of a lens driving device according to a second embodiment of the present invention; FIG. 37 a is a plan view of a lens driving device according to a second embodiment of the present invention, and b is a side view; FIG. 38 is a cross-sectional view taken along line a-a of FIG. 36; FIG. 39 is a cross-sectional view taken along line b-b of FIG. 36; FIG. 40 is a cross-sectional view taken along line c-c of FIG. 36; FIG. 41 is a cross-sectional view taken along line d-d of FIG. 36; FIG. 42 is a cross-sectional view taken along line e-e of FIG. 36; FIG. 43 is a cross-sectional view illustrating a cross-section of a lens driving device according to a second embodiment of the present invention cut in a direction perpendicular to an optical axis; FIG. 44 is an exploded perspective view of a lens driving device according to a second embodiment of the present invention; FIG. 45 is a plan view and a partially enlarged view of a lens driving device according to a second embodiment of the present invention with a cover removed; FIG. 46 is a perspective view of a lens driving device according to a second embodiment of the present invention with a cover removed; FIG. 47 is a partially enlarged see-through view of a portion of FIG. 46; FIG. 48 is a perspective view of a lens driving device according to a second embodiment of the present invention with a cover and an AF carrier removed; FIG. 49 is a bottom perspective view of an OIS-y carrier of a lens driving device according to a second embodiment of the present invention; FIG. 50 is a partially enlarged view of FIG. 48 with an OIS-y carrier removed; FIG. 51 is an enlarged view of an AF guide shaft and an OIS-y guide ball and related configuration of FIG. 50; FIG. 52 is a perspective view of a lens driving device according to a second embodiment of the present invention with a cover, an AF carrier, an OIS-y carrier, and a substrate removed; FIG. 53 is a perspective view of FIG. 52 with a base removed; and FIG. 54 is a perspective view illustrating an OIS-x carrier, a driving part, a guide member, and an attractive force member.

The lens driving device 1010 may be a voice coil motor (VCM). The lens driving device 1010 may be a lens driving motor. The lens driving device 1010 may be a lens driving actuator. The lens driving device 1010 may comprise an AF module. The lens driving device 1010 may comprise an OIS module.

The lens driving device 1010 may comprise a fixed part 1100. The fixed part 1100 may be a part that is relatively fixed when the moving part moves. The moving part may move against the fixed part 1100. The fixed part 1100 may be disposed outside the moving part. The fixed part 1100 may accommodate the moving part inside therein.

The lens driving device 1010 may comprise a base 1110. The fixed part 1100 may comprise the base 1110. The base 1110 may be disposed below the AF carrier 1210. The base 1110 may be disposed below the OIS-x carrier 1310. The base 1110 may be disposed below the OIS-y carrier 1410. The base 1110 may be coupled with the cover 1120. The AF carrier 1210, the OIS-x carrier 1310, and the OIS-y carrier 1410 may be disposed on the base 1110. The AF carrier 1210, the OIS-x carrier 310, and the OIS-y carrier 1410 may be disposed on the lower plate 1112 of the base 1110. The AF carrier 1210, the OIS-x carrier 1310, and the OIS-y carrier 1410 may be disposed inside the base 1110. The AF carrier 1210, the OIS-x carrier 1310, and the OIS-y carrier 1410 may be disposed inside the side plate 1113 of the base 1110.

The base 1110 may comprise a groove 1111. The groove 1111 may be an ‘OIS-x guide ball accommodating groove’. The groove 1111 may be concavely formed in the base 1110. The groove 1111 may be formed by recessing one surface of the base 1110. The groove 1111 may be formed in a side plate 1113 of the base 1110. The groove 1111 may be formed on an inner surface of the side plate 1113 of the base 1110. An OIS-x guide ball 1820 may be disposed in the groove 1111. The groove 1111 may be in direct contact with the OIS-x guide ball 1820. The groove 1111 may be disposed in a y-axis direction perpendicular to the optical axis. The groove 1111 may comprise a plurality of grooves. The groove 1111 may comprise four grooves. The four grooves may be disposed parallel to one another. The groove 1111 may comprise a first groove being in contact with the OIS-x guide ball 1820 at two points, and a second groove being in contact with the OIS-x guide ball 1820 at one point. In a variation, both the first groove and the second groove may be in contact with the OIS-x guide ball 1820 at two points.

The base 1110 may comprise a lower plate 1112. The lower plate 1112 may be a ‘bottom plate’. The base 1110 may comprise a side plate 1113. The side plate 1113 of the base 1110 may be a ‘side portion’. The side plate 1113 of the base 1110 may be extended from an upper surface of the lower plate 1112. The side plate 1113 of the base 1110 may comprise a plurality of side plates. The side plate 1113 of the base 1110 may comprise four side plates. The base 1110 may comprise a first side portion and a second side portion being disposed opposite to each other, and a third side portion and a fourth side portion being disposed opposite to each other. The AF coil 1520 and the OIS-y coil 1720 may be disposed in the first side portion of the base 1110. The OIS-x coil 1620 can be disposed in the third side portion of the base 1110.

The base 1110 may comprise a groove 1114. The groove 1114 may be a ‘yoke accommodating groove’. The groove 1114 may be formed in a side plate 1113 of the base 1110. The groove 1114 may be formed on an outer side surface of the side plate 1113 of the base 1110. An OIS-x attractive force yoke 1920 may be disposed in the groove 1114. The groove 1114 may comprise a shape corresponding to at least a portion of the OIS-x attractive force yoke 1920.

The lens driving device 1010 may comprise a cover 1120. The fixed part 1100 may comprise a cover 1120. The cover 1120 may be disposed in the base 1110. The cover 1120 may be disposed on the base 1110. The cover 1120 may be coupled to the base 1110. The cover 1120 may be fixed to the base 1110. The cover 1120 may be attached to the base 1110 with an adhesive. The cover 1120 may accommodate an AF carrier 1210 therein. The cover 1120 may accommodate an OIS-x carrier 1310 therein. The cover 1120 may accommodate an OIS-y carrier 1410 therein. The cover 1120 may be a shield member. The cover 1120 may be a shield can.

The cover 1120 may comprise an upper plate 1121. The upper plate 1121 may be disposed on a moving part. The upward movement of the moving part may be limited by the moving part being in contact with the upper plate 1121. The upper plate 1121 may comprise a hole through which light passes.

The cover 1120 may comprise a side plate 1122. The side plate 1122 may be extended from the upper plate 1121. The side plate 1122 may be disposed in the base 1110. The side plate 1122 may be disposed on a step portion being protruded from a lower portion of an outer side surface of the base 1110. The side plate 1122 may comprise a plurality of side plates. The side plate 1122 may comprise four side plates. The side plate 1122 may comprise a first side plate and a second side plate being disposed opposite to each other, and a third side plate and a fourth side plate being disposed opposite to each other.

In a second embodiment of the present invention, the AF coil 1520 and the OIS-y coil 1720 may be disposed between the moving part and the first side plate of the cover 1120. The AF coil 1520 and the OIS-y coil 1720 may be disposed between the AF carrier 1210 and the first side plate of the cover 1120. The AF coil 1520 and the OIS-y coil 1720 may be disposed between the OIS-y carrier 1410 and the first side plate of the cover 1120. The AF coil 1520 and the OIS-y coil 1720 may be disposed in the first side plate of the cover 1120. The AF coil 1520 and the OIS-y coil 1720 may be disposed at a position corresponding to the first side plate of the cover 1120.

The lens driving device 1010 may comprise a substrate 1130. The fixed part 1100 may comprise a substrate 1130. The substrate 1130 may be disposed in the base 1110. The substrate 1130 may be disposed in the side plate 1113 of the base 1110. The substrate 1130 may be disposed on an outer side surface of the side plate 1122 of the cover 1120. The substrate 1130 may be disposed parallel to an optical axis. The substrate 1130 may be a circuit board. The substrate 1130 may be a printed circuit board. The substrate 1130 may comprise a flexible printed circuit board (FPCB). The substrate 1130 may be flexible. The substrate 130 may be bent.

The substrate 1130 may comprise a first portion and a third portion being disposed at an opposite side to each other, and a second portion which connects the first portion and the third portion. At this time, the OIS-y coil 1720 may be disposed on a first portion of the substrate 1130. The OIS-x coil 1620 may be disposed in a second portion of the substrate 1130. The AF coil 1520 may be disposed in a third portion of the substrate 1130.

The substrate 1130 may comprise a body portion. Coils 1510, 1610, and 1710 may be disposed in the body portion. The substrate 1130 may comprise a terminal 1131. The terminal 1131 may be disposed in a terminal portion being extended downward from the body portion. The terminal 1131 may be formed at a lower portion of the substrate 1130. The terminal 1131 may be protruded downward from the base 1110.

The terminal 1131 may comprise a plurality of terminals. The terminal 1131 of the substrate 1130 may be electrically connected to the coils 1510, 1610, and 1710. The terminal 1131 of the substrate 1130 may be electrically connected to the AF coil 1520. The terminal 1131 of the substrate 1130 may be electrically connected to the OIS-x coil 1620. The terminal 1131 of the substrate 1130 may be electrically connected to the OIS-y coil 1720. The terminal 1131 of the substrate 1130 may be electrically connected to the sensors 1530, 1630, and 1730. The terminal 1131 of the substrate 1130 may be electrically connected to the AF sensor 1530. The terminal 1131 of the substrate 1130 can be electrically connected to the OIS-x sensor 1630. The terminal 1131 of the substrate 1130 can be electrically connected to the OIS-y sensor 1730. The terminal 1131 can be coupled to the printed circuit board 1050. The terminal 1131 can be coupled to the printed circuit board 1050 via solder. The terminal 1131 can be coupled to the printed circuit board 1050 via a conductive member.

The lens driving device 1010 may comprise a moving part. The moving part may be disposed in the fixed part 1100. The moving part may be disposed inside the fixed part 1100. The moving part may be disposed on the fixed part 1100. The moving part may be movably disposed in the fixed part 1100. The moving part may be moved with respect to the fixed part 1100 by a driving part. The moving part may be moved during AF driving. The moving part may be moved during OIS driving. A lens may be coupled to the moving part.

The lens driving device 1010 may comprise an AF moving part 1200. The AF moving part 1200 may be disposed in the fixed part 1100. The AF moving part 1200 may be disposed inside the fixed part 1100. The AF moving part 1200 may be disposed on the fixed part 1100. The AF moving part 1200 may be disposed inside the OIS-x moving part 1300. The AF moving part 1200 may be disposed on the OIS-x moving part 1300. The AF moving part 1200 may be disposed inside the OIS-y moving part 1400. The AF moving part 1200 may be disposed on the OIS-y moving part 1400. The AF moving part 1200 may be movably disposed. The AF moving part 1200 can move in an optical axis direction against the fixed part 1100, the OIS-x moving part 1300, and the OIS-y moving part 1400 by the AF driving unit 1500. The AF moving part 1200 can move during AF driving.

When a current is applied to the OIS-y coil 1720, the AF moving part 1200 can move together with the OIS-y moving part 1400. When a current is applied to the OIS-x coil 1620, the AF moving part 1200 and the OIS-y moving part 1400 can move together with the OIS-x moving part 1300.

The lens driving device 1010 may comprise an AF carrier 1210. The AF moving part 1200 may comprise an AF carrier 1210. The AF carrier 1210 may be a ‘bobbin’. The AF carrier 1210 may be an ‘AF holder’. The AF carrier 1210 may be disposed inside the base 1110. The AF carrier 1210 may be disposed on the base 1110. The AF carrier 1210 may be disposed inside the OIS-x carrier 1310. The AF carrier 1210 may be disposed on the OIS-x carrier 1310. The AF carrier 1210 may be disposed inside the OIS-y carrier 1410. The AF carrier 1210 may be disposed on the OIS-y carrier 1410. The AF carrier 1210 can be disposed inside the cover 1120. The AF carrier 1210 can be movably disposed in an optical axis direction.

The AF carrier 1210 may comprise a groove 1211. The AF moving part 1200 may comprise a groove 1211. The groove 1211 may be an ‘AF guide shaft accommodating groove’. A shaft 1810 may be disposed in the groove 1211. The groove 1211 may be in direct contact with the shaft 1810. The groove 1211 may be disposed in an optical axis direction. The groove 1211 may comprise a plurality of grooves. The groove 1211 may comprise two grooves. The groove 1211 may be formed in a shape corresponding to a portion of the shaft 1810. The shaft 1810 may be fixed to the groove 1211.

The AF carrier 1210 may comprise a groove 1212. The AF moving part 1200 may comprise a groove 1212. The groove 1212 may be an ‘AF magnet accommodating groove’. The groove 1212 may be formed on an outer side surface of the AF carrier 1210. An AF magnet 1510 may be disposed in the groove 1212. The groove 1212 may be formed in a shape corresponding to the AF magnet 1510.

The lens driving device 1010 may comprise an OIS-x moving part 1300. The OIS-x moving part 1300 may be disposed in the fixed part 1100. The OIS-x moving part 1300 may be disposed inside the fixed part 1100. The OIS-x moving part 1300 may be disposed on the fixed part 1100. The OIS-x moving part 1300 may be disposed below the OIS-y moving part 1400. The OIS-x moving part 1300 may be disposed between the fixed part 1100 and the AF moving part 1200. The OIS-x moving part 1300 may be disposed between the fixed part 1100 and the OIS-y moving part 1400. The OIS-x moving part 1300 may be movably disposed. The OIS-x moving part 1300 can move in an x-axis direction against the fixed part 1100 by the OIS-x driving unit 1600. The OIS-x moving part 1300 can move during OIS driving. When the OIS-x moving part 1300 moves in an x-axis direction, the OIS-y moving part 1400 and the AF moving part 1200 can also move together.

The lens driving device 1010 may comprise an OIS-x carrier 1310. The OIS-x moving part 1300 may comprise an OIS-x carrier 1310. The OIS-x carrier 1310 may be an ‘OIS-x holder’. The OIS-x carrier 1310 may be disposed inside the base 1110. The OIS-x carrier 1310 may be disposed on the base 1110. The OIS-x carrier 1310 may be disposed below the OIS-y carrier 1410. The OIS-x carrier 1310 may be disposed inside the cover 1120. The OIS-x carrier 1310 may be disposed between the base 1110 and the AF carrier 1210. The OIS-x carrier 1310 can be disposed between the base 1110 and the OIS-y carrier 1410. The OIS-x carrier 1310 can be movably disposed in an x-axis direction.

The OIS-x carrier 1310 may comprise a groove 1311. The groove 1311 may be an ‘OIS-y guide ball accommodating groove’. The groove 1311 may be formed in a lower plate 1313 of the OIS-x carrier 1310. The groove 1311 may be formed on an upper surface of the lower plate 1313 of the OIS-x carrier 1310. An OIS-y guide ball 1830 may be disposed in the groove 1311. The groove 1311 may be in direct contact with the OIS-y guide ball 1830. The groove 1311 may be disposed in a y-axis direction. The groove 1311 may comprise a plurality of grooves. The groove 1311 may comprise four grooves. The groove 1311 may comprise a first groove being in contact with the OIS-y guide ball 1830 at two points, and a second groove being in contact with the OIS-y guide ball 1830 at one point. In a modified embodiment, both the first groove and the second groove may contact the AF guide ball 1810 at two points.

The OIS-x carrier 1310 may comprise a groove 1312. The OIS-x moving part 1300 may comprise a groove 1312. The groove 1312 may be an ‘OIS-x guide ball accommodating groove’. The groove 1312 may be formed in a side plate 1314 of the OIS-x carrier 1310. The groove 1312 may be formed on an outer surface of the side plate 1314 of the OIS-x carrier 1310. An OIS-x guide ball 1820 may be disposed in the groove 1312. The groove 1312 may be in direct contact with the OIS-x guide ball 1820. The groove 1312 may be disposed in an x-axis direction. The groove 1312 may comprise a plurality of grooves. The groove 1312 may comprise four grooves. The groove 1312 may comprise a first groove contacting the OIS-x guide ball 1820 at two points, and a second groove contacting the OIS-x guide ball 1820 at one point. In a modified embodiment, both the first groove and the second groove may contact the OIS-x guide ball 1820 at two points. The OIS-x carrier 1310 may comprise a lower plate 1313. The lower plate 1313 of the OIS-x carrier 1310 may be disposed between the base 1110 and the OIS-y carrier 1410 in an optical axis direction. The lower plate 1313 may be disposed perpendicular to the optical axis.

The OIS-x carrier 1310 may comprise a side plate 1314. The side plate 1314 of the OIS-x carrier 1310 may be disposed between the base 1110 and the AF carrier 1210 in a y-axis direction. The side plate 1314 may be connected to the lower plate 313. The side plate 1314 may be disposed parallel to an optical axis.

The OIS-x carrier 1310 may comprise a hole 1315. The hole 1315 may be an ‘OIS-x magnet accommodating hole’. The hole 1315 may be formed in a side plate 1314 of the OIS-x carrier 1310. The hole 1315 may penetrate the OIS-x carrier 1310 in a y-axis direction. An OIS-x magnet 1610 may be disposed in the hole 1315. The hole 1315 may comprise a shape corresponding to the OIS-x magnet 1610.

The lens driving device 1010 may comprise an OIS-y moving part 1400. The OIS-y moving part 1400 may be disposed in the fixed part 1100. The OIS-y moving part 1400 may be disposed inside the fixed part 1100. The OIS-y moving part 1400 may be disposed on the fixed part 1100. The OIS-y moving part 1400 may be disposed on the OIS-x moving part 1300. The OIS-y moving part 1400 may be disposed on the OIS-x moving part 1300. The OIS-y moving part 1400 may be disposed between the fixed part 1100 and the AF moving part 1200. The OIS-y moving part 1400 may be disposed between the fixed part 1100 and the AF moving part 1200 in a direction perpendicular to the optical axis. The OIS-y moving part 1100 can be disposed between the fixed part 1100 and the AF moving part 1200 in an x-axis direction. The OIS-y moving part 1400 can be movably disposed in the fixed part 1100. The OIS-y moving part 1400 can move in a y-axis direction against the fixed part 1100 by the OIS-y driving unit 1700. The OIS-y moving part 1400 can move during OIS driving. When the OIS-y moving part 1400 moves, the AF moving part 1200 can also move together.

The lens driving device 1010 may comprise an OIS-y carrier 1410. The OIS-y moving part 1400 may comprise an OIS-y carrier 1410. The OIS-y carrier 1410 may be an ‘OIS-y holder’. The OIS-y carrier 1410 may be disposed in the base 1110. The OIS-y carrier 1410 may be disposed inside the base 1110. The OIS-y carrier 1410 may be disposed on the base 110. The OIS-y carrier 1410 may be disposed inside the cover 1120. The OIS-y carrier 1410 may be disposed on the OIS-x carrier 1310. The OIS-y carrier 1410 may be disposed on the OIS-x carrier 1310. The OIS-y carrier 1410 can be disposed between the base 1110 and the AF carrier 1210. The OIS-y carrier 1410 can be disposed between the base 1110 and the AF carrier 1210 in a direction perpendicular to the optical axis. The OIS-y carrier 1410 can be disposed between the side plate 1113 of the base 1110 and the AF carrier 1210 in an x-axis direction. The OIS-y carrier 1410 can be movably disposed in a y-axis direction.

The OIS-y carrier 1410 may be disposed on one side surface of the base 1110. The OIS-y carrier 1410 may be disposed on a side surface portion of the base 1110. The AF carrier 1210 may be accommodated in the OIS carriers 1310 and 1410. The AF carrier 1210 may be accommodated in the OIS-x carrier 1310. The AF carrier 1210 may be accommodated in the OIS-y carrier 1410. One of the OIS carriers 1310 and 1410 may be supported by the other OIS carrier. The other OIS carrier of the OIS carriers 1310 and 1410 may be supported on a side wall of the base 1110. One of the OIS guide balls 1820 and 1830 may be disposed on the side wall portion of the base 1110. However, the other may be disposed on the side of the bottom side portion of the base 1110. In this case, it may be disposed only on the side facing the bottom of the base 1110, and actual support may be disposed on the bottom of the OIS carrier.

The OIS-y carrier 1410 may comprise a groove 1411. The OIS-y moving part 1400 may comprise a groove 1411. The groove 1411 may be an ‘AF guide shaft accommodating groove’. The groove 1411 may be concavely formed in the OIS-y carrier 1410. The groove 1411 may be formed on an inner surface of the OIS-y carrier 1410. A shaft 1810 may be disposed in the groove 1411. The groove 1411 may be in direct contact with the shaft 1810. The groove 1411 may be disposed in an optical axis direction. The groove 1411 may comprise a plurality of grooves. The groove 1411 may comprise two grooves. The groove 1411 may comprise a first groove contacting the shaft 1810 at two points, and a second groove contacting the shaft 1810 at one point. In a modified embodiment, both the first groove and the second groove may contact the shaft 1810 at two points. The shaft 1810 may move along the OIS-y carrier 1410 in an optical axis direction.

The OIS-y carrier 1410 may comprise a groove 1412. The OIS-y moving part 1400 may comprise a groove 1412. The groove may be an ‘OIS-y guide ball accommodating groove’. The groove 1412 may be concavely formed in the OIS-y carrier 1410. The groove 1412 may be formed on a lower surface of the OIS-y carrier 1410. An OIS-y guide ball 1830 may be disposed in the groove 1412. The groove 1412 may be in direct contact with the OIS-y guide ball 1830. The groove 1412 may be disposed in a y-axis direction. The groove 1412 may comprise a plurality of grooves. The groove 1412 may comprise four grooves. The four grooves may be disposed parallel to each other. The groove 1412 may comprise a first groove being in contact with the OIS-y guide ball 1830 at two points, and a second groove being in contact with the OIS-y guide ball 1830 at one point. In a modified embodiment, both the first groove and the second groove may contact the OIS-y guide ball 1830 at two points.

The OIS-y carrier 1410 may comprise a groove 1413. The groove 1413 may be an ‘OIS-y magnet accommodating groove’. The groove 1413 may be formed on an outer side surface of the OIS-y carrier 1410. An OIS-y magnet 1710 may be disposed in the groove 1413. The groove 1413 may comprise a shape corresponding to the OIS-y magnet 1710.

The lens driving device 1010 may comprise a driving part. The driving part may move the moving part against the fixed part. The driving part may comprise an AF driving part 1500. The driving part may comprise an OIS driving parts 1600 and 1700. The driving part may comprise a coil and a magnet.

The lens driving device 1010 may comprise an AF driving part 1500. The AF driving part 1500 may move the AF moving part 1200 in an optical axis direction. The AF driving part 1500 may move the AF carrier 1210 in an optical axis direction. The AF driving part 1500 may move the AF carrier 1210 in an optical axis direction through electromagnetic force. The AF driving part 1500 may comprise a coil and a magnet. The AF driving part 1500 may comprise a coil and a magnet that interact with each other. The AF coil 1520 and the AF magnet 1510 may move the AF moving part 1200 in an optical axis direction.

When the OIS-x moving part 1300, the OIS-y moving part 1400, and the AF moving part 1200 are moved by the OIS-x driving part 1600, the distance between the facing surfaces of the AF coil 1520 and the AF magnet 1510 may change. When the OIS-y moving part 1400 and the AF moving part 1200 are moved by the OIS-y driving part 1700, the distance between the facing surfaces of the AF coil 1520 and the AF magnet 1510 does not change, and the AF magnet 1510 may be eccentric against the AF coil 1520.

The lens driving device 1010 may comprise an AF magnet 1510. The AF driving part 1500 may comprise an AF magnet 1510. The AF magnet 1510 may be disposed in the AF moving part 1200. The AF magnet 1510 may be disposed in the AF carrier 1210. The AF magnet 1510 may be disposed in the groove 1212 of the AF carrier 1210. The AF magnet 1510 may be disposed on an outer side surface of the AF carrier 1210. The AF magnet 1510 may be fixed to the AF carrier 1210. The AF magnet 1510 may be coupled to the AF carrier 1210. The AF magnet 1510 may be attached to the AF carrier 1210 with an adhesive. The AF magnet 1510 may be disposed inside the cover 1120. The AF magnet 1510 may interact with the AF coil 1520. The AF magnet 1510 may electromagnetically interact with the AF coil 1520. The AF magnet 1510 may be disposed at a position corresponding to the AF coil 1520. The AF magnet 1510 may face the AF coil 1520. The AF magnet 1510 may face the AF coil 1520. The AF magnet 1510 may be overlapped with the AF coil 1520 in a direction perpendicular to the optical axis. The AF magnet 1510 may be overlapped with the AF coil 1520 in an x-axis direction. In a y-axis direction and an x-axis direction, the AF magnet 1510 may not be overlapped with the OIS-x magnet 1610.

The AF magnet 1510 may be a four-pole magnet. The AF magnet 1510 may comprise a four-pole magnetizing magnet. The AF magnet 1510 may comprise a first magnet portion comprising an N pole and an S pole, and a second magnet portion comprising an N pole and an S pole. The first magnet portion and the second magnet portion may be disposed in a vertical direction. The first magnet portion and the second magnet portion may be disposed spaced apart from each other in a vertical direction, and a neutral portion may be disposed between the first magnet portion and the second magnet portion.

In a y-axis direction, the AF magnet 1510 may be overlapped with the OIS-y magnet 1710. The OIS-y magnet 1710 may comprise a first unit magnet and a second unit magnet being spaced apart from each other. The AF magnet 1510 may be disposed between the first unit magnet and the second unit magnet of the OIS-y magnet 1710. In a y-axis direction, the AF magnet 1510 may be disposed between the first unit magnet and the second unit magnet. The AF magnet 1510 and the OIS-y magnet 1710 may be disposed on the same side. At this time, in a y-axis direction, the AF magnet 1510 may be overlapped with the OIS-y magnet 1710. Alternatively, in a y-axis direction, the AF magnet 1510 may not be overlapped with the OIS-y magnet 1710.

The lens driving device 1010 may comprise an AF coil 1520. The AF driving part 1500 may comprise an AF coil 1520. The AF coil 1520 may interact with an AF magnet 1510. The AF coil 1520 may move the AF magnet 1510 in an optical axis direction. The AF coil 1520 may move the AF magnet 1510 in the optical axis direction through interaction with the AF magnet 1510. The AF coil 1520 may face the AF magnet 1510. The AF coil 1520 may face the AF magnet 1510. The AF coil 1520 may be disposed at a position corresponding to the AF magnet 1510. The AF coil 1520 may be overlapped with the AF magnet 1510 in an x-axis direction. The AF coil 1520 may be disposed in the substrate 1130. The AF coil 1520 may be disposed at a position corresponding to the AF magnet 1510 in the substrate 1130. The AF coil 1520 may be disposed in the base 1110. The AF coil 1520 may be disposed in the side plate 1122 of the cover 1120. The AF coil 1520 may be disposed between the AF magnet 1510 and the cover 1120. The AF coil 1520 may be disposed in the fixed part 1100.

The AF coil 1520 may be disposed in the first side plate of the cover 1120. The AF coil 1520 may be disposed in the first side plate of the base 1110. The AF coil 1520 may be disposed in a first portion of the substrate 1130. The OIS-y coil 1720 may be disposed in the first side plate of the cover 1120. The OIS-y coil 1720 may be disposed in the first side plate of the base 1110. The OIS-y coil 1720 may be disposed in the first part of the substrate 1130.

In a y-axis direction, the AF coil 1520 may be overlapped with the OIS-y coil 1720. The AF coil 1520 may be disposed between the first unit coil 1721 and the second unit coil 1722 of the OIS-y coil 1720. In a y-axis direction, the AF coil 1520 may be disposed between the first unit coil 1721 and the second unit coil 1722. The AF coil 1520 and the OIS-y coil 1720 may be disposed on the same side. At this time, the AF coil 1520 may be overlapped with the OIS-y coil 1720 in a y-axis direction. Alternatively, the AF coil 1520 may not be overlapped with the OIS-y coil 1720 in a y-axis direction.

At least one OIS driving coil and the AF coil 1520 may be disposed on the same surface. At least one OIS driving coil and the AF coil 1520 may be disposed on the same surface of the substrate 1130. At least one OIS driving coil and the AF coil 1520 may be disposed on the same surface of the base 1110.

The second embodiment of the present invention may be a large-diameter lens driving device 10 having a horizontal width (see g of FIG. 37) of 22 mm, a vertical width (see h of FIG. 37) of 22 mm, and a hollow diameter (see i of FIG. 37) of 17 mm when viewed from above, as illustrated in (a) of FIG. 37. At this time, the horizontal width may be 20 to 24 mm, and the vertical width may be 20 to 24 mm. The hollow diameter may be 16 to 18 mm. The first embodiment of the present invention may secure a space in which two coils having different functions can be disposed on one side of the large-diameter lens driving device 1010. In the first embodiment of the present invention, an AF coil 1520 and an OIS-y coil 1720 may be disposed on one side of the moving part. As illustrated in (b) of FIG. 37, the height of the lens driving device 1010 (see j of FIG. 37) may be 5.7 mm. At this time, the height of the lens driving device 1010 may be 5.2 to 6.2 mm.

The lens driving device 1010 may comprise an AF sensor 1530. The AF driving part 1500 may comprise an AF sensor 1530. The AF sensor 1530 may be disposed on a substrate 1130. The AF sensor 1530 may comprise a Hall element (Hall IC). The AF sensor 1530 may comprise a Hall sensor. The AF sensor 1530 may detect an AF magnet 1510. The AF sensor 1530 may detect a magnetic force of the AF magnet 1510. The AF sensor 1530 may detect movement of the AF magnet 1510. The movement amount or position of the AF magnet 1510 detected by the AF sensor 1530 may be used for feedback of auto focus (AF).

The AF sensor 1530 may be disposed inside the AF coil 1520. The AF sensor 1530 may be overlapped with the AF coil 1520 in an optical axis direction. The AF sensor 1530 may be overlapped with the neutral portion of the AF magnet 1510 in an x-axis direction. In a modified embodiment, the AF sensor 1530 may be disposed outside the AF coil 1520. The AF sensor 1530 may face the AF magnet 1510. The AF sensor 1530 may be disposed at a position corresponding to the AF magnet 1510.

The AF sensor 1530 may comprise a drive IC. In this case, the drive IC may be electrically connected to the AF coil 1520. The drive IC may apply current to the AF coil 1520.

The lens driving device 1010 may comprise a capacitor 1540. The capacitor 1540 may be disposed in the substrate 1130. The capacitor 1540 may be disposed next to the AF sensor 1530. The capacitor 1540 may be disposed inside the AF coil 1520. The capacitor 1540 may remove noise related to data and current being transmitted and received from the AF sensor 1530.

The lens driving device 1010 may comprise an OIS-x driving part 1600. The OIS-x driving part 1600 can move the OIS-x moving part 1300 in an x-axis direction perpendicular to the optical axis direction and the y-axis direction. The OIS-x driving part 1600 can move the OIS-x carrier 1310 in an x-axis direction. The OIS-x driving part 1600 can move the OIS-x carrier 1310 in an x-axis direction through electromagnetic force. The OIS-x driving part 1600 may comprise a coil and a magnet. The OIS-x coil 1620 and the OIS-x magnet 1610 can move the OIS-x moving part 1300 in an x-axis direction perpendicular to the optical axis direction and the y-axis direction.

When the OIS-x moving part 1300 is moved by the OIS-x driving part 1600, the AF moving part 1200 and the OIS-y moving part 1400 can move together with the OIS-x moving part 1300. The AF moving part 1200 and the OIS-y moving part 1400 can move together with the OIS-x moving part 1300 in an x-axis direction.

The lens driving device 1010 may comprise an OIS-x magnet 1610. The OIS-x driving part 1600 may comprise an OIS-x magnet 1610. The OIS-x magnet 1610 may be disposed in the OIS-x moving part 1300. The OIS-x magnet 1610 may be disposed in the OIS-x carrier 1310. The OIS-x magnet 1610 may be disposed in the hole 1315 of the OIS-x carrier 1310. The OIS-x magnet 1610 may be fixed to the OIS-x carrier 1310. The OIS-x magnet 1610 may be coupled to the OIS-x carrier 1310. The OIS-x magnet 1610 may be attached to the OIS-x carrier 1310 with an adhesive. The OIS-x magnet 1610 can be disposed inside the cover 1120. The OIS-x magnet 1610 can interact with the OIS-x coil 1620. The OIS-x magnet 1610 can electromagnetically interact with the OIS-x coil 1620. The OIS-x magnet 1610 can be disposed at a position corresponding to the OIS-x coil 1620. The OIS-x magnet 1610 can face the OIS-x coil 1620. The OIS-x magnet 1610 can face the OIS-x coil 1620. The OIS-x magnet 1610 may be overlapped with the OIS-x coil 1620 in a direction perpendicular to the optical axis. The OIS-x magnet 1610 may be overlapped with the OIS-x coil 1620 in a y-axis direction.

The OIS-x magnet 1610 may be a four-pole magnet. The OIS-x magnet 1610 may comprise a four-pole magnetizing magnet. The OIS-x magnet 1610 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be spaced apart from each other in a horizontal direction, and a neutral portion may be disposed between the first magnet portion and the second magnet portion.

In a second embodiment of the present invention, even when the OIS-x magnet 1610 moves due to the interaction between the OIS-x coil 1620 and the OIS-x magnet 1610, the distance between the OIS-x coil 1620 and the OIS-x magnet 1610 can be maintained constant.

The lens driving device 1010 may comprise an OIS-x coil 1620. The OIS-x driving part 1600 may comprise the OIS-x coil 1620. The OIS-x coil 1620 may interact with the OIS-x magnet 1610. The OIS-x coil 1620 may move the OIS-x magnet 1610 in an x-axis direction. The OIS-x coil 1620 may move the OIS-x magnet 1610 in an x-axis direction through interaction with the OIS-x magnet 1610. The OIS-x coil 1620 may face the OIS-x magnet 1610. The OIS-x coil 1620 may face the OIS-x magnet 1610. The OIS-x coil 1620 may be disposed at a position corresponding to the OIS-x magnet 1610. The OIS-x coil 1620 may be overlapped with the OIS-x magnet 1610 in a y-axis direction. The OIS-x coil 1620 may be disposed in the substrate 1130. The OIS-x coil 1620 may be disposed in the substrate 1130 at a position corresponding to the OIS-x magnet 1610. The OIS-x coil 1620 may be disposed in the base 1110. The OIS-x coil 1620 may be disposed in the side plate 1122 of the cover 1120. The OIS-x coil 1620 may be disposed between the OIS-x magnet 1610 and the cover 1120. The OIS-x coil 1620 can be disposed in the fixed part 1100.

The lens driving device 1010 may comprise an OIS-x sensor 1630. The OIS-x driving part 1600 may comprise an OIS-x sensor 1630. The OIS-x sensor 1630 may be disposed in a substrate 1130. The OIS-x sensor 1630 may comprise a Hall element (Hall IC). The OIS-x sensor 1630 may comprise a Hall sensor. The OIS-x sensor 1630 may detect an OIS-x magnet 1610. The OIS-x sensor 1630 may detect a magnetic force of the OIS-x magnet 1610. The OIS-x sensor 1630 may detect movement of the OIS-x magnet 1610. The movement or position of the OIS-x magnet 1610 detected by the OIS-x sensor 1630 can be used for feedback of the handshake correction driving (OIS) in an x-axis direction.

The OIS-x sensor 1630 can be disposed inside the OIS-x coil 1620. The OIS-x sensor 1630 may be overlapped with the OIS-x coil 1620 in an optical axis direction. The OIS-x sensor 1630 may be overlapped with the neutral portion of the OIS-x magnet 1610 in a y-axis direction. In a modified embodiment, the OIS-x sensor 1630 can be disposed outside the OIS-x coil 1620. The OIS-x sensor 1630 can face the OIS-x magnet 1610. The OIS-x sensor 1630 can be disposed at a position corresponding to the OIS-x magnet 1610.

The lens driving device 1010 may comprise an OIS-y driving part 1700. The OIS-y driving part 1700 may move the OIS-y moving part 1400 in a y-axis direction perpendicular to the optical axis direction. The OIS-y driving part 1700 may move the OIS-y carrier 1410 in a y-axis direction. The OIS-y driving part 1700 may move the OIS-y carrier 1410 in a y-axis direction through electromagnetic force. The OIS-y driving part 1700 may comprise a coil and a magnet. The OIS-y coil 1720 and the OIS-y magnet 1710 may move the OIS-y moving part 1400 in a y-axis direction perpendicular to the optical axis direction.

When the OIS-y moving part 1400 is moved by the OIS-y driving part 1700, the AF moving part 1200 can move together with the OIS-y moving part 1400. The AF moving part 1200 can move together with the OIS-y moving part 1400 in a y-axis direction.

The lens driving device 1010 may comprise an OIS-y magnet 1710. The OIS-y driving part 1700 may comprise an OIS-y magnet 1710. The OIS-y magnet 1710 may be disposed in the OIS-y moving part 1400. The OIS-y magnet 1710 may be disposed in the OIS-y carrier 1410. The OIS-y magnet 1710 may be disposed in a groove 1413 of the OIS-y carrier 1410. The OIS-y magnet 1710 may be disposed on an outer side surface of the OIS-y carrier 1410. The OIS-y magnet 1710 may be fixed to the OIS-y carrier 1410. The OIS-y magnet 1710 can be coupled to the OIS-y carrier 1410. The OIS-y magnet 1710 can be attached to the OIS-y carrier 1410 with an adhesive. The OIS-y magnet 1710 can be disposed inside the cover 1120. The OIS-y magnet 1710 can interact with the OIS-y coil 1720. The OIS-y magnet 1710 can electromagnetically interact with the OIS-y coil 1720. The OIS-y magnet 1710 can be disposed at a position corresponding to the OIS-y coil 1720. The OIS-y magnet 1710 can face the OIS-y coil 1720. The OIS-y magnet 1710 can face the OIS-y coil 1720. The OIS-y magnet 1710 may be overlapped with the OIS-y coil 1720 in a direction perpendicular to the optical axis. In an x-axis direction, the OIS-y magnet 1710 may be overlapped with the OIS-x magnet 1610.

The OIS-y magnet 1710 may be a four-pole magnet. The OIS-y magnet 1710 may comprise a four-pole magnetizing magnet. The OIS-y magnet 1710 may comprise a first magnet portion comprising an N pole and an S pole, and a second magnet portion comprising an N pole and an S pole. The first magnet portion and the second magnet portion may be disposed in a horizontal direction. The first magnet portion and the second magnet portion may be disposed spaced apart from each other in a horizontal direction, and a neutral portion may be disposed between the first magnet portion and the second magnet portion.

The OIS-y magnet 1710 may comprise a plurality of magnets. The OIS-y magnet 1710 may comprise two magnets. The OIS-y magnet 1710 may comprise a first unit magnet and a second unit magnet. The first unit magnet 1711 and the second unit magnet 1722 may be formed with the same size and shape. The first unit magnet 1711 and the second unit magnet 1722 may be disposed on both sides of the AF magnet 1510. In a modified embodiment, one of the first unit magnet 1711 and the second unit magnet 1722 may be omitted. That is, the OIS-y magnet 1710 may be formed with only the first unit magnet 1711. Alternatively, the OIS-y magnet 1710 may be formed with only the second unit magnet 1712.

The first unit magnet 1711 and the second unit magnet 1712 can be disposed so that the surfaces facing the AF magnet 1510 have the same polarity. That is, the first unit magnet 1711 comprises a first surface facing the AF magnet 1510, and the outer side of the first surface has an S pole and the inner side can have an N pole. The second unit magnet 1712 comprises a second surface facing the AF magnet 1510, and the outer side of the second surface has an S pole and the inner side can have an N pole.

In a second embodiment of the present invention, even when the OIS-y magnet 1710 moves due to the interaction between the OIS-y coil 1720 and the OIS-y magnet 710, the distance between the OIS-y coil 1720 and the OIS-y magnet 710 can be maintained constant.

The lens driving device 1010 may comprise an OIS-y coil 1720. The OIS-y driving part 1700 may comprise an OIS-y coil 1720. The OIS-y coil 1720 may interact with an OIS-y magnet 1710. The OIS-y coil 1720 may move the OIS-y magnet 1710 in a y-axis direction. The OIS-y coil 1720 may move the OIS-y magnet 1710 in a y-axis direction through interaction with the OIS-y magnet 1710. The OIS-y coil 1720 may face the OIS-y magnet 1710. The OIS-y coil 1720 may face the OIS-y magnet 1710. The OIS-y coil 1720 may be disposed at a position corresponding to the OIS-y magnet 1710. The OIS-y coil 1720 may be overlapped with the OIS-y magnet 1710 in an x-axis direction. The OIS-y coil 1720 may be disposed in the substrate 1130. The OIS-y coil 1720 may be disposed in the substrate 1130 at a position corresponding to the OIS-y magnet 1710. The OIS-y coil 1720 may be disposed in the base 1110. The OIS-y coil 1720 may be disposed in the side plate 1122 of the cover 1120. The OIS-y coil 1720 may be disposed between the OIS-y magnet 1710 and the cover 1120. The OIS-y coil 1720 can be disposed on the fixed part 1100.

The OIS-y coil 1720 may comprise a plurality of coils. The OIS-y coil 1720 may comprise two coils. The OIS-y coil 1720 may comprise a first unit coil 1721 and a second unit coil 1722. The first unit coil 1721 and the second unit coil 1722 may be formed with the same size and shape. The first unit coil 1721 and the second unit coil 1722 may be disposed on both sides of the AF coil 1520. In a modified embodiment, either the first unit coil 1721 or the second unit coil 1722 may be omitted. That is, the OIS-y coil 1720 may be formed with only the first unit coil 1721. Alternatively, the OIS-y coil 1720 may be formed with only the second unit coil 1722.

The lens driving device 1010 may comprise an OIS-y sensor 1730. The OIS-y driving part 1700 may comprise an OIS-y sensor 1730. The OIS-y sensor 1730 may be disposed in a substrate 1130. The OIS-y sensor 1730 may comprise a Hall element (Hall IC). The OIS-y sensor 1730 may comprise a Hall sensor. The OIS-y sensor 1730 may detect an OIS-y magnet 1710. The OIS-y sensor 1730 may detect a magnetic force of the OIS-y magnet 1710. The OIS-y sensor 1730 may detect movement of the OIS-y magnet 1710. The movement amount or position of the OIS-y magnet 1710 detected by the OIS-y sensor 1730 can be used for feedback of the handshake correction driving (OIS) in a y-axis direction.

The OIS-y sensor 1730 may be disposed inside the OIS-y coil 1720. The OIS-y sensor 1730 may be overlapped with the OIS-y coil 1720 in an optical axis direction. The OIS-y sensor 1730 may be overlapped with the neutral portion of the OIS-y magnet 1710 in an x-axis direction. In a modified embodiment, the OIS-y sensor 1730 may be disposed outside the OIS-y coil 1720. The OIS-y sensor 1730 may face the OIS-y magnet 1710. The OIS-y sensor 1730 may be disposed at a position corresponding to the OIS-y magnet 1710.

The lens driving device 1010 may comprise a guide member. The guide member may comprise a ball. The guide member may comprise a pin. The guide member may comprise a cylindrical member. The guide member may guide the movement of the moving part against the fixed part 1100 in a specific direction.

The lens driving device 1010 may comprise a shaft 1810. The shaft 1810 may be an “AF guide shaft.” The shaft 1810 may guide the movement of the AF moving part 1200 in an optical axis direction. The shaft 1810 may guide the movement of the AF carrier 1210 against the OIS-y carrier 1410 in an optical axis direction. The shaft 1810 may be disposed between the AF moving part 1200 and the OIS-y moving part 1400. The AF moving part 1200 and the OIS-y moving part 1400 may comprise grooves 1211 and 1411 being extended in an optical axis direction. The shaft 1810 may be disposed between the groove 1211 of the AF moving part 1200 and the groove 1411 of the OIS-y moving part 1400. The shaft 1810 may be disposed between the OIS-y carrier 1410 and the AF carrier 1210. The shaft 1810 may be disposed between the OIS-y carrier 1410 and the AF carrier 1210 in an x-axis direction. The shaft 1810 may be disposed between the inner side surface of the OIS-y carrier 1410 and the outer side surface of the AF carrier 1210.

The shaft 1810 can be fixed to the AF moving part 1200. The shaft 1810 can be bonded to the AF moving part 1200. The shaft 1810 can be formed integrally with the AF moving part 1200. The shaft 1810 can be formed integrally with the AF moving part 1200 through insert injection. The shaft 1810 can be fixed to the AF carrier 1210. The shaft 1810 can be bonded to the AF carrier 1210. The shaft 1810 can be formed integrally with the AF carrier 1210. The shaft 1810 can be formed integrally with the AF carrier 1210 through insert injection. By the attractive force between the shaft 1810 and the OIS-y magnet 1710, the shaft 1810 and the AF moving part 1200 can be pressurized toward the OIS-y magnet 1710. The central axis of the shaft 1810 can be disposed parallel to an optical axis. The shaft 1810 can guide the AF moving part 1200 to move in an optical axis direction against the OIS-y moving part 1400. The shaft 1810 can guide the AF carrier 1210 to move in an optical axis direction against the OIS-y carrier 1410.

The OIS-y magnet 1710 may comprise an inner surface facing the shaft 1810. At least a portion of the shaft 1810 may be overlapped with the neutral portion of the OIS-y magnet 1710 in a direction perpendicular to the inner surface of the OIS-y magnet 1710. Conversely, the neutral portion of the OIS-y magnet 1710 may be overlapped with the shaft 1810 in a direction perpendicular to the inner surface of the OIS-y magnet 1710.

The upper surface of the shaft 1810 may be disposed lower than the upper surface of the OIS-y magnet 1710. The upper surface of the shaft 1810 may be disposed at the same height as the upper surface of the OIS-y magnet 1710. The upper surface of the shaft 1810 may be disposed higher than the upper surface of the OIS-y magnet 1710. At an initial position where no current is applied to the AF coil 1520, the center of the shaft 1810 in an optical axis direction may be disposed at the same height as the center of the OIS-y magnet 1710 in an optical axis direction. At an initial position where no current is applied to the AF coil 1520, the center of the shaft 1810 in an optical axis direction may be disposed higher than the center of the OIS-y magnet 1710 in an optical axis direction. In an initial position where no current is applied to the AF coil 1520, the center of the shaft 1810 in an optical axis direction may be positioned lower than the center of the OIS-y magnet 1710 in an optical axis direction.

The shaft 1810 may be disposed between the groove 1411 of the OIS-y moving part 1400 and the groove 1211 of the AF moving part 1200. At least one of the groove 1411 of the OIS-y moving part 1400 and the groove 1211 of the AF moving part 1200 may be extended longer than the diameter of the shaft 1810 in an optical axis direction. The shaft 1810 may be disposed in the groove 1411 of the OIS-y carrier 1410. At this time, the shaft 1810 may be fixed to the AF moving part 1200. In an optical axis direction, the length of the groove 1411 of the OIS-y moving part 1400 may be longer than the length of the shaft 1810. In an optical axis direction, the length of the groove 1411 of the OIS-y moving part 1400 may be equal to or longer than the AF up-and-down stroke length. When the AF moving part 1200 moves upward to the maximum, the upper end of the groove 1411 of the OIS-y moving part 1400 may be positioned higher than the upper end of the shaft 1810. When the AF moving part 1200 maximally moves downward, the lower end of the groove 1411 of the OIS-y moving part 1400 may be disposed lower than the lower end of the shaft 1810. The shaft 1810 may be disposed in the groove 1211 of the AF carrier 1210. The shaft 1810 may have a cylindrical shape. The shaft 1810 may have a cylindrical shape. Grease may be applied to the surface of the shaft 1810.

The shaft 1810 may be formed of metal. The shaft 1810 may have magnetism. An attractive force may act between the shaft 1810 and the OIS-y magnet 1710. An attractive force may act between the shaft 1810 and the driving magnet. Through this, there is an advantage in that a separate attractive force member for pressurizing the shaft 1810 is unnecessary.

The shaft 1810 can comprise a plurality of shafts. The shaft 1810 can comprise two shafts. One of the two shafts 1810 can be disposed at one side of the AF magnet 1510 and the other can be disposed at the other side of the AF magnet 1510. The shaft 1810 can comprise a first shaft and a second shaft. In a direction in which the first shaft faces the second shaft, the AF magnet 1510 may not be overlapped with the first shaft and the second shaft. In a y-axis direction, the AF magnet 1510 may not be overlapped with the shaft. In a modified embodiment, in a direction in which the first shaft faces the second shaft, the AF magnet 1510 may be partially overlapped with the first shaft and the second shaft.

The distance between the upper surface of the shaft 1810 and the lower surface of the shaft 1810 may be 40 to 60% of the overall height of the lens driving device 1010. The length of the shaft 1810 in an optical axis direction may be 40 to 60% of the overall height of the lens driving device 1010. At this time, the overall height of the lens driving device 1010 may be the distance from a lower surface of the base 1110 to an upper surface of the cover 1120.

The lens driving device 1010 may comprise an OIS-x guide ball 820. The OIS-x guide ball 1820 may guide the movement of the OIS-x carrier 1310 against the base 1110 in an x-axis direction. The OIS-x guide ball 1820 may be disposed between the OIS-x moving part 1300 and the fixed part 1100. The OIS-x moving part 1300 and the fixed part 1100 may comprise grooves 1111 and 1312 being extended in an x-axis direction. The OIS-x guide ball 1820 may be disposed between the groove 1312 of the OIS-x moving part 1300 and the groove 1111 of the fixed part 1100. The OIS-x guide ball 1820 may be disposed between the base 1110 and the OIS-x carrier 1310. The OIS-x guide ball 1820 can be disposed between the base 1110 and the OIS-x carrier 1310 in a y-axis direction. The entire region from the lower end to the upper end of the OIS-x guide ball 1820 can be overlapped with both the base 1110 and the OIS-x carrier 1310 in a y-axis direction. The entire region of the OIS-x guide ball 1820 can be overlapped with the base 1110 and the OIS-x carrier 1310 in a y-axis direction. The OIS-x guide ball 1820 can be disposed between the side plate 1113 of the base 1110 and the side plate 1314 of the OIS-x carrier 1310. The OIS-x guide ball 1820 can be disposed between the inner surface of the side plate 1113 of the base 1110 and the outer surface of the side plate 1314 of the OIS-x carrier 1310. When viewed from the outside of the OIS-x carrier 1310, the OIS-x guide ball 1820 may be overlapped with the OIS-x magnet 1610 in a horizontal direction. At least a portion of the OIS-x guide ball 1820 may be overlapped with the OIS-x magnet 1610 in an x-axis direction.

The OIS-x guide ball 820 can be disposed between the groove 111 of the base 110 and the groove 312 of the OIS-x moving part 300. At least one of the groove 111 of the base 110 and the groove 312 of the OIS-x moving part 300 can be extended longer than the diameter of the OIS-x guide ball 820 in an x-axis direction.

The OIS-x guide ball 1820 may be disposed in the groove 1111 of the base 1110. The OIS-x guide ball 1820 may be disposed in the groove v312 of the OIS-x carrier 1310. The OIS-x guide ball 1820 may comprise a first-first ball being in contact with the base 1110 and the OIS-x carrier 1310 at four points, and a first-second ball being in contact with the base 1110 and the OIS-x carrier 1310 at three points. The OIS-x guide ball 1820 may be spherical. The OIS-x guide ball 1820 may be formed of metal. Grease may be applied to the surface of the OIS-x guide ball 1820.

The OIS-x guide ball 1820 may comprise multiple balls. The OIS-x guide ball 1820 may comprise four balls. Two OIS-x guide balls 1820 may be disposed on one side of the OIS-x magnet 1610, and the remaining two OIS-x guide balls 1820 may be disposed on the other side of the OIS-x magnet 1610.

The lens driving device 1010 may comprise an OIS-y guide ball 1830. The OIS-y guide ball 1830 may guide the movement of the OIS-y carrier 1410 against the OIS-x carrier 1310 in a y-axis direction. The OIS-y guide ball 1830 may be disposed between the OIS-y moving part 1400 and the OIS-x carrier 1310. The OIS-y guide ball 1830 may be disposed between the OIS-y moving part 1400 and the OIS-x carrier 1310 in an optical axis direction. The OIS-y moving part 1400 and the OIS-x moving part 1300 may comprise grooves 1311 and 1412 being extended in a y-axis direction. The OIS-y guide ball 1830 may be disposed between the groove 1412 of the OIS-y moving part 1400 and the groove 1311 of the OIS-x moving part 1300. The OIS-y guide ball 1830 may be disposed between the OIS-x carrier 310 and the OIS-y carrier 1410. The OIS-y guide ball 1830 may be disposed between the base 1110 and the OIS-y carrier 1410 in an optical axis direction. The OIS-y guide ball 1830 may be disposed in the groove 1311 of the OIS-x carrier 1310. The OIS-y guide ball 1830 may be disposed between the lower plate 1313 of the OIS-x carrier 1310 and the OIS-y carrier 1410. The OIS-y guide ball 1830 can be disposed between an upper surface of the lower plate 1313 of the OIS-x carrier 1310 and a lower surface of the OIS-y carrier 1410.

The OIS-y guide ball 1830 can be disposed between the groove 1311 of the OIS-x moving part 1300 and the groove 1412 of the OIS-y moving part 1400. At least one of the groove 1311 of the OIS-x moving part 1300 and the groove 1412 of the OIS-y moving part 1400 can be extended in a y-axis direction longer than the diameter of the OIS-y guide ball 1830.

The OIS-y guide ball 1830 may be disposed in the groove 311 of the OIS-x carrier 1310. The OIS-y guide ball 1830 may be disposed in the groove 1412 of the OIS-y carrier 1410. The OIS-y guide ball 1830 may comprise a first-first ball being in contact with the OIS-x carrier 1310 and the OIS-y carrier 1410 at four points, and a first-second ball being in contact with the OIS-x carrier 1310 and the OIS-y carrier 1410 at three points. The OIS-y guide ball 1830 may be spherical. The OIS-y guide ball 1830 may be formed of metal. Grease may be applied to a surface of the OIS-y guide ball 1830.

The OIS-y guide ball 1830 may comprise a plurality of balls. The OIS-y guide ball 1830 may comprise four balls. Two OIS-y guide balls 1830 may be disposed on one side of the AF magnet 1510, and the remaining two OIS-y guide balls 1830 may be disposed on the other side of the AF magnet 1510.

The lens driving device 1010 may comprise a ball pressurizing member. The ball pressurizing member may comprise a yoke. The yoke may be an ‘attractive force yoke’. The yoke may be an ‘attractive force member’. The yoke may be formed of metal. An attractive force may be generated between the yoke and the magnets 1610 and 1710. The balls 1820 and 1830 may be pressurized by an attractive force between the yoke and the magnets 1610 and 1710. In the second embodiment of the present invention, the attractive force yoke for the AF guide member can be omitted due to the attractive force between the shaft 1810 and the driving magnet.

The yoke may comprise a plurality of yokes. The yoke may comprise three yokes. The yoke may comprise an OIS-x attractive force yoke 1920 and an OIS-y attractive force yoke 1930. The OIS-x attractive force yoke 1920 and the OIS-y attractive force yoke 1930 may be spaced from each other.

The lens driving device 1010 may comprise an OIS-x attractive force yoke 1920. The OIS-x attractive force yoke 1920 may be disposed in the fixed part 1100. The OIS-x attractive force yoke 1920 may be disposed in the base 1110. The OIS-x attractive force yoke 1920 may be coupled to the base 1110. The OIS-x attractive force yoke 1920 may be fixed to the base 1110. The OIS-x attractive force yoke 1920 may be attached to the base 1110 with an adhesive. The OIS-x attractive force yoke 1920 may be disposed in the substrate 1130. The OIS-x attractive force yoke 1920 may be coupled to the substrate 1130. The OIS-x attractive force yoke 1920 may be fixed to the substrate 1130. The OIS-x attractive force yoke 1920 may be attached to the substrate 1130 with an adhesive. The OIS-x attractive force yoke 1920 can be disposed between the base 1110 and the substrate 1130. The OIS-x attractive force yoke 1920 can be disposed in the groove 1114 of the base 1110.

The OIS-x attractive force yoke 1920 can be disposed at a position corresponding to the OIS-x magnet 1610. The OIS-x attractive force yoke 1920 can exert an attractive force on the OIS-x magnet 1610. An attractive force can be generated between the OIS-x attractive force yoke 1920 and the OIS-x magnet 1610. The OIS-x guide ball 1820 can be pressurized by the attractive force between the OIS-x attractive force yoke 1920 and the OIS-x magnet 1610. The OIS-x guide ball 1820 can be pressurized between the OIS-x carrier 1310 and the base 1110 by the attractive force between the OIS-x attractive force yoke 1920 and the OIS-x magnet 1610.

The OIS-x attractive force yoke 1920 may comprise a hole. An OIS-x coil 1620 may be disposed in the hole of the OIS-x attractive force yoke 1920.

The lens driving device 1010 may comprise an OIS-y attractive force yoke 1930. The OIS-y attractive force yoke 1930 may be disposed in the OIS-x moving part 1300. The OIS-y attractive force yoke 1930 may be disposed in the OIS-x carrier 1310. The OIS-y attractive force yoke 1930 may be coupled to the OIS-x carrier 1310. The OIS-y attractive force yoke 1930 may be fixed to the OIS-x carrier 1310. The OIS-y attractive force yoke 1930 may be attached to the OIS-x carrier 1310 with an adhesive. The OIS-y attractive force yoke 1930 may be disposed in the lower plate 1313 of the OIS-x carrier 1310. The OIS-y attractive force yoke 1930 may be disposed on an upper surface of the lower plate 1313 of the OIS-x carrier 1310. The OIS-y attractive force yoke 1930 may be disposed at a position corresponding to the OIS-y magnet 1710. An attractive force can exert on the OIS-y attractive force yoke 1930 with the OIS-y magnet 1710. An attractive force may be generated between the OIS-y attractive force yoke 1930 and the OIS-y magnet 1710. The OIS-y guide ball 1830 may be pressurized by the attractive force between the OIS-y attractive force yoke 1930 and the OIS-y magnet 1710. The OIS-y guide ball 1830 can be pressurized between the OIS-y carrier 1410 and the OIS-x carrier 1310 by the attractive force between the OIS-y attractive force yoke 1930 and the OIS-y magnet 1710.

The OIS-y attractive force yoke 1930 may be formed in a ‘⊂’ shape. The OIS-y attractive force yoke 1930 may be formed in a ‘U’ shape. The OIS-y attractive force yoke 1930 may comprise a first yoke portion and a second yoke portion which are disposed parallel to each other, and a third yoke portion which connects the first yoke portion and the second yoke portion. The OIS-y attractive force yoke 1930 may be formed in a shape that is bent twice.

The second embodiment of the present invention may comprise a structure in which an OIS carrier is disposed on a side surface portion of a base 1110. An AF carrier 1210 may be accommodated in the OIS carrier. One of the OIS carriers may be supported on a side wall of the base 1110. The other may be supported on another OIS carrier other than the side wall of the base 1110. One OIS guide ball may be disposed on a side wall portion of the base 1110, while the other may be disposed on a bottom portion of the base 1110. The ball may be disposed only in a direction of the bottom portion of the base 1110, and actual support may be provided in a direction of the bottom portion of the OIS carrier. At least one OIS driving coil and an AF driving coil may be disposed on the same surface. At this time, the OIS driving coil disposed on the same surface may be divided into two, but may also be configured as one. An AF attractive force yoke 1910 for supporting the AF carrier 1200 may be located in the OIS carrier. The AF magnet 1510 may have a structure for sending magnetic force in a direction of the AF attractive force yoke 1910, such as a C-cut, for a greater attractive force than the AF attractive force yoke 1910. The OIS-y attractive force yoke 1930 may be present in a bottom direction of the OIS-x carrier 1310. The OIS-y guide ball 1830 may be disposed in the bottom direction with respect to the base 1110. The OIS-y magnet 1710 may have a structure for sending magnetic force in a direction of the OIS-y attractive force yoke 1930, such as a C-cut, for a greater attractive force than the OIS-y attractive force yoke 1930. The OIS-x attractive force yoke 1920 may be present in the side wall portion of the base 1110. The OIS-x attractive force yoke 1920 has a hole shape of a certain size, and an OIS-x coil 1620 can be disposed between the holes. However, in a modified embodiment, the hole shape of the OIS-x attractive force yoke 1920 may be omitted. If a hole is applied, the size of the OIS-x attractive force yoke 1920 can be slimmed down as much as the thickness thereof.

The AF moving part 1200 can be pressurized toward the OIS-y moving part 1400 by the attractive force between the shaft 1810 and the OIS-y magnet 1710.

The shaft 1810 is fixed to one of the AF moving part 1200 and the OIS-y moving part 1400, so that the shaft 1810 can be pressurized against the other of the AF moving part 1200 and the OIS-y moving part 1400 by the attractive force between the shaft 1810 and the OIS-y magnet 1710. Although the shaft 1810 has been described as a separate component from the AF moving part 1200 and the OIS-y moving part 1400, in a modified embodiment, the AF moving part 1200 may comprise the shaft 1810. Alternatively, the OIS-y moving part 1400 may comprise the shaft 1810. In this case, the AF moving part 1200 and the OIS-y moving part 1400 may be in contact or close contact with each other.

The AF moving part 1200 comprises a first side surface facing the AF coil 1520, and the first side surface of the AF moving part 1200 may comprise a first region, a second region recessed more inwardly than the first region, and a third region recessed more inwardly than the second region. The AF magnet 1510 may be disposed in a groove 1212 formed in the first region. The shaft 1810 may be disposed in a groove 1211 formed in the third region.

The OIS-y moving part 1400 may comprise a first surface having a first guide portion formed therein to guide the AF moving part 1200 to be moved in a first direction, and a second surface having a groove 1411 formed therein in which the shaft 1810 is disposed. At this time, the first direction may be the y-axis direction. The first guide portion may be a groove 1412. The first surface may be a lower surface. The second surface may be an inner side surface.

The lens driving device 1010 may comprise a first ball part being disposed between a lower surface of the OIS-y moving part 1400 and an upper surface of the OIS-x moving part 1300. At this time, the first ball part may be an OIS-y guide ball 1830. The lens driving device 1010 may comprise a second ball part being disposed between the OIS-x moving part 1300 and a side plate of the fixed part 1100. At this time, the second ball part may be an OIS-x guide ball 1820.

Hereinafter, the assembly process of a lens driving device according to a second embodiment of the present invention is described with reference to the drawings.

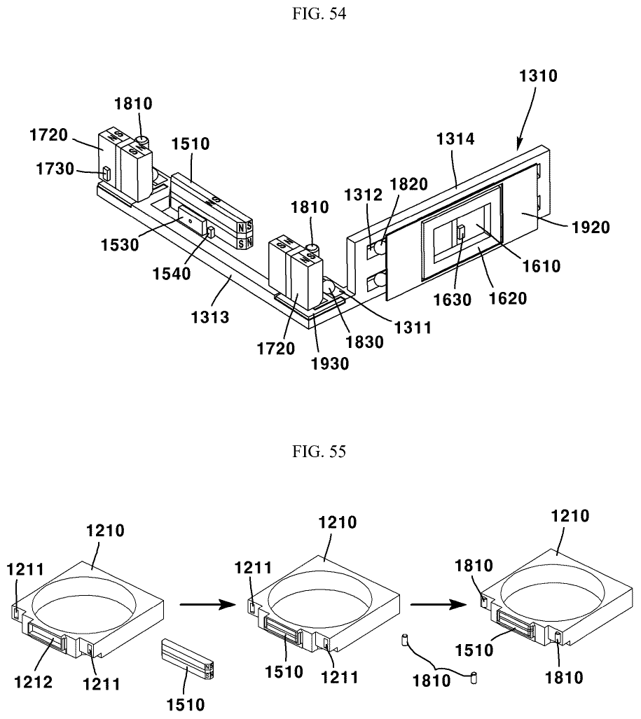

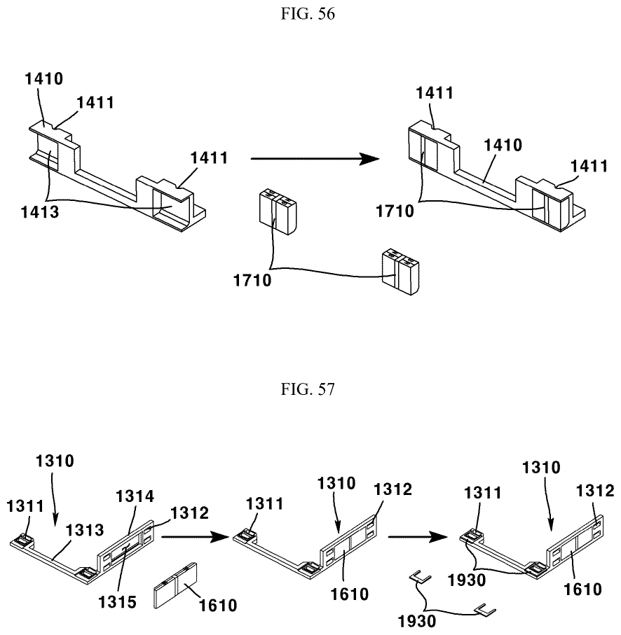

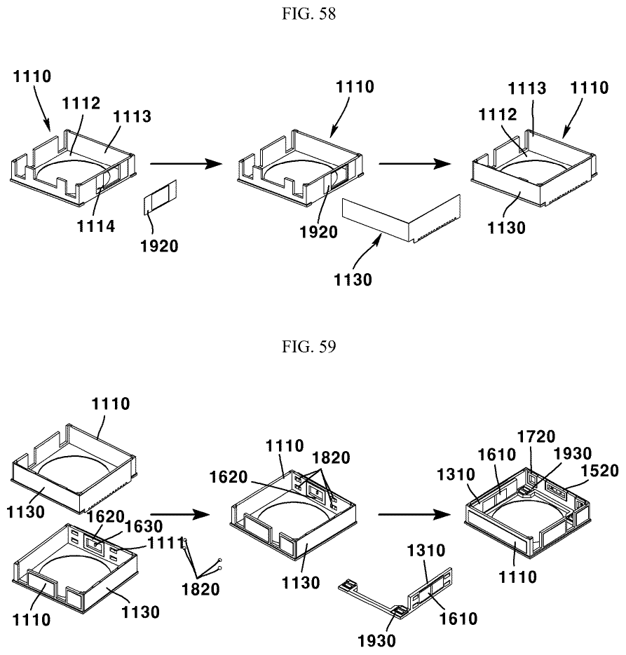

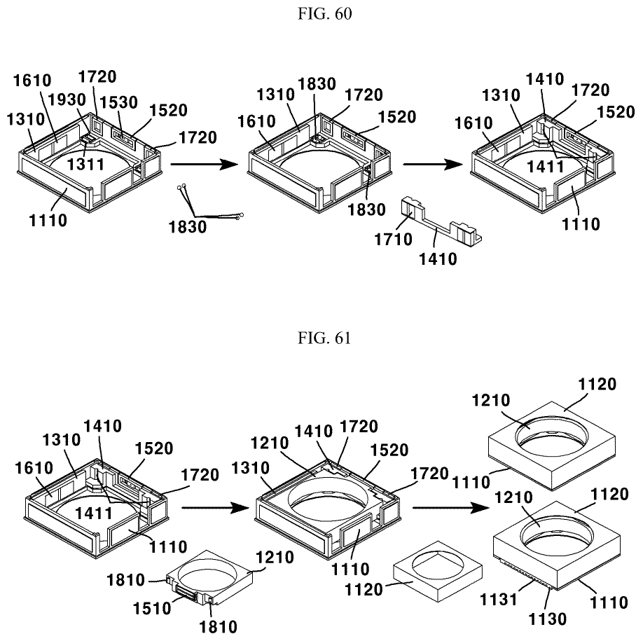

FIG. 55 is a drawing illustrating a process in which an AF magnet and a shaft are coupled to an AF carrier to form an AF carrier assembly; FIG. 56 is a drawing illustrating a process in which an OIS-y magnet is coupled to an OIS-y carrier to form an OIS-y carrier assembly; FIG. 57 is a drawing illustrating a process in which an OIS-x magnet and an OIS-y attractive force yoke are coupled to an OIS-x carrier to form an OIS-x carrier assembly; and FIG. 58 is a drawing illustrating a process in which an OIS-x attractive force yoke and a substrate assembly are coupled to a base. At this time, the substrate assembly may comprise a substrate, and a coil and a sensor coupled to the substrate. FIG. 59 is a drawing illustrating a process in which an OIS-x guide ball and an OIS-x carrier assembly are coupled in a final state of FIG. 58; FIG. 60 is a drawing illustrating a process in which an OIS-y guide ball and an OIS-y carrier assembly are coupled in a final state of FIG. 59; and FIG. 61 is a drawing illustrating the process of assembling an AF carrier assembly and a cover into a lens driving device by coupling them in a final state of FIG. 60.

As illustrated in FIG. 55, an AF magnet 1510 may be disposed in a groove 1212 of an AF carrier 1210, and a shaft 1810 may be disposed in a groove 1211 of an AF carrier 1210, to form an AF carrier assembly. As illustrated in FIG. 56, an OIS-y magnet 1710 may be disposed in a groove 1413 of an OIS-y carrier 1410, to form an OIS-y carrier assembly. As illustrated in FIG. 57, an OIS-x magnet 1610 may be disposed in a hole 1315 of an OIS-x carrier 1310, and an OIS-y attractive force yoke 1930 may be disposed in a lower plate 1313 of the OIS-x carrier 1310, to form an OIS-x carrier assembly. As illustrated in FIG. 58, an OIS-x attractive force yoke 1920 and a substrate assembly may be disposed in a base 1110. At this time, the substrate assembly may comprise a substrate 1130, coils 1520, 1620, and 1720 coupled to the substrate, and sensors 1530, 1630, and 1730. Thereafter, as illustrated in FIG. 59, an OIS-x guide ball 1820 and an OIS-x carrier assembly may be disposed in the final state of FIG. 58. Thereafter, as illustrated in FIG. 60, an OIS-y guide ball 1830 and an OIS-y carrier assembly may be disposed in the final state of FIG. 59. Thereafter, as illustrated in FIG. 61, an AF carrier assembly may be disposed in the final state of FIG. 60, and a cover 1120 may be coupled.

Hereinafter, the auto focus (AF) driving of a lens driving device according to a second embodiment of the present invention will be described with reference to the drawings.

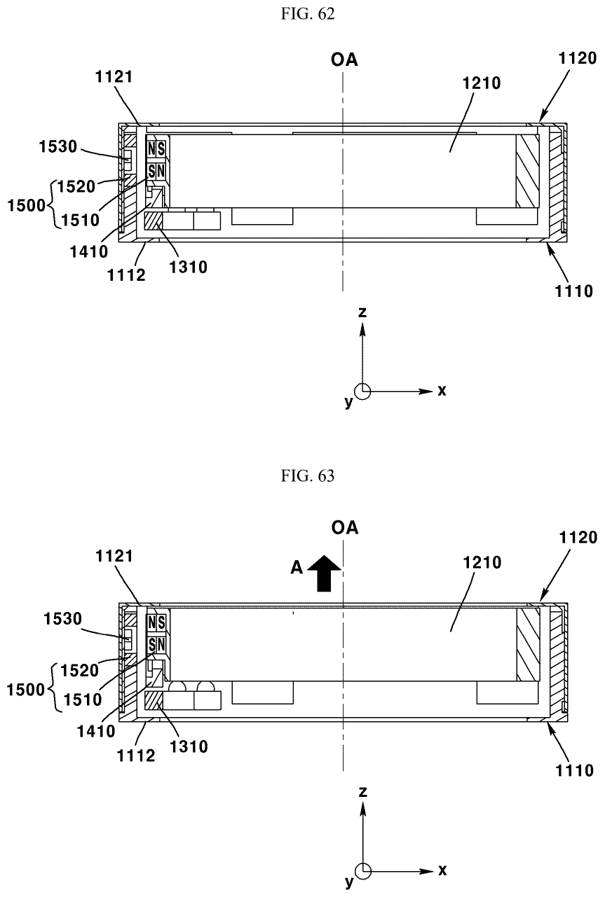

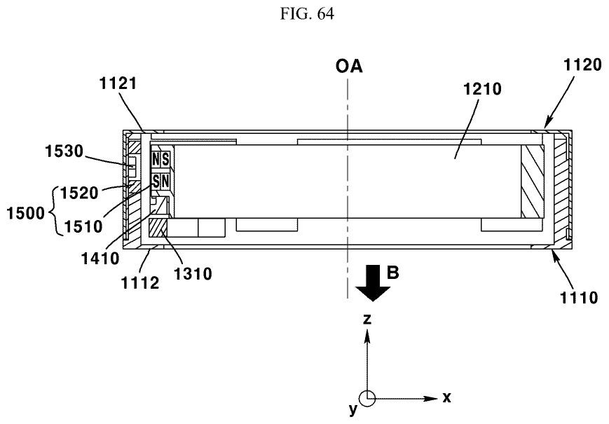

FIGS. 62 to 64 are drawings for explaining an auto focus driving of a lens driving device according to a second embodiment of the present invention. FIG. 62 is a cross-sectional view illustrating the appearance of an AF moving part in an initial state in which no current is applied to an AF coil. FIG. 63 is a cross-sectional view illustrating the appearance of an AF moving part moving upward in an optical axis direction when a forward current is applied to an AF coil. FIG. 64 is a cross-sectional view illustrating the appearance of an AF moving part moving downward in an optical axis direction when a reverse current is applied to an AF coil.

The moving part may be disposed at a position spaced apart from both the upper plate 1121 of the cover 1120 and the base 1110 in the initial position where no current is applied to the AF coil 1520. At this time, the moving part may be an AF moving part 1200.

When a positive current is applied to the AF coil 1520, the AF magnet 1510 can move upward in an optical axis direction due to the electromagnetic interaction between the AF coil 1520 and the AF magnet 1510 (see A of FIG. 63). At this time, the AF carrier 1210 can move upward in an optical axis direction together with the AF magnet 1510. Furthermore, the lens can move upward in an optical axis direction together with the AF carrier 1210. Accordingly, the distance between the lens and the image sensor can be changed, and the focus of the image being formed on the image sensor through the lens can be adjusted.

When a reverse current is applied to the AF coil 1520, the AF magnet 1510 can move downward in an optical axis direction due to the electromagnetic interaction between the AF coil 1520 and the AF magnet 1510 (see B of FIG. 64). At this time, the AF carrier 1210 can move downward in an optical axis direction together with the AF magnet 1510. Furthermore, the lens can move downward in an optical axis direction together with the AF carrier 1210. Accordingly, the distance between the lens and the image sensor can be changed, and the focus of the image being formed on the image sensor through the lens can be adjusted.

Meanwhile, during the movement process of the AF magnet 1510, the AF sensor 1530 can detect the strength of the magnetic field of the AF magnet 1510 to detect the amount of movement or position of the AF magnet 1510. The amount of movement or position of the AF magnet 1510 detected by the AF sensor 530 can be used for auto focus feedback control.

Hereinafter, the handshake correction OIS, optical image stabilization operation of a lens driving device according to a second embodiment of the present invention is described with reference to the drawings.

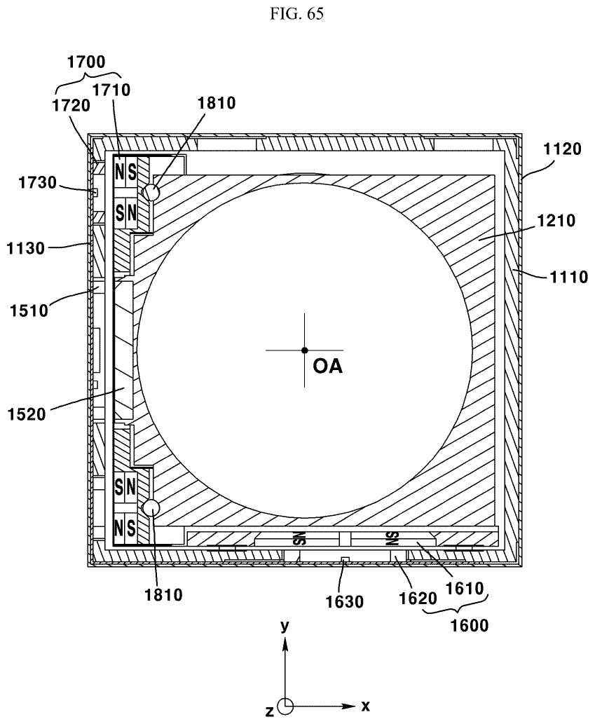

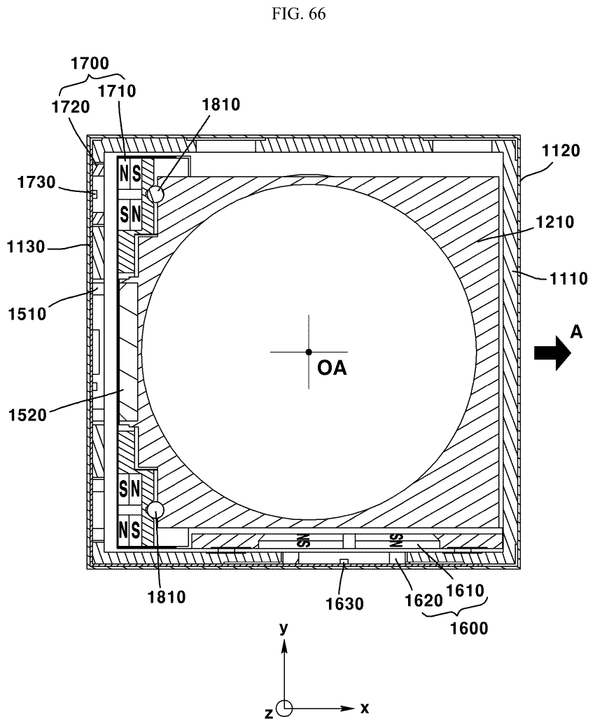

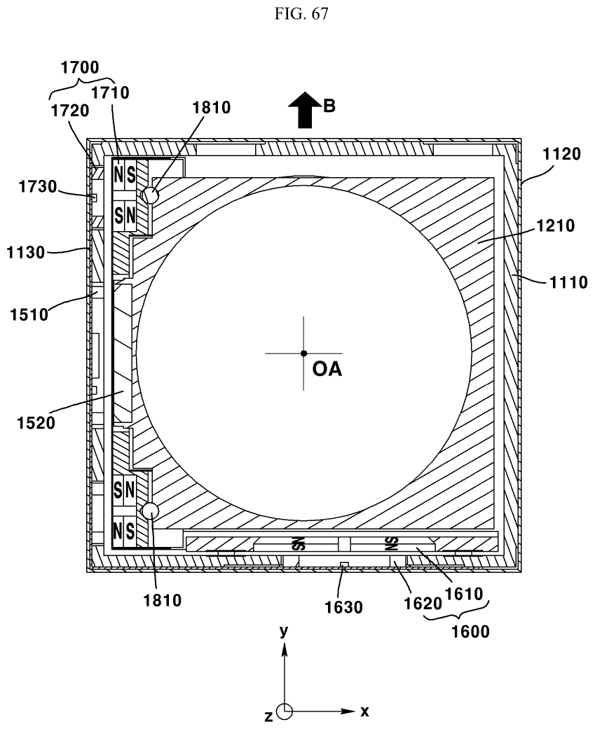

FIGS. 65 to 67 are drawings for explaining the handshake correction driving of a lens driving device according to a second embodiment of the present invention. FIG. 65 is a cross-sectional view illustrating the appearance of a moving part in an initial state in which no current is applied to an OIS-y coil and an OIS-x coil. FIG. 66 is a cross-sectional view illustrating an OIS-x moving part, an OIS-y moving part, and an AF moving part moving in an x-axis direction perpendicular to the optical axis when current is applied to an OIS-x coil. FIG. 67 is a cross-sectional view illustrating an OIS-y moving part and an AF moving part moving in a y-axis direction perpendicular to the optical axis when current is applied to an OIS-y coil.

As illustrated in FIG. 65, the moving part may be disposed at an initial position where no current is applied to the OIS-x coil 1620 and the OIS-y coil 1720. At this time, the moving part may be the OIS-x moving part 1300 and the OIS-y moving part 1400. In addition, the moving part may comprise the AF moving part 1200, the OIS-x moving part 1300, and the OIS-y moving part 1400.

When current is applied to the OIS-x coil 1620, the OIS-x magnet 1610 can move in an x-axis direction perpendicular to the optical axis due to the electromagnetic interaction between the OIS-x coil 1620 and the OIS-x magnet 1610 (see A of FIG. 66). At this time, the OIS-x carrier 1310 can move in an x-axis direction together with the OIS-x magnet 1610. Furthermore, the OIS-y carrier 1410, the AF carrier 1210, and the lens can move in an x-axis direction together with the OIS-x carrier 1310. In more detail, when a positive current is applied to the OIS-x coil 1620, the OIS-x magnet 1610, the OIS-x carrier 1310, the OIS-y carrier 1410, the AF carrier 1210, and the lens can move in one direction on an x-axis. In addition, when a reverse current is applied to the OIS-x coil 1620, the OIS-x magnet 1610, the OIS-x carrier 1310, the OIS-y carrier 1410, the AF carrier 1210, and the lens can move in the other direction along the x-axis.

When a current is applied to the OIS-y coil 1720, the OIS-y magnet 1710 can move in a y-axis direction perpendicular to the optical axis due to the electromagnetic interaction between the OIS-y coil 1720 and the OIS-y magnet 1710 (see B of FIG. 67). At this time, the OIS-y carrier 1410 can move in a y-axis direction together with the OIS-y magnet 1710. Furthermore, the AF carrier 1210 and the lens can move in a y-axis direction together with the OIS-y carrier 1410. In more detail, when a positive current is applied to the OIS-y coil 1720, the OIS-y magnet 1710, the OIS-y carrier 1410, the AF carrier 1210, and the lens can move in one direction on a y-axis. In addition, when a reverse current is applied to the OIS-y coil 1720, the OIS-y magnet 1710, the OIS-y carrier 1410, the AF carrier 1210, and the lens can move in the other direction along the y-axis.

Meanwhile, the OIS-x sensor 1630 can detect the amount of movement or position of the OIS-x magnet 1610 by detecting the strength of the magnetic field of the OIS-x magnet 610. The amount of movement or position of the OIS-x magnet 1610 detected by the OIS-x sensor 1630 can be used for x-axis direction handshake correction feedback control. The OIS-y sensor 1730 can detect the amount of movement or position of the OIS-y magnet 1710 by detecting the strength of the magnetic field of the OIS-y magnet 1710. The amount of movement or position of the OIS-y magnet 1710 detected by the OIS-y sensor 1730 can be used for y-axis direction handshake correction feedback control.

Hereinafter, a camera device according to a second embodiment of the present invention will be described with reference to the drawings.

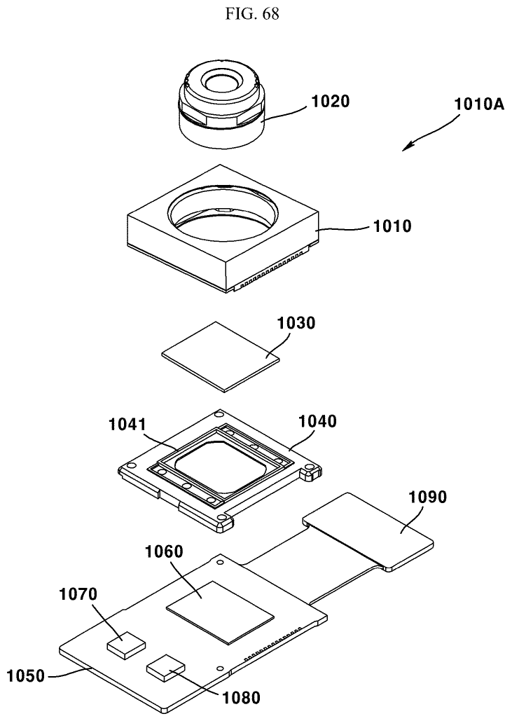

FIG. 68 is an exploded perspective view of a camera device according to a second embodiment of the present invention.

The camera device 1010A may comprise a camera module.

The camera device 1010A may comprise a lens module 1020. The lens module 1020 may comprise at least one lens. The lens may be disposed at a position corresponding to the image sensor 1060. The lens module 1020 may comprise a lens and a barrel. The lens module 1020 may be coupled to an AF carrier 1210 of a lens driving device 1010. The lens module 1020 may be coupled to the AF carrier 1210 by screw coupling and/or adhesive. The lens module 1020 may move integrally with the AF carrier 1210.

The camera device 1010A may comprise a filter 1030. The filter 1030 may block light of a specific frequency band from passing through the lens module 1020 from being incident on the image sensor 1060. The filter 1030 may be disposed parallel to an x-y plane. The filter 1030 may be disposed between the lens module 1020 and the image sensor 1060. The filter 1030 may be disposed in the sensor base 1040. In a modified embodiment, the filter 1030 may be disposed in the base 1110. The filter 1030 may comprise an infrared filter. The infrared filter may block light of an infrared region from being incident on the image sensor 1060.

The camera device 1010A may comprise a sensor base 1040. The sensor base 1040 may be disposed between the lens driving device 1010 and the printed circuit board 1050. The sensor base 1040 may comprise a protruded portion 1041 on which a filter 1030 is disposed. An opening may be formed in a portion of the sensor base 1040 on which the filter 1030 is disposed so that light passing through the filter 1030 may be incident on the image sensor 1060. The adhesive member may couple or attach the base 1110 of the lens driving device 1010 to the sensor base 1040. The adhesive member may additionally serve to prevent foreign substances from entering the interior of the lens driving device 1010. The adhesive member may comprise at least one of an epoxy, a thermosetting adhesive, and an ultraviolet-curable adhesive.

The camera device 1010A may comprise a printed circuit board (PCB) 1050. The printed circuit board 1050 may be a substrate or a circuit board. A lens driving device 1010 may be disposed in the printed circuit board 1050. A sensor base 1040 may be disposed between the printed circuit board 1050 and the lens driving device 1010. The printed circuit board 1050 may be electrically connected to the lens driving device 1010. An image sensor 1060 may be disposed in the printed circuit board 1050. Various circuits, elements, control units, and the like may be provided in the printed circuit board 1050 to convert an image formed on the image sensor 1060 into an electrical signal and transmit it to an external device.

The camera device 1010A may comprise an image sensor 1060. The image sensor 1060 may be configured such that light passing through a lens and a filter 1030 is incident to form an image. The image sensor 1060 may be mounted on a printed circuit board 1050. The image sensor 1060 may be electrically connected to the printed circuit board 1050. For example, the image sensor 1060 may be coupled to the printed circuit board 1050 by surface mounting technology (SMT). As another example, the image sensor 1060 may be coupled to the printed circuit board 1050 by flip chip technology. The image sensor 1060 may be disposed such that its optical axis is aligned with that of the lens. That is, the optical axis of the image sensor 1060 and the optical axis of the lens may be aligned. The image sensor 1060 can convert light being irradiated to the effective image area of the image sensor 1060 into an electrical signal. The image sensor 1060 can be any one among a charge coupled device (CCD), a metal oxide semi-conductor (MOS), a CPD, and a CID.

The camera device 1010A may comprise a motion sensor 1070. The motion sensor 1070 may be mounted on a printed circuit board 1050. The motion sensor 1070 may be electrically connected to a control unit 1080 through a circuit pattern provided in the printed circuit board 1050. The motion sensor 1070 may output rotational velocity information due to the movement of the camera device 1010A. The motion sensor 1070 may comprise a two-axis or three-axis gyro sensor or an angular velocity sensor

The camera device 1010A may comprise a control unit 1080. The control unit 1080 may be disposed in a printed circuit board 1050. The control unit 1080 may be electrically connected to a coil 1330 of a lens driving device 1010. The control unit 1080 may individually control the direction, intensity, and amplitude of current supplied to the coil 1330. The control unit 1080 may control the lens driving device 1010 to perform an auto-focus function and/or a handshake correction function. Furthermore, the control unit 1080 may perform auto-focus feedback control and/or handshake correction feedback control for the lens driving device 1010.

The camera device 1010A may comprise a connector 1090. The connector 1090 may be electrically connected to a printed circuit board 1050. The connector 1090 may comprise a port for being electrically connected to an external device.

Hereinafter, optics according to a second embodiment of the present invention are described with reference to the drawings.

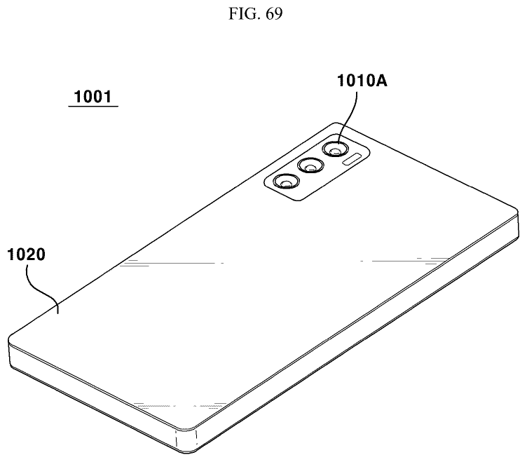

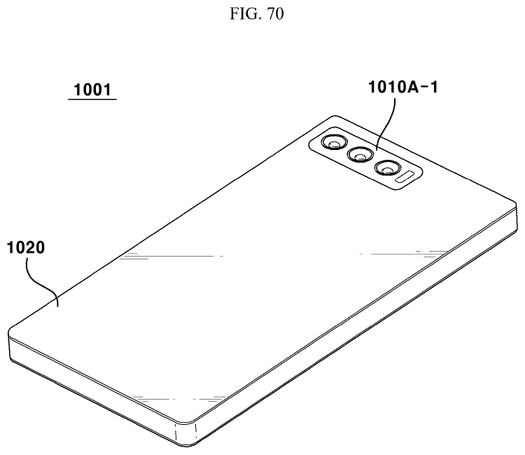

FIG. 69 is a perspective view of optics according to a second embodiment of the present invention.

The optics 1001 may comprise any one or more among a mobile phone, a cellular phone, a portable terminal, a mobile terminal, a smart phone, a smart pad, a portable smart device, a digital camera, a laptop computer, a digital broadcasting terminal, a personal digital assistant (PDA), a portable multimedia player (PMP), and a navigation device. The optics 1001 may comprise any device for photographing images or pictures.

The optics 1001 may comprise a main body 1020. The optics 1001 may comprise a camera device 1010A. The camera device 1010A may be disposed in the main body 20. The camera device 1010A may photograph a subject. The optics 1001 may comprise a display. The display may be disposed in the main body 1020. The display may output one or more of an image and a video photographed by the camera device 1010A. The display may be disposed on a first surface of the main body 1020. The camera device 1010A may be disposed on one or more of the first surface of the main body 1020 and the second surface opposite to the first surface. As illustrated in FIG. 34, the camera device 1010A may have a triple camera disposed in a vertical direction. As illustrated in FIG. 35, the camera device 1010A-1 may have a triple camera disposed in a horizontal direction.

In the above, the present invention has been described by dividing into the first embodiment and the second embodiment, but the first embodiment may comprise some components of the second embodiment. In addition, the second embodiment may comprise some components of the first embodiment. The third embodiment of the present invention may comprise some components of the first embodiment and some components of the second embodiment. In more detail, the second embodiment may comprise the AF attractive force yoke 910 of the first embodiment and related components. In addition, the first embodiment may comprise the shaft 1810 of the second embodiment and related components.

Although the present embodiment of the present invention has been described with reference to the attached drawings, those skilled in the art will understand that the present invention can be implemented in other specific forms without changing the technical idea or essential characteristics thereof. Therefore, it should be understood that the embodiments described above are exemplary in all respects and not restrictive.

1. A lens driving device comprising:
a fixed part;
a first moving part disposed in the fixed part;
a second moving part disposed between the fixed part and the first moving part;
a first coil and a first magnet configured to move the first moving part in an optical axis direction; and
a second coil and a second magnet configured to move the second moving part in a first direction perpendicular to the optical axis direction,
wherein the second coil is overlapped with the first coil in the first direction.

2. The lens driving device of claim 1, wherein the second coil comprises a first unit coil and a second unit coil, and
wherein, in the first direction, the first coil is disposed between the first unit coil and the second unit coil.

3. The lens driving device of claim 1, wherein, in the first direction, the first magnet is overlapped with the second magnet.

4. The lens driving device of claim 1, comprising:
a third moving part disposed between the fixed part and the second moving part; and
a third coil and a third magnet configured to move the third moving part in a second direction perpendicular to the optical axis direction and the first direction.

5. The lens driving device of claim 4, wherein when a current is applied to the second coil, the first moving part is configured to move together with the second moving part, and
wherein when a current is applied to the third coil, the first moving part and the second moving part are configured to move together with the third moving part.

6. The lens driving device of claim 1, comprising a first yoke on which an attractive force with the first magnet acts,
wherein the first magnet is disposed on the first moving part, and
wherein the first yoke is disposed on the second moving part.

7. The lens driving device of claim 4, comprising a second yoke on which an attractive force with the second magnet acts,
wherein the second magnet is disposed on the second moving part, and
wherein the second yoke is disposed on the third moving part.

8. The lens driving device of claim 7, comprising:
a third yoke on which an attractive force with the third magnet acts,
wherein the third magnet is disposed on the third moving part, and
wherein the third yoke is disposed on the fixed part.

9. The lens driving device of claim 1, comprising a first ball disposed between the first moving part and the second moving part,
wherein the first moving part and the second moving part comprise a first groove extending in the optical axis direction, and
wherein the first ball is disposed between the first groove of the first moving part and the first groove of the second moving part.

10. A lens driving device comprising:
a fixed part;
a first moving part disposed in the fixed part;
a second moving part disposed between the fixed part and the first moving part;
a first coil and a first magnet configured to move the first moving part in an optical axis direction; and
a second coil and a second magnet configured to move the second moving part in a first direction perpendicular to the optical axis direction,
wherein the second moving part comprises a first surface on which a first guide part is formed to guide the first moving part to move in a first direction; and a second surface on which a third guide part is formed to guide a movement of the first moving part in the optical axis direction.

11. The lens driving device of claim 4, comprising a second ball disposed between the second moving part and the third moving part,
wherein the second moving part and the third moving part comprise a second groove extending in the first direction, and
wherein the second ball is disposed between the second groove of the second moving part and the second groove of the third moving part.

12. The lens driving device of claim 4, comprising a third ball disposed between the third moving part and the fixed part,
wherein the third moving part and the fixed part comprise a third groove extending in the second direction, and
wherein the third ball is disposed between the third groove of the third moving part and the third groove of the fixed part.

13. The lens driving device of claim 4, wherein in the second direction, the second magnet is overlapped with the third magnet.

14. The lens driving device of claim 4, wherein in the first direction and the second direction, the first magnet is not overlapped with the third magnet.

15. A camera device comprising:
a printed circuit board;
an image sensor disposed on the printed circuit board;
the lens driving device of claim 1 disposed on the printed circuit board; and
a lens coupled with the lens driving device.

16. An optical apparatus comprising:
a main body;
the camera device of claim 15 disposed on the main body; and
a display disposed on the main body and configured to output at least any one or more of an image and a video photographed by the camera device.

17. A lens driving device comprising:
a fixed part comprising a bottom plate and a side plate;
a first moving part configured to move with respect to the fixed part;
a second moving part configured to guide the first moving part to move in an optical direction;
a third moving part configured to guide the first moving part to move in a first direction and a second direction perpendicular to the optical direction;
a first ball part disposed between the first moving part and the second moving part;
a second ball part disposed between a lower surface of the second moving part and an upper surface of the third moving part; and
a third ball part disposed between the third moving part and the side plate of the fixed part.

18. The lens driving device of claim 17 comprising:
a first coil and a first magnet configured to move the first moving part in the optical axis direction;
a second coil and a second magnet configured to move the second moving part in a first direction perpendicular to the optical axis direction; and
a third coil and a third magnet configured to move the third moving part in a second direction perpendicular to the optical axis direction and the first direction.

19. The lens driving device of claim 18, wherein the second coil is overlapped with the first coil in the first direction.

20. The lens driving device of claim 18, wherein the second coil comprises a first unit coil and a second unit coil, and
wherein, in the first direction, the first coil is disposed between the first unit coil and the second unit coil.
